(19) United States
(12) Patent Application Publication
(10) Pub. No.: US 2010/0079413 A1
(43) Pub. Date: Apr. 1, 2010

(54) Control device

(75) Inventors: Takeshi Kawashima, Nisshin-city (JP); Masahiro Itoh, Ichinomiya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/586,914

(22) Filed: Sep. 29, 2009

(30) Foreign Application Priority Data
Sep. 29, 2008 (JP) 2008-251783
Jan. 30, 2009 (JP) 2009-020635

(51) Int. Cl. G06F 3/042; G06F 3/048; G01C 21/32

(52) U.S. Cl. 345/175; 715/781; 701/208

(57) ABSTRACT

There is provided a control device for an in-vehicle electronic apparatus. The control device includes: a manipulation input element that has a manipulation input region having a predetermined area; an imaging device that has a photographing range covering the manipulation input region, and that captures an image including a hand image region representative of the hand; a hand image region identification section that identifies the hand image region in the image; an area ratio calculation section that calculates a value of hand image area ratio, which is area ratio of the hand image region to the manipulation input region; and an operation input information generation section that generates and outputs operation input information based on the calculated value of the hand image area ratio and a manipulation state of the manipulation input region, the operation input information being directed to the in-vehicle electronic apparatus.

### CROSS REFERENCE TO RELATED APPLICATION

The present application is based on Japanese Patent Applications No. 2008-251783 filed on Sep. 29, 2008 and No. 2009-020635 filed on Jan. 30, 2009, disclosures of which are incorporated herein by reference.

### BACKGROUND OF THE INVENTION

1. Field of the Invention

The present invention relates to a control device, more particularly to a control device for an in-vehicle apparatus.

2. Description of Related Art

There has been proposed various types of control device for an in-vehicle apparatus such as a car navigation apparatus and the like. One type of such control device is an operating device that captures an image of a hand of a user, extracts a finger image from the captured image, and superimposes the extracted finger image on a GUI input window such as a navigation window and the like of the in-vehicle apparatus.

For example, Patent Document 1 discloses an operating device that uses a camera mounted to a ceiling of a vehicle body to capture an image of a hand of a user who is manipulating a switch panel located next to a seat, and causes a liquid crystal panel located in front of the user to display the captured image of the hand and the switch panel. Patent Document 2 discloses another operating device that uses a camera located on a roof of a vehicle to capture an image of a hand of a driver, specifies an outline of the hand and superimposes the image of the outline on an image of buttons. Patent Document 3 discloses another operating device that captures an image of a manipulation button and a hand above a switch matrix, detects the hand getting access to the switch matrix, and superimposes the hand image.

Patent Document 1: JP-2000-335330A (U.S. Pat. No. 6,407,733)

Patent Document 2: JP-2000-6687A

Patent Document 3: JP-2004-26046A

The conventional technique uses information on the captured image, only to superimpose a hand contour image to indicate an operation position on a window. The information on the captured image is not effectively used as input information.

More specifically, the above-described operating devices include a touch input device having a two dimensional input surface. The touch input device is capable of performing continuous two-dimensional position detection, as a mouse, a track ball and a track pad can do. However, when menu selection, character input and point selection on a map are main user operations using the touch input device, and in particular when the operating devices are used for an in-vehicle electronic apparatus, a main user manipulation becomes a touch manipulation aiming for a certain item, a certain button, a desired location on map, or the like. In such a case, the operating devices typically do not allow the manipulation of continuous movement of a finger while the finger is being in contact with the input surface, because an error input can easily occur in the continuous movement. Thus, an input form of the operating device is typically such a discrete one that a finger is spaced apart from the input surface in a case irrelevant to an input, the finger contacts the input surface at only a location relevant to the desired input. One reason of the use of the above described input form is as follows. In the touch input device, a mechanism for detecting a contact on a touch manipulation surface plays both roles of a mechanism for position detection on the touch manipulation surface and a mechanism for detecting an input. A touch input device does not have an input detection mechanism that is provided separately from the mechanism for position detection. Note that a mouse has a click button as such mechanism for input detection.

In a case of a mouse, a user can easily perform a drag operation on a target item on a window through: moving a pointer to the target item such as an icon or the like; clicking a button to switch the target item into a selected state; and moving the mouse on an manipulation plane while maintaining the selected state. When the mouse is moving, the mechanism for position detection detects position of the mouse in real time, and thus, a movement trajectory of the target item on the window can well correspond to that of the mouse, realizing intuitive operation. In a case of a touch input device however, although a user can switch a target item into a selected state and specify a destination by performing a touch manipulation, when the user spaces a finger apart from a touch manipulation surface, the touch input device cannot detect finger position and cannot monitor a drag movement trajectory. As a result, the operating device cannot display the movement of the target item in accordance with a movement trajectory of fingertip. The operating device cannot realize an intuitive operation in the same level as mouse cam realize.

### SUMMARY OF THE INVENTION

In view of the above and other points, it is an objective of the present invention to provide a control device capable of effectively using information on a captured image as input information and thereby capable of considerably extending an input form. For example, the control device may be configured to display a pointer image indicative of the present position of a fingertip and a move target image so that the pointer image and the move target image are movable together even when a finger of a user is spaced apart from a manipulation surface of a touch input device.

According to a first aspect of the present disclosure, there is provided a control device including: a touch input device that has a manipulation surface adapted to receive a touch manipulation made by a finger of a user, and detects and outputs an input location of the touch manipulation; an imaging device that has a photographing range having one-to-one coordinate relationship to the manipulation surface, and captures an image of a hand of the user getting access to the manipulation surface; a fingertip specifying section that specifies a fingertip of the hand based on data of the image of the hand; a display device that includes a display screen having one-to-one coordinate relationship to the photographing range and the manipulation surface; a pointer image display control section that causes the display device to display a pointer image on the display screen, the pointer image pointing to a place corresponding to the fingertip; a selection reception region setting section that sets a selection reception region on the display screen so that the selection reception region is located at a predetermined place on the display screen; a move target image selection section that switches a move target image prepared on the selection reception region into a selected state when the touch input device detects that the touch manipulation is performed at the input location corresponds to the move target image item; and an image movement display section that (i) detects a target fingertip, which is the fingertip that makes the touch manipulation at the input location corresponding to the move target image item, (ii) causes the display device to display the move target image in the selected state and the pointer image at a place corresponding to position of the target fingertip, and (iii) causes the move target image in the selected state and the pointer image to move together on the display screen in response to movement of the target fingertip in the photographing range, in such manner that a trajectory of movement of the selected move target image and the pointer image corresponds to a trajectory of the movement of the target fingertip.

According to the above control device, it is possible to utilize information on position of the fingertip of the user based on the image of the hand even when the finger is being spaced apart from the manipulation surface. The control device can detect the position of the fingertip and the input location of the touch manipulation independently from each other. It is therefore possible to effectively use information on a captured image as input information and thereby possible to considerably extend an input form. For example, the control device enables input operation such as drag operation on an image item and the like in an intuitive manner based on the captured image.

According to a second aspect of the present disclosure, there is provided a control device for a user to operate an in-vehicle electronic apparatus in a vehicle by manipulating the control device. The control device includes: a manipulation input element that is located so as to be within reach of the user who is sitting in a seat of the vehicle, and that has a manipulation input region having a predetermined area; an imaging device that has a photographing range covering the manipulation input region, and that captures an image including a hand image region representative of the hand of the user getting access to the manipulation input element; a hand image region identification section that identifies the hand image region in the image; an area ratio calculation section that calculates a value of hand image area ratio, which is area ratio of the hand image region to the manipulation input region; and an operation input information generation section that generates and outputs operation input information based on the calculated value of the hand image area ratio and a manipulation state of the manipulation input region, the operation input information being directed to the in-vehicle electronic apparatus.

According to the second aspect, the control device including the manipulation input element and the imaging device can generates and outputs the operation input information directed to the in-vehicle electronic apparatus based on the calculated value of the hand image area ratio and the manipulation state of the manipulation input region. Thus, as input information, it is possible to efficiently use information on the image captured by the imaging device in addition to the input information provided from the manipulation input element. Therefore, it is possible to largely extend input forms in utilizing the control device.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view illustrating a control device mounted in a vehicle in accordance with a first embodiment;

FIG. 2A is a cross sectional diagram illustrating an internal structure of the control device;

FIG. 2B is a enlarged cross sectional view a pat of the control device surrounded by line IIB in FIG. 2A;

FIG. 3 is a block diagram illustrating an electric configuration of the control device;

FIG. 4 is a block diagram illustrating an electric configuration of a navigation apparatus to which the control device is applicable;

FIG. 5 is a diagram illustrating a corresponding relationship between a photographing range of a camera and a display screen of the navigation apparatus;

FIG. 6 is a diagram illustrating a flow of image processing for determining a fingertip position;

FIG. 7 is a conceptual diagram illustrating content of a fingertip position memory;

FIG. 8 is a conceptual diagram illustrating content of an icon registration memory;

FIG. 9 is a graph illustrating a cancelation movement analysis;

FIG. 10 is a flowchart illustrating a main procedure to be performed by the control device;

FIG. 11A is a flowchart illustrating a fingertip position specification process;

FIG. 11B is a flowchart illustrating a fingertip determination process;

FIG. 12 is a flowchart illustrating an icon registration process;

FIG. 13 is a flowchart illustrating an icon registration management process;

FIG. 14 is a flowchart illustrating an icon synthesizing display process;

FIG. 15 is a flowchart illustrating a command execution process;

FIGS. 16, 17 and 18 are diagrams illustrating an operation flow related to destination setting and a transition of display states;

FIG. 19 is diagrams illustrating an operation flow related to cancelation of icon registration and a transition of display states;

FIG. 20 is diagrams illustrating an operation flow related to a coupling movement mode turn off and a transition of display states;

FIGS. 21 and 22 are diagrams illustrating an operational flow related to a eraser tool and a transition of display states;

FIG. 23 is diagrams illustrating an operation flow related to map scroll and a transition of display state;

FIG. 24 is diagrams illustrating an operation flow related to stopover point setting and a transition of display state;

FIGS. 25 and 26 are diagrams illustrating an operation flow related tp peripheral search and a transition of display state;

FIGS. 27 and 28 are diagrams illustrating an operation flow related to map enlargement and a transition of display state;

FIG. 29 is a side view illustrating a control device of a modification of the first embodiment;

FIG. 30 is a perspective view illustrating an input part of the control device of the modification of the first embodiment;

FIG. 31 is a diagram for explaining a concept of width of a tip region;

FIG. 32 is a diagram for explaining a concept of a labeling process for separating multiple tip regions;

FIG. 33 is diagrams illustrating a variety of binarized captured-images;

FIG. 34 is a diagram for explaining a process of excluding a tip region of a photographic subject as a non-fingertip region;

FIG. 35 is diagrams illustrating a concept of a finger-width estimation calculation which is performed based on area and Y-direction position of a photographic subject on an image;

FIG. 36 is diagrams for explaining a difficulty arising when a fingertip is stick out from a display screen;

FIG. 37 is diagrams for explaining a concept used in addressing the difficulty illustrated in FIGS. 36A to 36C by introducing a non-display imaging region;

FIG. 38 is a diagram for explaining a manner of determining, based on the concept illustrated in FIG. 37, whether a tip region is a fingertip region;

FIG. 39 is a diagram for explaining a first manner of determining, based on an aspect ratio of the tip region, whether a tip region is a fingertip region;

FIG. 40 is a diagram illustrating a second manner of determining, based on an aspect ratio of the tip region, whether a tip region is a fingertip region;

FIG. 41A are diagrams for explaining a concept used in determining whether a tip region is a fingertip region based on area of a photographic subject and the number of tip regions;

FIGS. 42A and 42B are diagrams for explaining a concept used in determining, based on movement distance of fingertip position, whether icon registration is to be maintained;

FIG. 43 is diagrams for explaining suspension of icon registration in a case where fingertip position is located outside a display region;

FIG. 44 is a diagram illustrating a move target image;

FIG. 45 is a diagram for explaining a geometrical principle used in setting a wrist point and a finger straight line;

FIG. 46 is a diagram illustrating a pointer image that is pasted along the finger straight line;

FIG. 47 is a diagram illustrating a first example of a simulated finger image;

FIG. 48 is a diagram illustrating a second example of a simulated finger image;

FIG. 49 is a diagram illustrating a third example of a simulated finger image;

FIG. 50 is diagrams illustrating a positional relationship between a finger image and an input manipulation surface, and illustrating a display example in which the finger image is superimposed;

FIG. 51 is a diagram illustrating a display example in which a pointer image is superimposed;

FIG. 52 is a diagram for explaining a first modified manner of setting a wrist point;

FIG. 53 is diagrams for explaining a second modified manner of setting a wrist point;

FIG. 54 is a diagram for explaining a third modified manner of setting a wrist point;

FIG. 55 is a perspective view illustrating a control device for an in-vehicle electronic apparatus mounted in a vehicle compartment in accordance with a second embodiment;

FIG. 56A is a cross sectional diagram illustrating an internal structure of the control device;

FIG. 56B is an enlarged view of a part of the control device, the part being surrounded by the dashed line LVIB in FIG. 56A;

FIG. 57 is a block diagram illustrating an electric configuration of the control device;

FIGS. 58A, 58B and 58C are diagrams illustrating a relationship among an image of fingers, a manipulation input surface and an input window;

FIG. 59 is diagrams illustrating a first operation for the control device;

FIG. 60 is a flowchart illustrating an input information generation procedure;

FIG. 61 is diagrams illustrating a second operation for the control device;

FIG. 62 is diagrams illustrating a time variation in hand image region that corresponds to a first example of input hand movement that can be employed in the second operation illustrated in FIG. 61;

FIG. 63 is diagrams illustrating a change over time in area and center coordinate of a hand image region illustrated in FIG. 62;

FIG. 64 is diagrams illustrating a second example of the input hand movement that can be employed in the second operation illustrated in FIG. 61 and division of manipulation input region into multiple sub-regions;

FIG. 65 is diagrams illustrating a time variation in hand image region that corresponds to a third example of the input hand movement that can be employed in the second operation illustrated in FIG. 61;

FIG. 66 is diagrams illustrating a change over time in area and center coordinate of a hand image region illustrated in FIG. 65; and

FIG. 67 is diagrams illustrating a time variation in hand image region that corresponds to a fourth example of the input hand movement that can be employed in the second operation illustrated in FIG. 61.

### DETAILED DESCRIPTION OF THE EXEMPLARY EMBODIMENTS

The exemplary embodiments are described below with reference to the accompanying drawings.

### First Embodiment

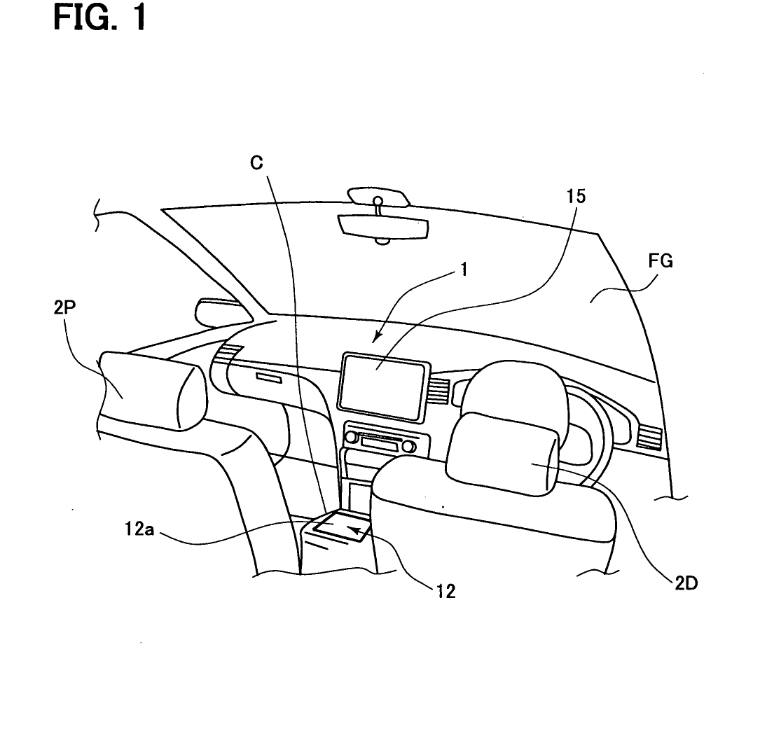

FIG. 1 is a perspective view illustrating a control device 1 for an in-vehicle electronic apparatus according to a first embodiment. The control device 1 is placed in a vehicle compartment, and includes a monitor 15 and a manipulation part 12 (also referred to as an input part 12). The monitor 15 can function as a display device and is located at a center part of an instrument pane. The manipulation part 12 is located on a center console, and is within reach from both of a driver seat 2D and a passenger seat 2P, so that a user sitting in the driver seat or the passenger seat can manipulate the manipulation part 12. A user can use the control device 1 to operate, for example, a car navigation apparatus, a car audio apparatus or the like while taking a look at a display screen of the monitor 15.

The manipulation part 12 has an input manipulation surface acting as an manipulation surface, and is positioned so that the input manipulation surface faces in the upper direction. The manipulation part 12 includes a touch panel 12a providing the input manipulation surface. Touch panel 12a may be a touch-sensitive panel of resistive type, a surface acoustic wave type, a capacitive type or the like. The touch panel 12a includes a transparent resin plate acting as a base, or a glass plate acting as a transparent input support plate. An upper surface of the touch panel 12a receives and supports a touch manipulation performed by a user using a finger. The control device 1 sets an input coordinate system on the input manipulation surface, which has one-to-one coordinate relationship to the display screen of the monitor 15.

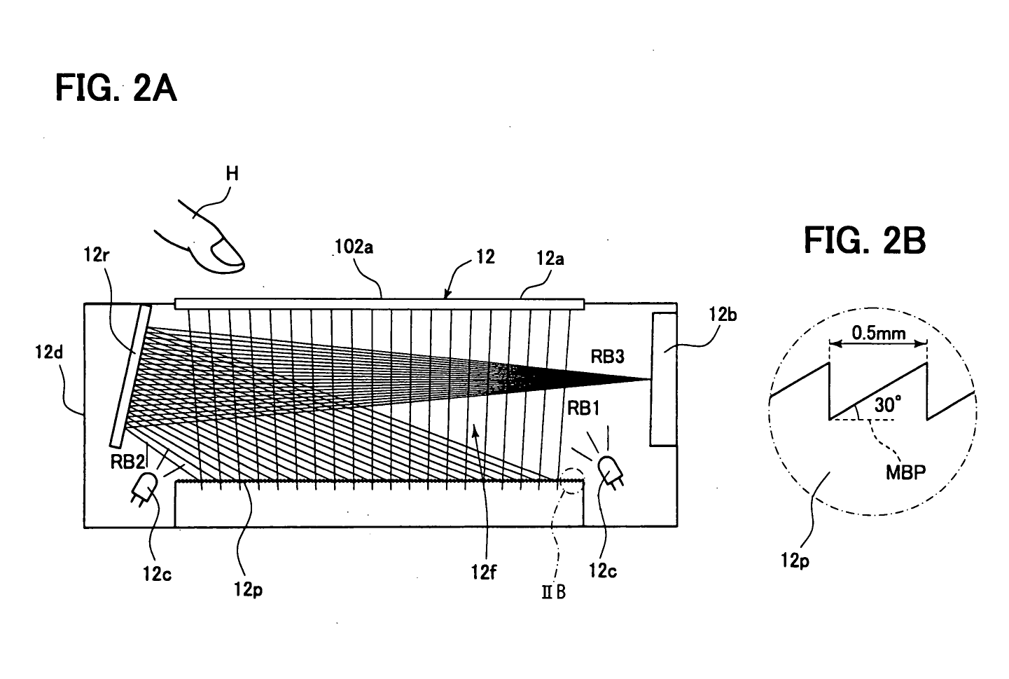

FIG. 2A is a cross sectional diagram illustrating an internal configuration of the input part 12. The input part 12 includes a case 12d. The touch panel 12a is mounted to an upper surface of the case 12d so that the input manipulation surface 102a faces away from the case 12d. The input part 12 further includes an illumination light source 12c, an imaging optical system, and a hand imaging camera 12b, which are received in the case 12d. The hand imaging camera 12b (also referred to as a camera 12b for simplicity) can act as an imaging device and can function as an image date acquisition means or section. The illumination light source 12c includes multiple light-emitting diodes (LEDs), which may be a monochromatic light source. Each LED has a mold having a convex surface, and has a high brashness and a high directivity in an upper direction of the LED. The multiple LEDs are located in the case 12d so as to surround a lower surface of the touch panel 12a. Each LED is inclined so as to point a tip of the mold at an inner region of the lower surface of the touch panel 12a. When a user applies his or her front of a hand H above the input manipulation surface 102a for instance, the light emitted from the LEDs are reflected from the hand H, as shown in FIG. 2A by using the reference symbol RB1 named a first reflected light. The first reflected light RB1 transmits through the touch panel 12a and travels in a lower direction.

The imaging optical system includes a first reflecting portion 12p and a second reflecting portion 12r. The first reflecting portion 12p is, for example, a prism plate 12p, on a surface of which multiple tiny triangular prisms are arranged in parallel rows. The prism plate 12p is transparent and located just below the touch panel 12a. The prism plate 12p and the touch panel 12a are located on opposite sides of the case 12d so as to define therebetween a space 12f. The first reflecting portion 12p reflects the first reflected light RB1 in an upper oblique direction, and thereby outputs a second reflected light RB2 toward a laterally outward side of the space 12f. The second reflecting portion 12r is, for example, a flat mirror 12r located on the laterally outward side of the space 12f. The second reflecting portion 12r reflects the second reflected light RB2 in a lateral direction, and thereby outputs a third reflected light RB3 toward the camera 12b, which is located on an opposite side of the space 12f from the second reflecting portion 12r. The camera 12b is located at a focal point of the third reflected light RB3, and captures and acquires an image (i.e., a hand image) of the hand H and the finger of the user.

As shown in FIG. 2B, the multiple tiny prisms of the prism plate 12p have a rib-like shape. The multiple tiny prisms respectively have reflecting surfaces that are inclined at the substantially same angle with respect to a mirror base plane MBP of the prism plate 12p. The multiple tiny prisms are closely spaced and parallel to each other on the mirror base plane MBP. The prism plate 12p can reflect the normal incident light in an oblique direction or the lateral direction. Due to the above structure, it becomes possible to place the first reflecting portion 12p below the touch panel 12a so that the first reflecting portion 12p and the touch panel 12a are parallel and opposed to each other. Thus, it is possible to remarkably reduce a size of the space 12f in a height direction.

Since the second reflecting portion 12r and the camera 12b are located on laterally opposite sides of the space 12f, the third reflecting light RB3 can be directly introduced into the camera 12b while traveling across the space 12f. Thus, the second reflecting portion 12r and the camera 12b can be placed close to lateral edges of the touch panel 12a, and, a path of the light from the hand H to the camera 12b can be folded in three in the space 12f. The imaging optical system can be therefore remarkably compact as a whole, and the case 12d can be thin. In particular, since the reducing of size of the touch panel 12a or the reducing of area of the input manipulation surface 102a enables the input part 12 to be remarkably downsized or thinned as a whole, it becomes possible to mount the input part 12 to vehicles whose center console C has a small width or vehicles whose have a small attachment space in front of a gear shift lever.

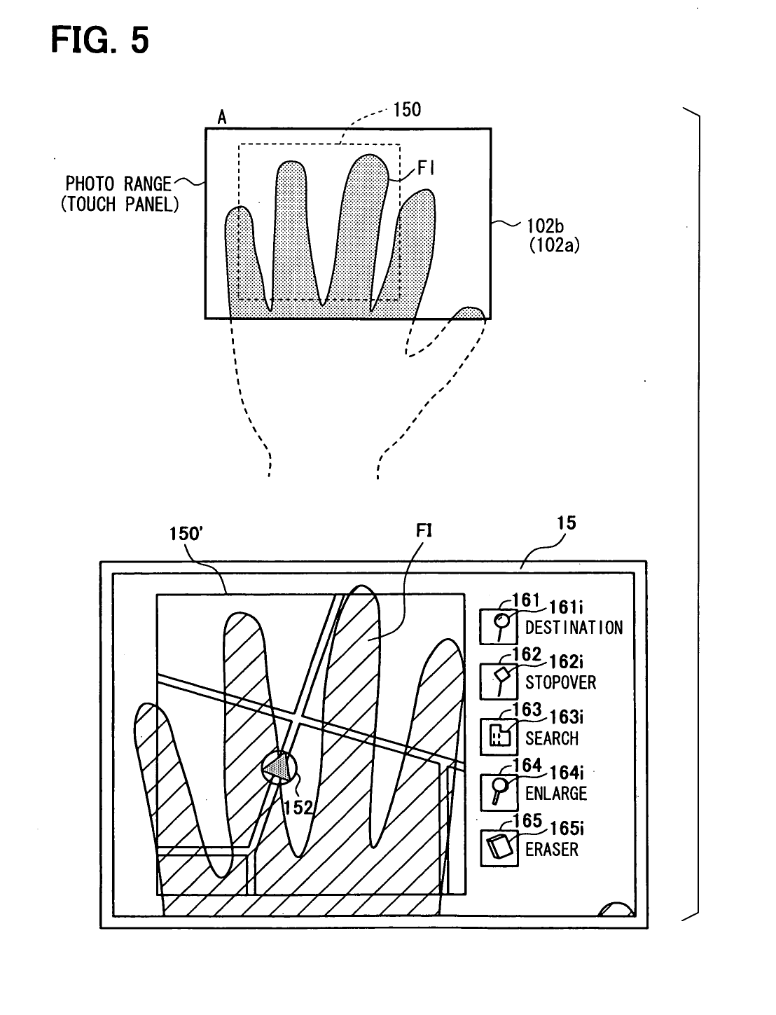

The input manipulation surface 102a of the touch panel 12a corresponds to a photographing range of the camera 12b. As shown in FIG. 5, on an assumption that size of the hand H is an average size of adult hand, the input manipulation surface 102a has a dimension in an upper-lower direction (corresponding to a Y direction), such that only a part of the hand in a longitudinal direction of the hand is within the input manipulation surface 102a, the part including a tip of the middle finger. For example, the size of the input manipulation surface 102a in the Y direction may be in a range between 60 mm and 90 mm, and may be 75 mm in an illustrative case. Because of the above size, only a part of the hand between bases of fingers and tips of fingers may be displayed on the, display screen of the monitor 15, and another part of the hand except the fingers may not be involved in display. Thus, it is possible to remarkably simplify the below-described display procedure using a pointer image. Size of the input manipulation surface 102a in a right-left direction (corresponding to X direction) may be in a range between 110 mm and 130 mm, and may be 120 mm in an illustrative case. Thus, when the fingers of the hand are opened far apart from each other on the input manipulation surface 102a, the fore finger, the middle finger and the ring finger are within the photographing range, and the thumb is outside the photographing range. It should be noted that, when fingers appropriately get close to each other, all of the fingers can be within the photographing range.

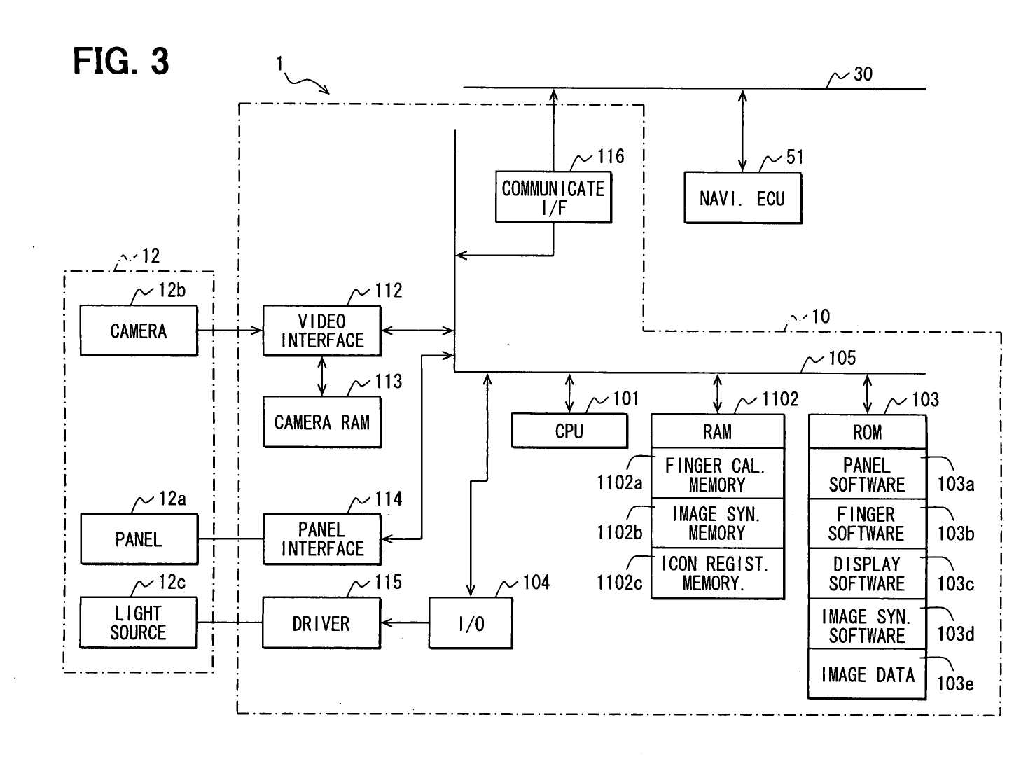

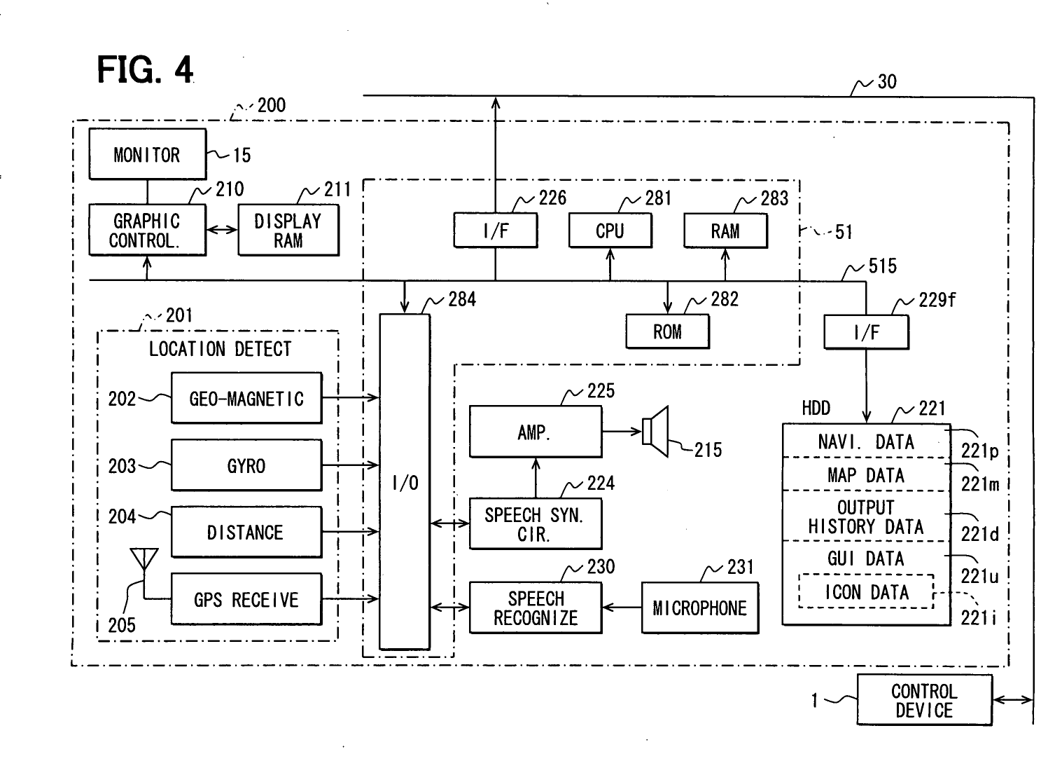

FIG. 3 is a block diagram illustrating an electrical configuration of the control device 1. The control device 1 includes an operation ECU (electronic control unit) 10, which may act as a main controller. The operation ECU 10 may be provided as a computer hardware unit including a CPU 101 as a main component. In addition to the CPU 101, the operation ECU 10 includes a RAM 1102, a ROM 103, a video interface 112, a touch panel interface 114, a general-purpose I/O 104, a serial communication interface 116 and an internal bus connecting the foregoing components with each other. The video interface 112 is connected with the camera 12b and a video RAM 113 (also referred to as a camera RAM 113) for image capturing video. The touch panel interface 114 is connected with the touch panel 12a acting as a touch input device. The general-purpose I/O 104 is connected with the illumination light source 12c via a driver circuit 115. The serial communication interface 116 is connected with an in-vehicle serial communication bus 30 such as a CAN communication bus and the like, so that the control device 1 is mutually communicatable with another ECU network-connected with the in-vehicle serial communication bus 30. More specifically, the control device 1 is mutually communicatable with a navigation ECU 51 acting as a controller of a car navigation apparatus 200 (see FIG. 4).

An image signal, which is a digital signal or an analog signal representative of an image captured by the camera 12b, is continuously inputted to the video interface 112. The video RAM 113 stores therein the image signal as image frame data at predetermined time intervals. Memory content of the video RAM 113 is updated on an as-needed basis each time the video RAM 113 reads new image frame data.

The touch panel interface 114 includes a driver circuit that may be dedicated to correspond to a type of the touch panel 12a. Based on the input of a signal from the touch panel 12a, the touch panel interface 114 detects an input location of a touch manipulation on the touch panel. 12a and outputs a detection result as location input coordinate information.

Coordinate systems are set on the photographing range of the camera 12b, the input manipulation surface of the touch panel 12a and the display screen of the monitor 15 and have one-to-one correspondence relationship to each other. The photographing range corresponds to an image captured by the camera 12b. The input manipulation surface acts as a manipulation input region. The display screen corresponds to the input window image frame data and the pointer image frame data, which determine display content on the display screen.

The ROM 103 stores therein a variety of software that the CPU 101 can execute. The variety of software includes touch panel control software 103a, fingertip point calculation software 103b, display control software 103c, and image synthesis software 103d.

The touch panel control software 103a is described below. By performing the touch panel control software 103a, the CPU 101 acquires a coordinate of the input location of a touch manipulation from the touch panel interface 114, and acquires the input window image frame data from the navigation ECU 51. The input window image frame data is transmitted from the navigation ECU 51 together with determination reference information used for specifying content of the manipulation input. The determination reference information may include, for example, information used for specifying a region of a soft button and information used for specifying content of an operation command to be issued when the soft button is selected by the touch manipulation. The CPU 101 specifies content of the manipulation input based on the coordinate of the input location and the acquired determination reference information, and issues and outputs a command signal to the navigation ECU 51 to command the navigation ECU 51 to perform an operation corresponding to the manipulation input. The navigation ECU 51 can function as a control command activation means or section.

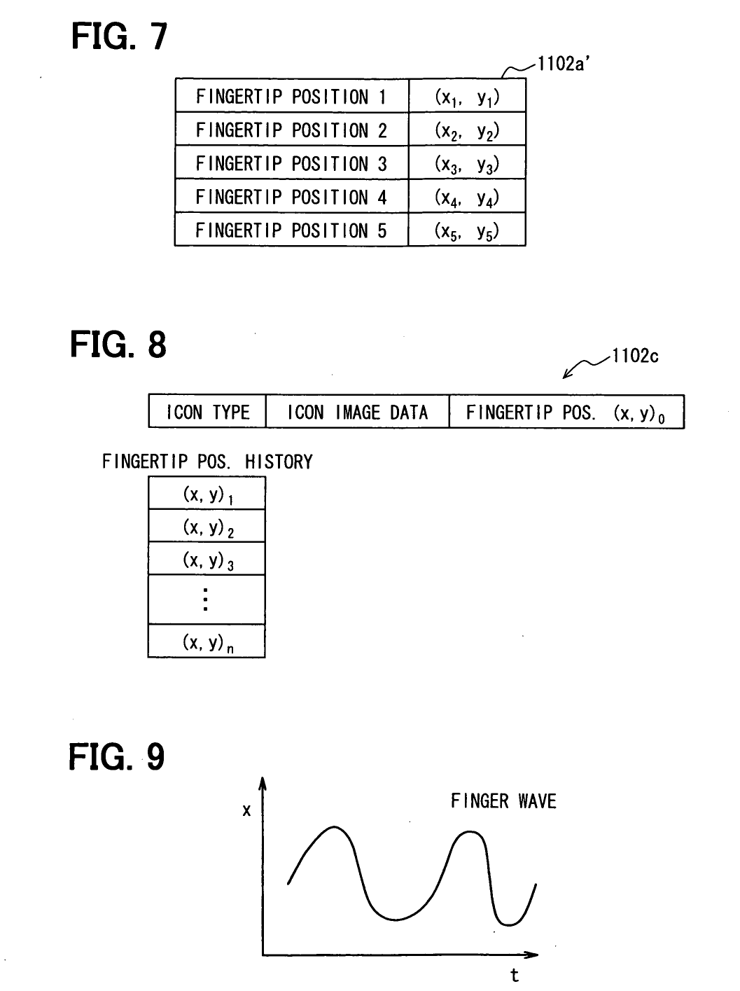

The fingertip point calculation software 103b is described below. The CPU 101 executing the fingertip point calculation software 103b can function as a fingertip specification means or section that specifies a fingertip of the hand based on data of the image of the hand in the following ways. The CPU 101 uses a fingertip calculation processing memory 102a′ in the RAM 102 as a work area. The CPU 101 binarizes an image of a user's hand captured by the camera 12b, and specifies a fingertip position in the binarized image as a fingertip point. More specifically, a predetermined representation point (e.g., geometrical center) of a tip region “ta” in the binarized image is calculated and specified as an image tip position “tp” (e.g., a fingertip point “tp”). The tip region “ta” may be an end portion of the hand in an insertion direction of the hand. Based on size or area of the tip region “ta”, it is determined whether the image tip position “tp” is a true fingertip point “tp”. In connection with the above process, a circuit for binarizing pixels may be integrated into an output part of the video interface in order to preliminarily perform the process of binarizing the image. As shown in FIG. 7, a coordinate of the specified fingertip point (also referred to as fingertip position or fingertip) can be stored in the working area of the fingertip position memory 1102a′, and multiple fingertip points (e.g., up to five fingertip points) may be specified at the same time and may be stored.

The display control software 103c is described below. The CPU 101 executing the display control software 103c can function as a selection reception region setting means or section, a move target image selection means or section, and an operation button image display control section or means. The CPU 101 sets a selection reception region at a predetermined place on the display screen of the monitor 15. The CPU 101 causes the display device to display an operation button image 161 to 165 (see FIG. 5) on the selection reception region of the display screen, the operation button image containing a marking image 161i to 165i as design display. When a touch manipulation on the input manipulation surface of the touch panel 12a is performed at an input location corresponding to the selection reception region, the

CPU 101 switches a movement target image prepared on the corresponding selection reception region into a selected state. In the present embodiment, as shown in FIG. 5, the movement target image is an icon 161i to 165i or the marking image 161i to 165i. The selected icon is registered in an icon registration memory 1102c in the RAM 102. The CPU 101 instructs the graphic controller 110 to load the input window image frame data, generates pointer image frame data in a way described later, and transmits the generated pointer image frame data to the graphic controller 110. FIG. 8 is a diagram illustrating a configuration of the icon registration memory 1102c. By using the icon registration memory 1102c, the CPU 101 registers and stores data about only a combination of specific data related to a type of the icon, image data of the icon and coordinate data of the fingertip position. Thus, a single operation can move only one icon and can issue a command corresponding to the one icon. To analyze fingertip movement, the CPU 101 stores a history of fingertip position in a predetermined past period in the icon registration memory 1102c.

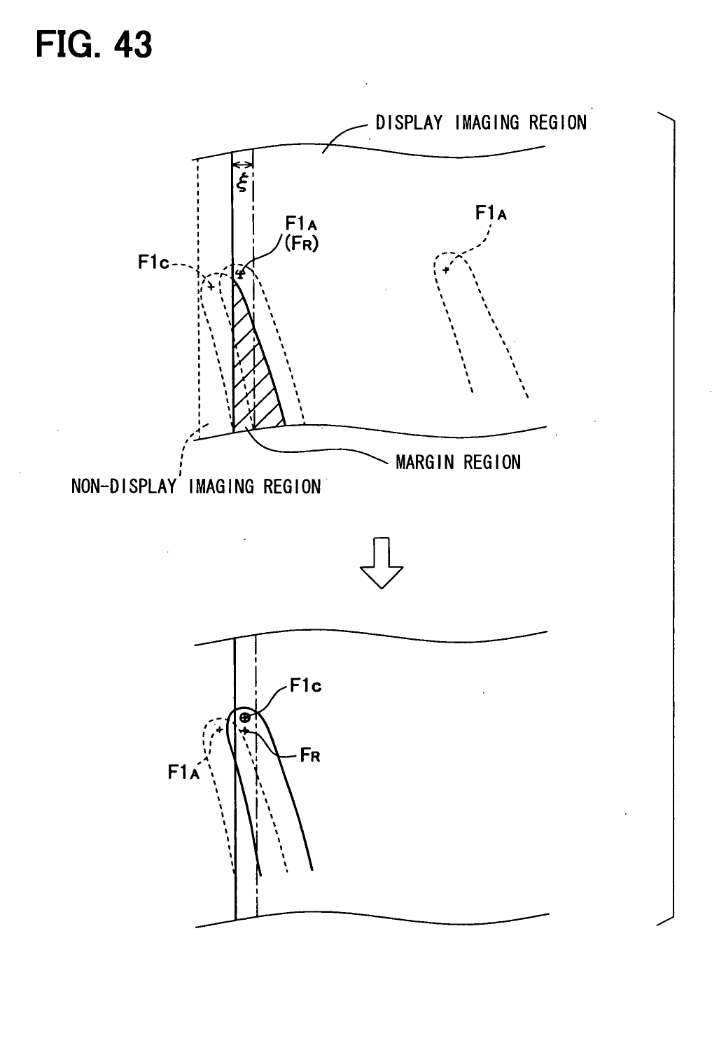

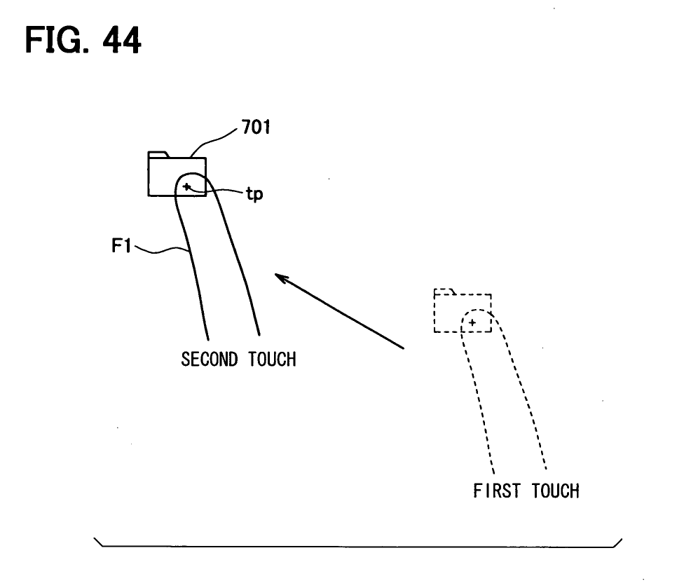

The image synthesis software 103d is described below. The CPU 101 executing the image synthesis software 103d can function as a pointer image display control section or means and an image movement display section or means. The CPU 101 uses an image synthesis memory 1102b in the RAM 1102 as a work area. The CPU 101 performs a process of pasting a pointer image on a pointer image frame. The pointer image may be a actual finger image FI (see FIG. 5) extracted from the image of the hand captured by the camera 12b or a simulated finger image SF (see FIG. 43). The simulated finger image SF may be a pre-prepared image different from actual finger image FI and stored as pointer image data in the ROM 103. Of the fingertip points specified by the fingertip point calculation software 103b, the fingertip point corresponding to a first touch manipulation is set to a target fingertip point. The target fingertip point matches the below described registration fingertip point. The move target image in the selected state and the pointer image are displayed on the display screen at a place corresponding to the target fingertip point. In response to movement of the target fingertip in the photographing range 102b, the move target image being in the selected state and the pointer image are moved together on the display screen such that a trajectory of coupling movement of the move target image and the pointer image corresponds to a trajectory of the movement of the target fingertip. Through the above manner, the CPU 101 acting as the pointer image display control section causes the display device to display a pointer image on the display screen, the pointer image pointing to a place corresponding to the fingertip. The CPU 101 can function as the image movement display section, which (i) recognizes a target fingertip, which is the fingertip that makes the touch manipulation at the input location corresponding to the move target image item, (ii) causes the display device to display the move target image in the selected state and the pointer image at a place corresponding to position of the target fingertip, and (iii) causes the move target image in the selected state and the pointer image to move together on the display screen in response to movement of the target fingertip in the photographing range, in such manner that a trajectory of movement of the selected move target image and the pointer image corresponds to a trajectory of the movement of the target fingertip.

FIG. 4 is a block diagram illustrating a car navigation apparatus 200 in accordance with the first embodiment. The car navigation apparatus 200 includes: a location detection device 201; a voice synthesis circuit 224 for speech guidance and the like; an amplifier 225 and a speaker 215 for speech output; a monitor 15 including a LCD (liquid crystal display) or the like; a navigation ECU 51 acting as a main controller connected with the foregoing components; a remote control terminal 212; and a HDD (hard disk drive) 221 acting as a main storage. The HDD 221 stores therein: map data 221m containing road data; navigation data 221d containing destination data, guidance information on destinations; and GUI display data 221u.

The car navigation apparatus 200 and the control device 1 are connected with each other via the serial communication bus 30. Manipulation input for operating and controlling the car navigation apparatus 200 can be performed by using the control device 1. Further, a variety of commands can be input to the car navigation apparatus 200 by using a speech recognition unit 230. More specifically, speech can be input to a microphone 231 connected with the speech recognition unit 230, and a signal associated with the speech is processed by a known speech recognition technique and converted into an operation signal in accordance with a result of the processing.

The location detection device 201 includes a geomagnetic sensor 202, a gyroscope 203, a distance sensor 204, and a GPS receiver 205 for detecting the present location of a vehicle based on a GPS signal from satellites. Because the respective sensors 202 to 205 have errors whose properties are different, multiple sensors are used while being complemented each other.

The navigation ECU 51 includes microcomputer hardware as a main component, the microcomputer hardware including a CPU 281, a ROM 282, a RAM 283, an I/O 284, and a bus 515 connecting the foregoing components with each other. The HDD 221 is bus-connected via an interface 229f. A graphic controller 210 can function to output an image to the monitor 15 based on drawing information for displaying a map or a navigation operation window. The graphic controller 210 is connected with the bus 515. A display video RAM 211 for drawing process is also connected with the bus 515. The graphic controller 110 acquires the input window image frame data from the navigation ECU 51. Further, from the control device 1 via the communication interface 226 and the serial communication bus 30, the graphic controller 110 acquires the pointing image frame data, which is made based on the GUI display data 221u such that the pointer image is pasted at a predetermined region. Further, in accordance with needs, the graphic controller 110 acquires the icon 161i to 165i acting as the marking image, which is made based on the GUI display data 221u. The graphic controller 110 then performs a frame synthesis operation by alpha blending or the like on the display video RAM 111 and outputs the synthesized frame to the monitor 15.

When a navigation program 221p is activated by the CPU 281 of the navigation ECU 51, information on the present location of the vehicle is acquired from the location detection device 201, and map data 221m indicative of a map around the present location is read from the HDD 221. Further, the map and a present location mark 152 indicative of the present location are displayed on a map display region 150′ (see an upper part of FIG. 5) of the display screen. The map display region 150′ corresponds to a command activation valid region 150 (see a lower part of FIG. 5) of the input manipulation surface 102a.

The operation button images 161 to 165 are displayed in a periphery of the map display region 150′ of the display screen of the monitor 15. The periphery is, for example, a blank space located on a right side of the map display region 150′, as shown in FIG. 5. The periphery of the map display region 150′ may be referred to as a window outside part. Each operation button image 161 to 165 is displayed on a corresponding one of the selection reception regions of the display screen. When a touch manipulation on the touch panel 12a is detected at an input location corresponding to the selection reception region 161 to 165, the movement target image 161i to 165i on the selection reception region that corresponds to the input location of the touch manipulation is switched in the selected state. Each operation button image 161 to 165 can be used for activating a control command to perform point specification on the map display region 150′. More specifically, the control command includes: a destination setting command (linked with the operation button image 161) to set a navigation destination on the map display region 150′; a stopover point setting command (linked with the operation button image 162) to set a stopover point on the map display region 150′; a peripheral facilities search command (linked with the operation button image 163) to search for peripheral facilities; and a map enlargement command (linked with the operation button image 164) to provide an enlarged view of the map. The operation button image 165 can be an eraser tool for executing a control command to cancel the pre-set destination, the pre-set stopover point, or the like. For simplicity, the operation button image 161 to 165 also may be referred to as a button 161 to 165.

Operation will be explained below.

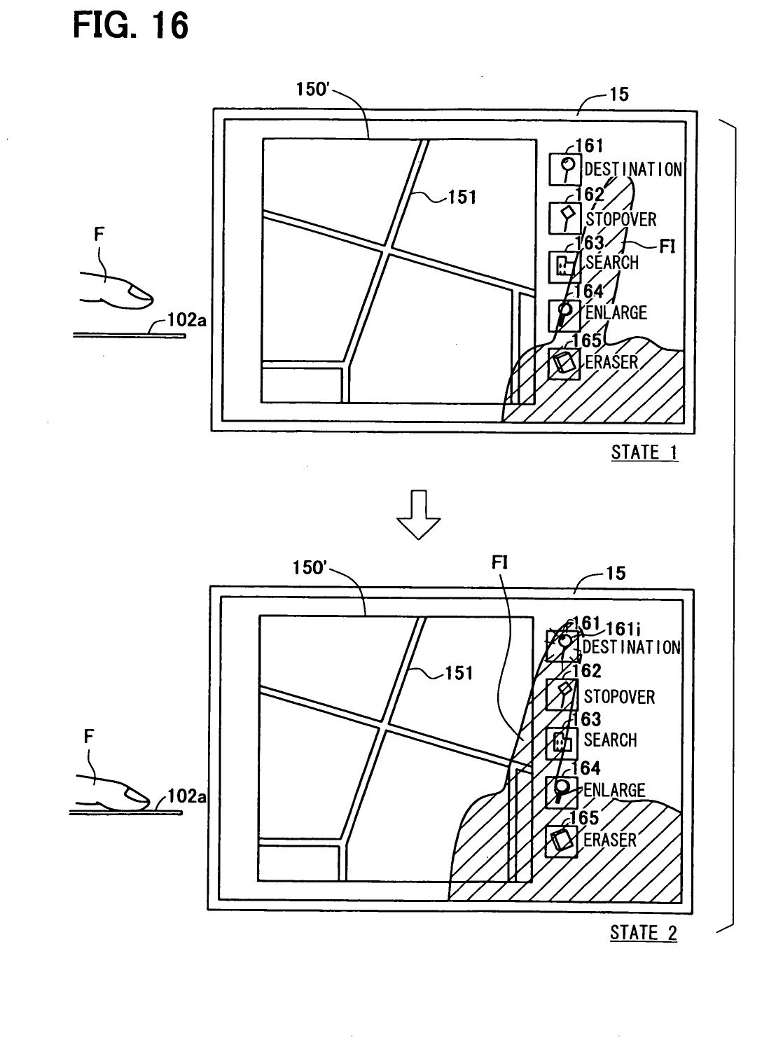

An operation flow in activating the destination setting command by using the operation button image 161 is as follows. In the state 1 shown in FIG. 16, a hand may enter in the photographing range of the control device 1, and the monitor 15 superimposes the finger image FI (acting as the pointer image) captured by the camera 12b of the control device 1. In the state 2 shown in FIG. 16, a user may point the fingertip at a desired operation button image (e.g., button 161) while confirming position of his or her fingertip by watching the finger image FI, and the user performs a first touch manipulation on the input manipulation surface 102a of the touch panel 12a. In response to the first touch manipulation, the marking image 161i displayed as design display on the operation button image is switched into a selected state.

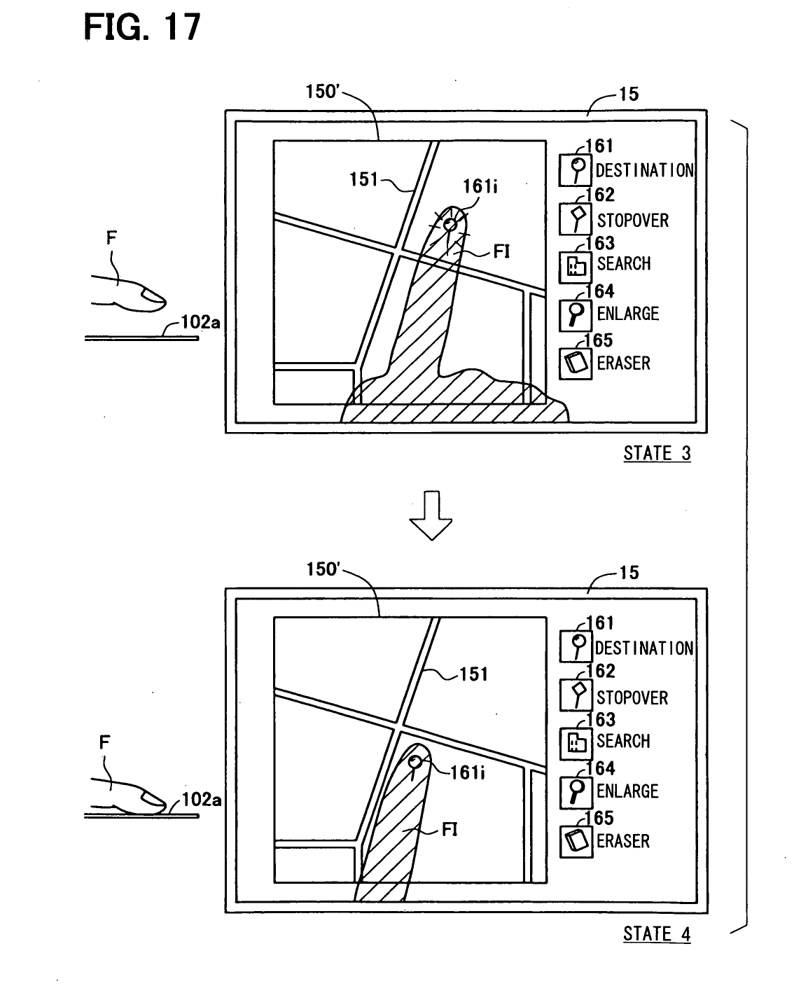

As shown in the state 3 of FIG. 17, when the user spaces the finger F apart from the input manipulation surface 102a and moves the fingertip over the map after the operation button image is switched into the selected state, position of the fingertip is tracked based on the hand image captured by the camera 12b. The marking image 161i is moved together with the hand image FI on the screen while the marking image 161i is attached to a place corresponding to the position of the fingertip (i.e., target fingertip). In other words, in response to the movement of the target fingertip in the photographing range, the marking image 161i (acting as the move target image) and the hand image FI (acting as the pointer image) are moved together such that a trajectory of the movement of the marking image 161 i and the hand image FI corresponds a trajectory of the movement of the target fingertip. The marking image 161i can function to highlight the position of the target fingertip, which is time-variable in accordance with manipulation. As shown in the state 4 of FIG. 17, the user may point the fingertip point at a desired destination on the map, and performs a second touch manipulation. Thereby, the point corresponding to the input location of the second touch manipulation is temporarily set as the destination, and the destination setting command is activated, as shown in the state 4 of FIG. 17. Further, the marking image 161i is pasted at the temporal destination and acts as an icon indicative of the temporal destination. In other words, the CPU 101 can function as a marking image pasting section or means that causes the display device to display the marking image on the display screen, such that the marking image is fixedly pasted at a place corresponding to the input location of the second touch manipulation when the coupling movement mode is switched off. In the present embodiment, a confirmation message and a button image 171 for confirming the setting are displayed on the periphery of the map display region 150′. When a user performs a selection operation for confirming the setting such as a touch operation directed to a “YES” button, the setting of the destination is fixed.

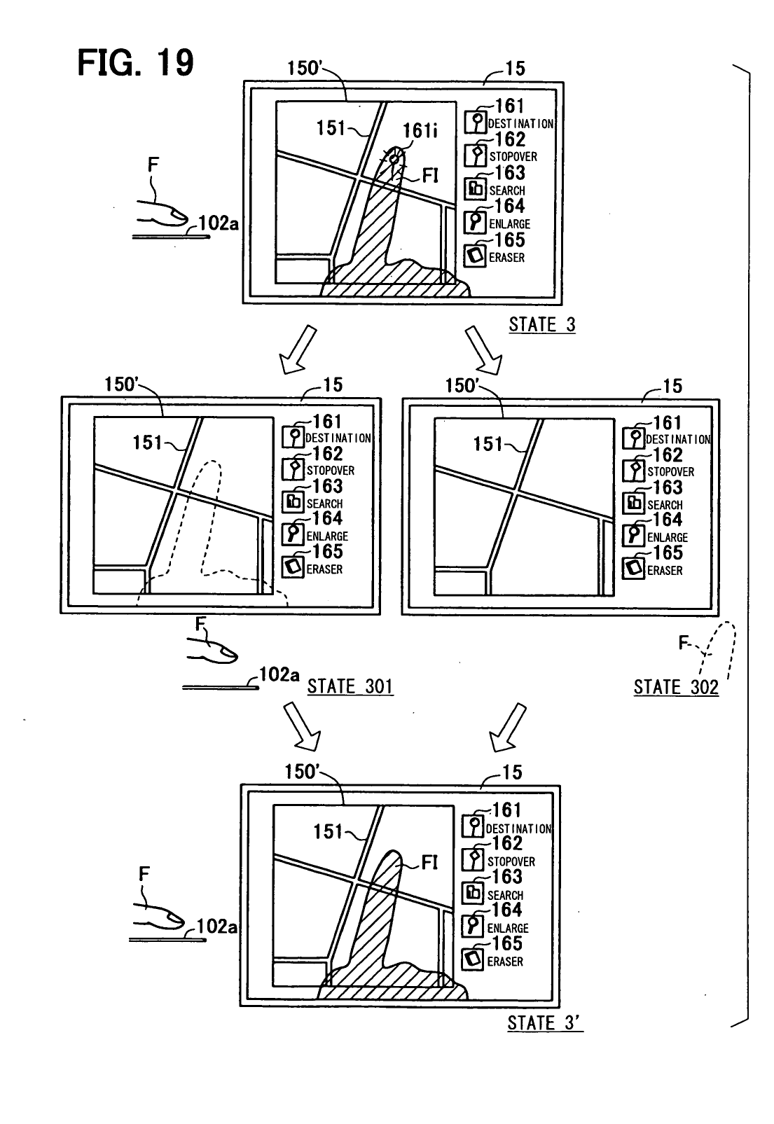

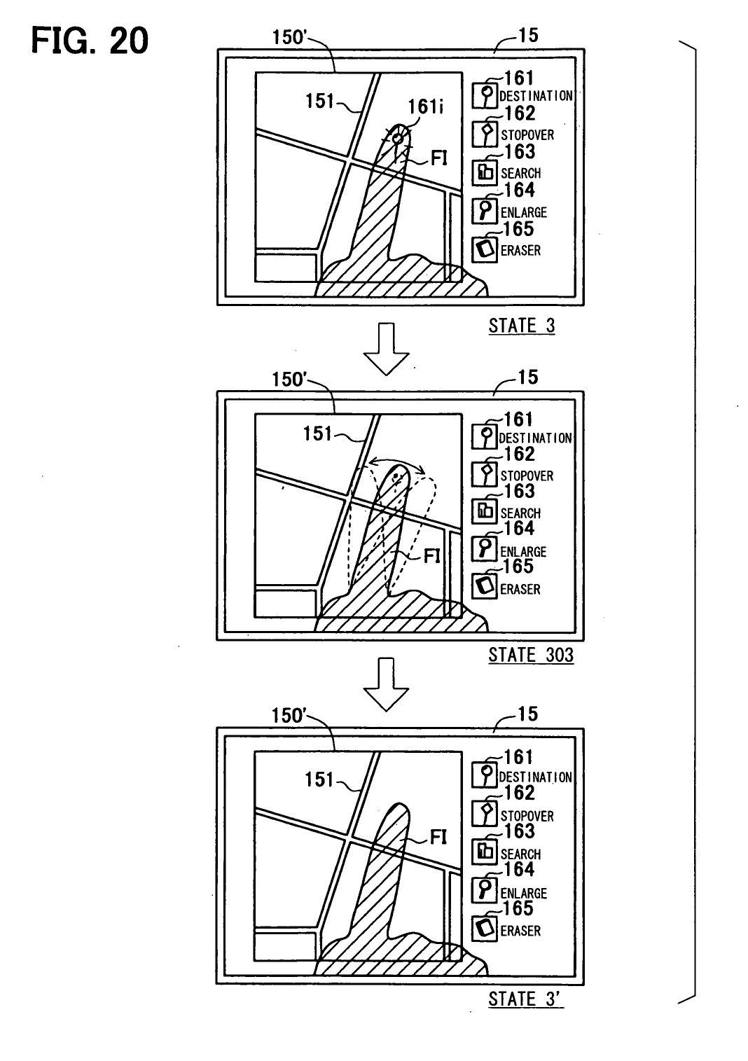

Hereinafter, a coupling movement mode may be referred to a mode where the marking image and the hand image are movable together and the marking image 161i is attached to the fingertip of the hand image FI. The CPU 101 can function as a target fingertip movement detection section that detects movement of the target fingertip based on the images captured by the camera 12b. As shown in FIG. 19, the coupling movement mode is turned off and the marking image 161i is switched into an unselected state when the hand is spaced a predetermined distance or more apart from the input manipulation surface 102a, corresponding to the state 301 in FIG. 19, or when the hand is moved to an outside of the photographing range (the display screen), corresponding to the state 302 in FIG. 19. More specifically, the display screen has a valid region (also referred to as a pointer displayable part) where the pointer image is displayable. When, in the coupling movement mode, the target fingertip point “tp” is escaped from the valid region, the coupling movement mode is turned off and the marking image 161i is switched into the unselected state. In the present embodiment, the whole display screen of the monitor 15 is set as the valid region. Alternatively, a part of the screen of the monitor 15 may be set as the valid region. Thus, even if the hand returns to an inside of the photographing range, the marking image 161i remains un-displayed, corresponding to the state 3′ in FIG. 19. Alternatively, as shown in FIG. 20, when a coupling movement mode turn off manipulation is performed in the coupling movement mode, the coupling movement mode are turned off and the marking image 161i is switched into the unselected state. The coupling movement mode off manipulation may be such a manipulation that the finger F is waved side to side as shown in the state 303 of FIG. 20 and may be also referred to as a cancel movement.

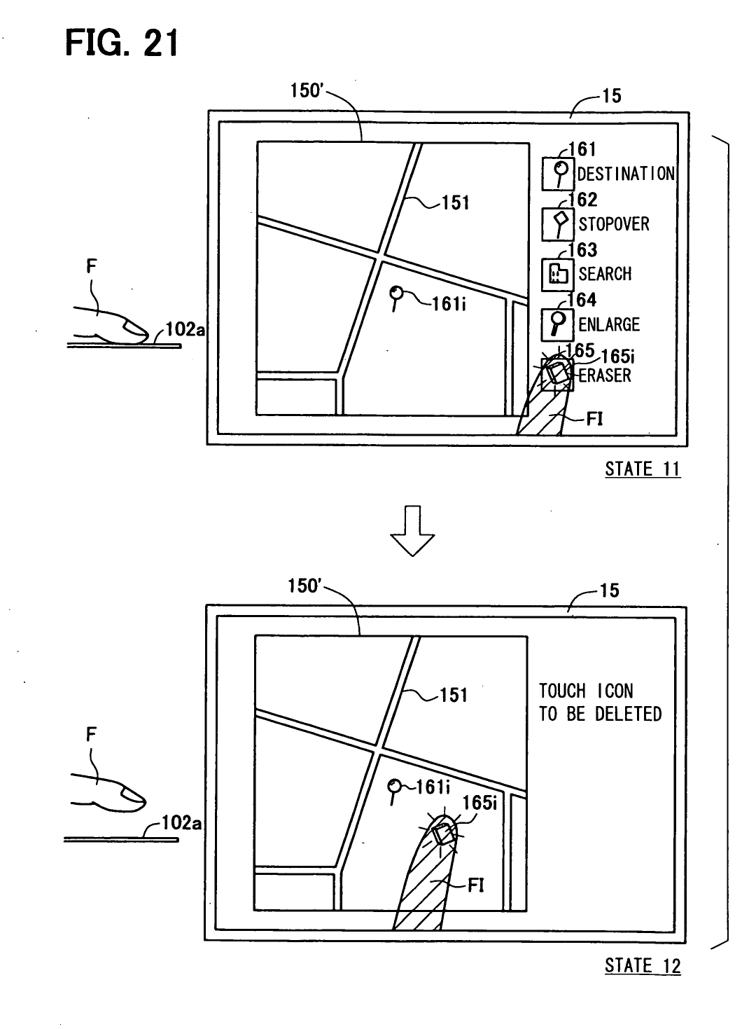

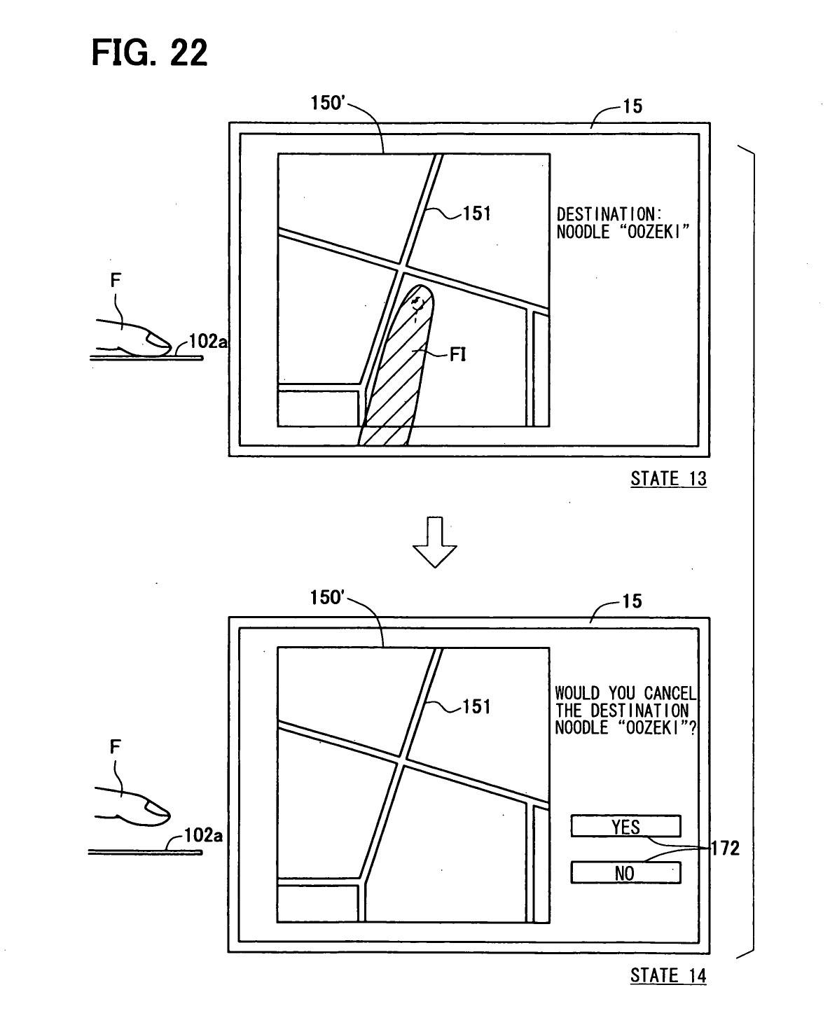

The pre-set destination can be canceled by using the eraser tool in the following ways. A user can use the eraser tool through operating the operation button image 165, which is also referred as an eraser button 165. The state 11 of FIG. 21 illustrates an icon 161i indicative of a point that has been set as the destination. A user can perform the first touch manipulation directed to the eraser button 165. Thereby, the marking image 165i (eraser icon), which is displayed as design display on the button 165, is switched into a selected state. In the above state, a user can space the finger F apart from the input manipulation surface 102a and moves the fingertip toward the pre-set destination. As shown in the state 12 of FIG. 21, the eraser icon 165i and the hand image FI are moved together in the coupling movement mode while the eraser icon 165i is being attached to the fingertip. Then, the user may point the fingertip at the icon 161i indicative of a destination on the map and performs the second touch manipulation, as shown in the state 13 of FIG. 22. Then, as shown in the state 14 of FIG. 22, the pre-set destination is changed in a temporal setting cancel state. In the present embodiment, a confirmation message and a button image 172 for the cancel confirmation are displayed on the periphery of the map display region 150′. When the user performs selection operation for confirming the cancelation such as a touch operation directed to a “YES” button, the canceling of the destination is fixed. In other words, the CPU 101 can function as a marking image pasting section or means that causes the display device to display the marking image on the display screen, such that the marking image is fixedly pasted at a place corresponding to the input location of the second touch manipulation when the coupling movement mode is switched off. At least prior to the fixing of the destination canceling, the icon 161i indicative of the destination and the eraser icon 165i disappear at the place where the second touch manipulation is performed. In other words, the CPU 101 can function as a marking image deletion section that deletes the marking image 165i at the place corresponding to the second touch manipulation when the coupling movement mode is switched off.

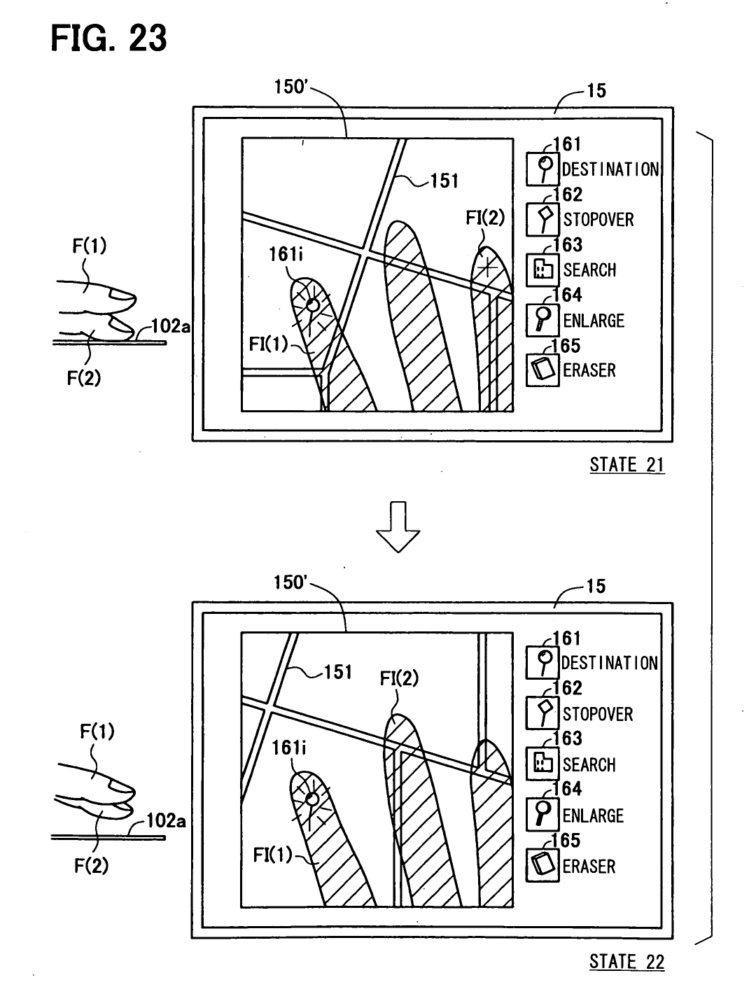

As shown in the state 21 of FIG. 23, the user can perform the first touch manipulation using one finger FI(1), and then, the user can perform the second touch manipulation using another finger FI(2) in a state where the corresponding marking image 161i is attached to the finger FI(1). In such a case, as shown in the state 22 of FIG. 23, the map is scrolled based on a point where the second touch manipulation is performed. In the above case, the map is scrolled so that the point indicated by the second touch manipulation on the map is moved to a reference position, e.g., a center of the map display region 150′.

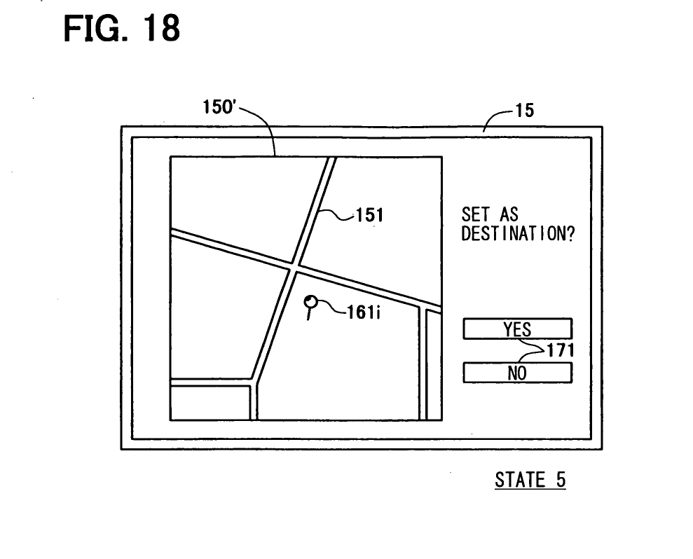

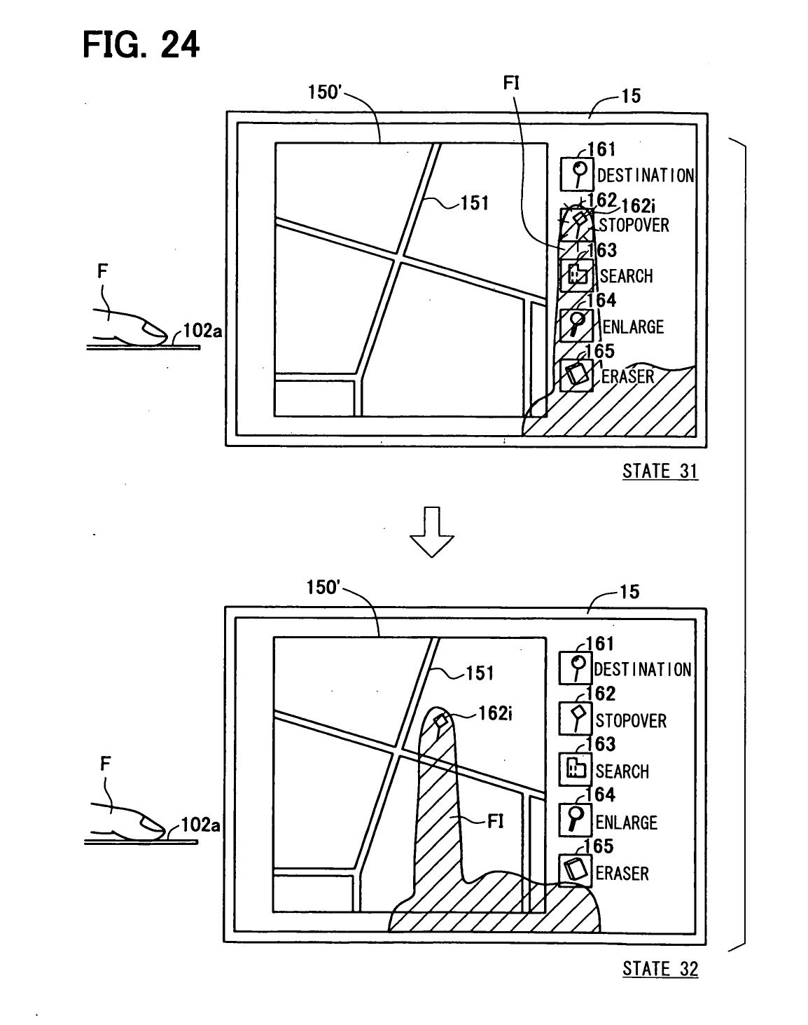

FIG. 24 illustrates an operation flow in activating the stopover point setting command to set a stopover point by using the operation button image 162. A ways of activating the stopover point setting command is basically the same as that illustrated in FIGS. 16 to 20. As shown in the state 31 of FIG. 24, the user can point the fingertip at the operation button image 162 and performs the first touch manipulation while confirming his or her finger position by watching the hand image FI. Thereby, the marking image 162i (stopover point icon), which is displayed as design display on the operation button image 162, is switched into a selected state. When the user spaces the finger F apart from the input manipulation surface 102a and moves the fingertip along the map, position of the fingertip is tracked based on the hand image captured by the camera 12b. Accordingly, the marking image 162i and the hand image FI are moved in the coupling movement mode, in which the marking image 162i and the hand image FI are moved together on the display screen while the marking image 161i is being attached to the fingertip (target fingertip). Then, as shown in the state 32 of FIG. 24, the user points the fingertip at a desired stopover point on the map and performs the second touch manipulation. Thereby, the stopover point is selected and set, and the marking image 162i (stopover icon) is pasted and displayed at the selected stopover point. In other words, the CPU 101 can function as a marking image pasting section or means that causes the display device to display the marking image on the display screen, such that the marking image is fixedly pasted at a place corresponding to the input location of the second touch manipulation when the coupling movement mode is switched off.

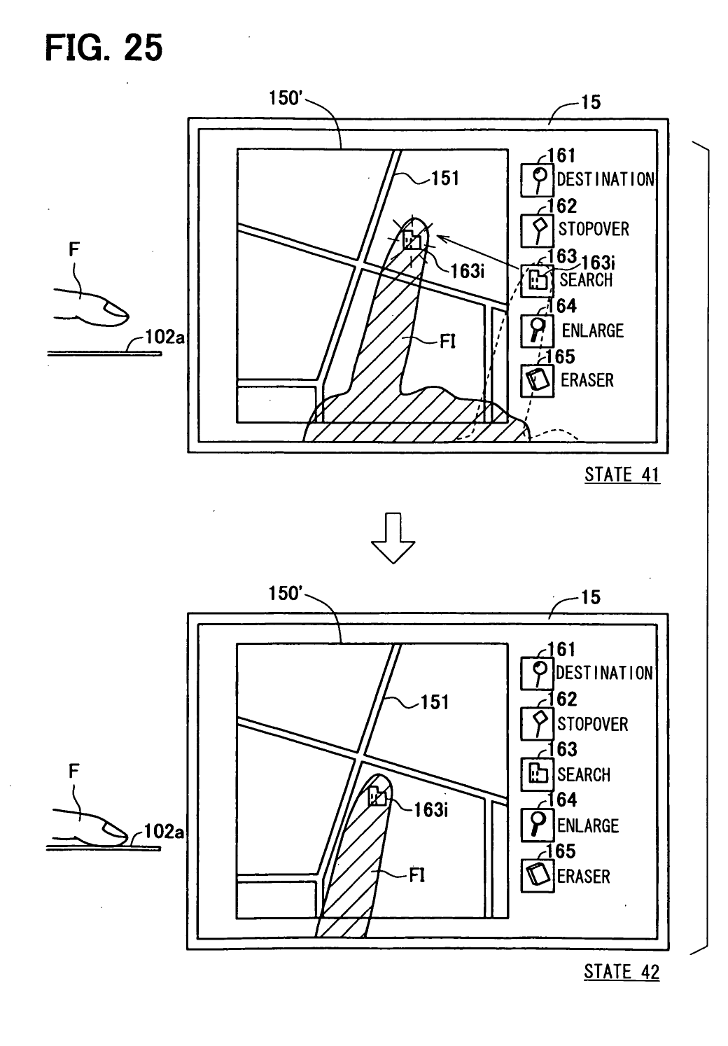

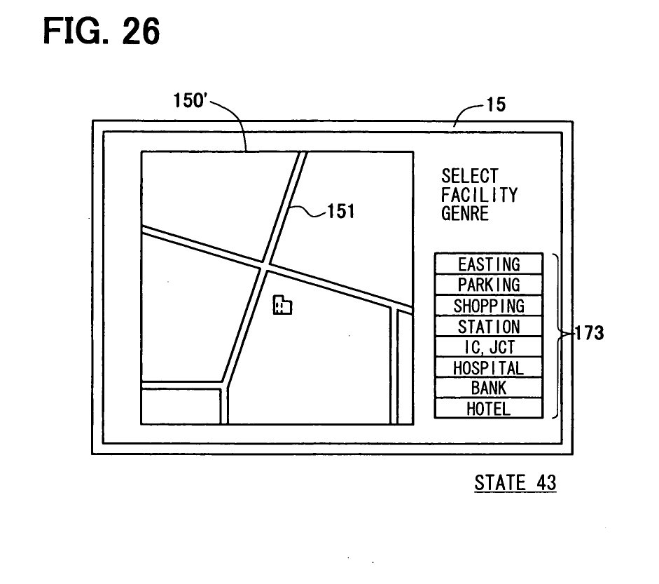

FIGS. 25 and 26 illustrate an operation flow in activating the peripheral search command by using the operation button image 163. As the state 41 of FIG. 25, a user can points the fingertip at the operation button image. 163 and performs the first touch manipulation while confirming his or her finger position by watching the hand image FI. Thereby, the marking image 163i (peripheral search icon), which is displayed as design display on the operation button image 163, is switched into a selected state. When the user spaces the finger F apart from the input manipulation surface 102a and moves the fingertip along the map, the marking image 163i and the hand image FI are moved in the coupling movement mode, in which the marking image 163i and the hand image FI are movable together on the display screen while the marking image 163i is being attached to the fingertip point (target fingertip).

Then, the user can point the fingertip at a desired point on the map, and performs the second touch manipulation, as shown in FIG. 25 as the state 42. Thereby, a point for peripheral search is selected and set, and the marking image 163i (peripheral search icon) is pasted and displayed on the map at the selected point for peripheral search. Peripheral facilities located within a predetermined distance from the selected point are retrieved as destination candidates or stopover candidates. In a case shown inn FIG. 26, a massage indicating that facility genre is selectable and button images 173 for genre selection are displayed on the periphery of the map display region 150′. When the user selects a desired genre by performing a touch manipulation directed to the button image 173, peripheral facilities classified into the selected genre are retrieved. Then, for example, the retrieved facilities are displayed in the form of facility icon on the map or in the form of list of items indicative of facility names, distances and directions.

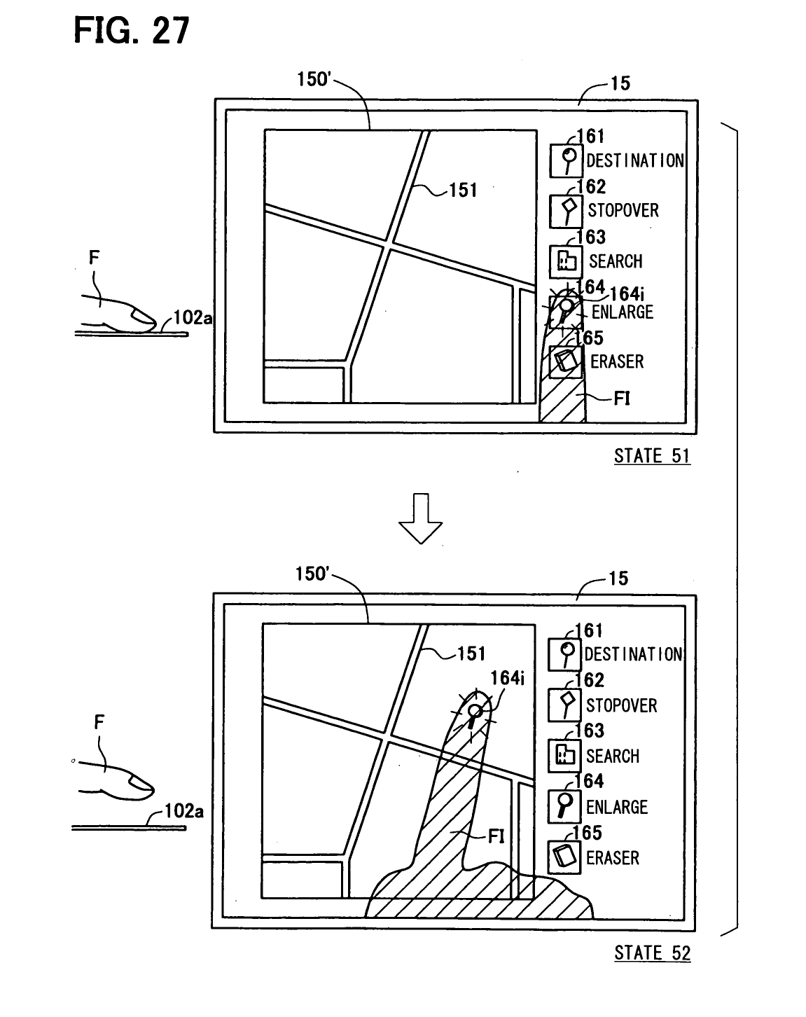

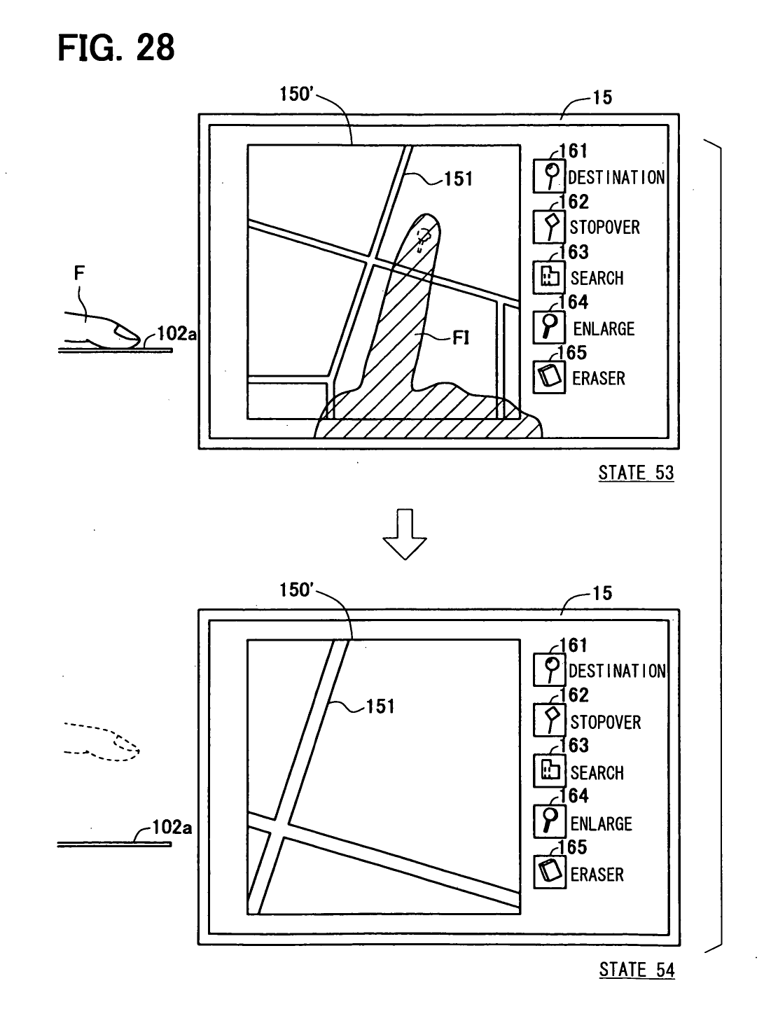

FIGS. 27 and 28 illustrate an operation flow in activating the map enlargement command to change the scale of the map by using the operation button image 164. As shown in FIG. 27 as the state 51, a user can point the fingertip at the operation button image 164 and performs the first touch manipulation while confirming his or her finger position by watching the hand image FI. Thereby, the marking image 164i (enlarge icon), which is displayed as display design on the operation button image 164, is switched into a selected state. Then, when the user spaces the finger F apart from the input manipulation surface 102a and moves the fingertip along the map, the marking image 164i and the hand image FI are moved in the coupling movement mode, in which the marking image 164i and the hand image FI are movable together on the screen while the marking image 164i is being attached to the fingertip (target fingertip), as shown in FIG. 27 as the state 52. Then, the user can point the fingertip at a desired point for enlarged display on the map, and performs the second touch manipulation to select and set the point for enlarged display, as shown in FIG. 28 as the state 53. Then, the map is enlarged at a predetermined magnification so that the selected point becomes the center of the enlarged map, as shown in FIG. 28 as the state 54. When the map is enlarged, the marking image 164i (enlarge icon) is deleted from the display screen. When the user performs a similar operation on the enlarged map again, the map can be further enlarged until map scale reaches a predetermined limit.

Operation of the control device 1 is described below with reference to flowcharts.

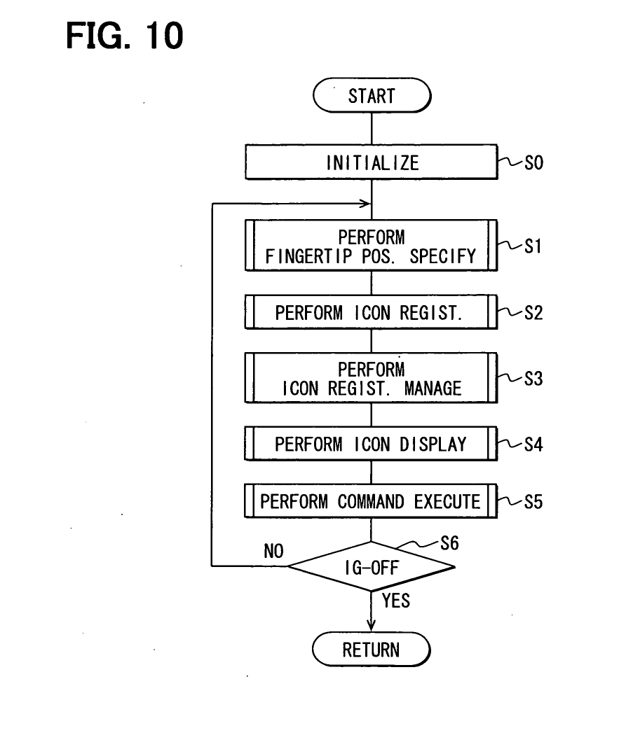

FIG. 10 is a flowchart illustrating a main procedure, which is activated when an IG (ignition) switch of the vehicle is turned on. At S0, each memory in the RAM 102 is initialized. At S1, a fingertip position specification process is performed using an image captured by the camera 12b. At S2, an icon registration process is performed in response to detection of the first touch manipulation directed to the button 161 to 165 illustrated in, for example, FIG. 16. The icon registration process is performed to register (i) an icon (marking image) that is to be moved together with the hand image FI and (ii) fingertip position corresponding to the icon, At S3, an icon registration management process is performed, which is related to the deleting of a registered icon or the canceling of icon registration, and which is related to the updating of the fingertip position. At S4, an icon paste process is performed, in which an image of an icon corresponding to a registered fingertip position is pasted on and combined with the hand image FI, so that the icon and the hand image (pointer image) are displayed so as to be movable together depending on the fingertip position, which is updated in response to movement of the hand. At S5, a command execution process is performed, in which the variety of commands corresponding to the icons are issued when the second touch manipulation is performed in the coupling movement mode. At S6, it is determined whether the IG switch is turned off. When it is determined that the IG switch is turned off, corresponding to “YES” at S6, the main procedure is ended. When it is determined that the IG switch is not turned off, corresponding to “NO” at S6, the process returns to S1.

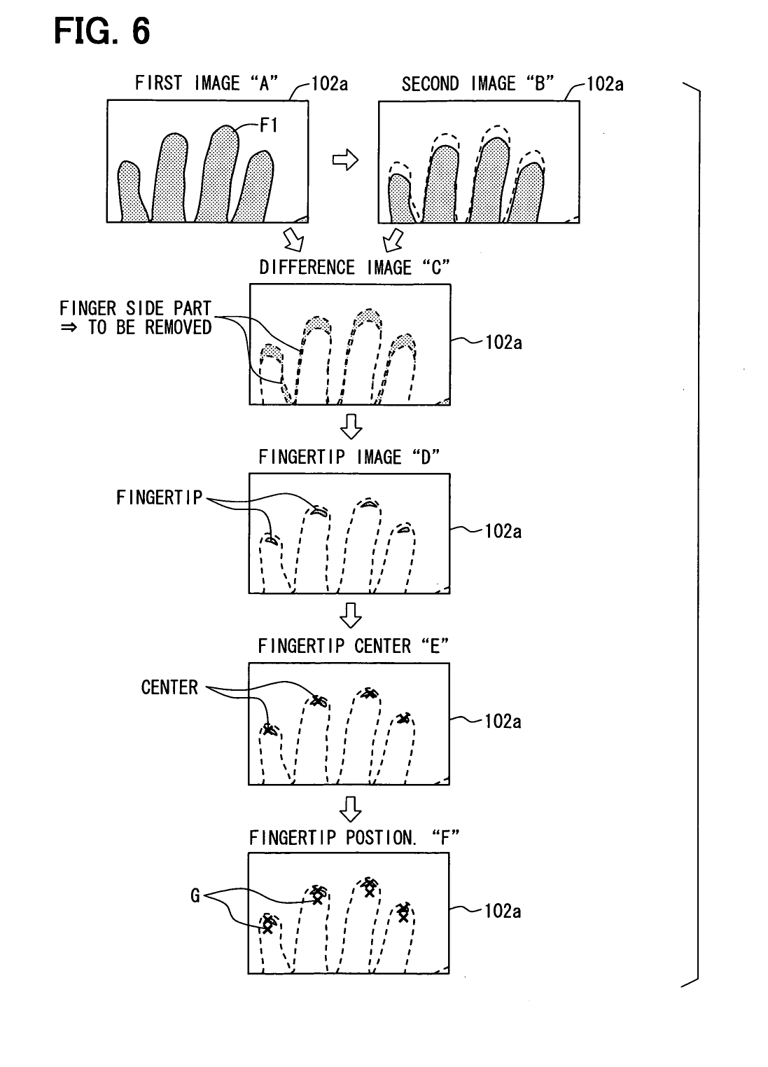

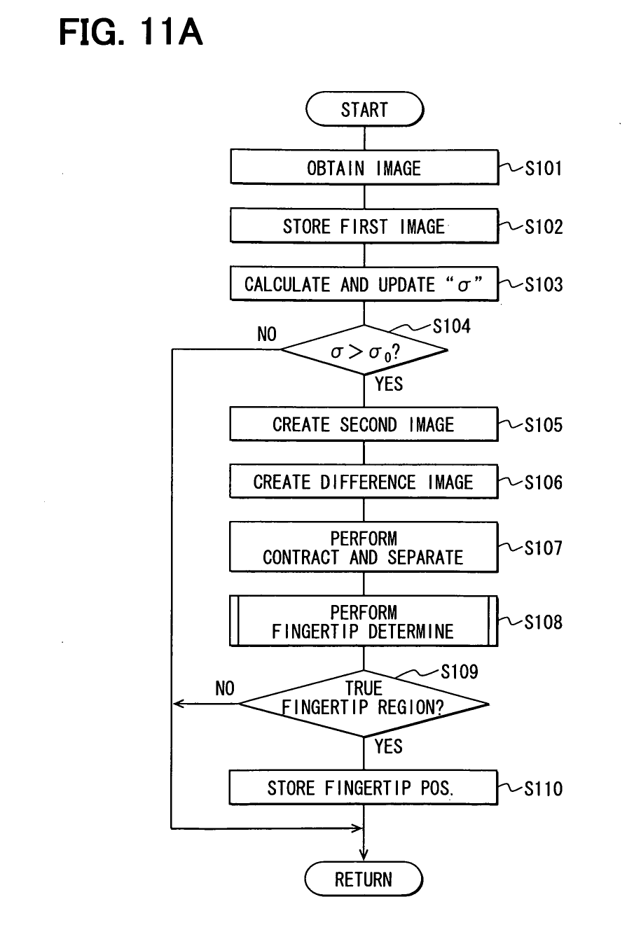

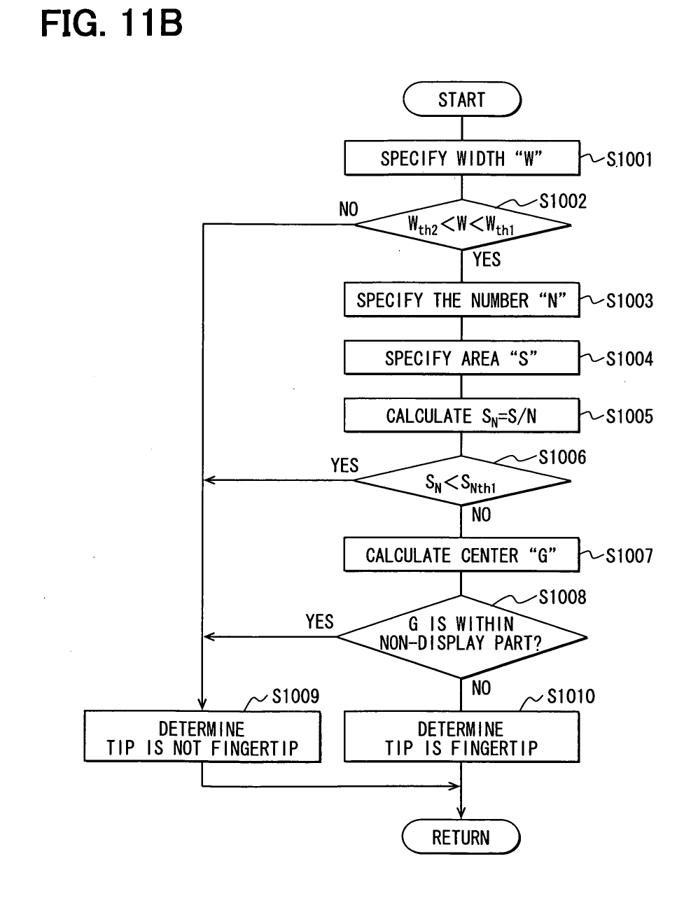

FIG. 11A is a flowchart illustrating the fingertip position specification process in details. As shown in FIG. 2, when the hand H gets access to the input manipulation surface 102a of the touch panel 12a, the camera 12b captures an image of a hand based on the light that is outputted from the illumination light source 12c and reflected from hand H. At S101, the captured image is read. In the image, the pixels representing the hand H is brighter than the pixels representing a background region. Thus, by binarizing brightness values of pixels using an appropriate threshold, it is possible to divide the image into two regions: a photographic subject region with a high brightness pixel value of “1”; and a background region with a low brightness pixel value of “0”. At S102, the binarized image is stored as a first image “A”. In the first image “A” illustrated in FIG. 6, the photographic subject region is illustrated as a dotted region and the background region is illustrated as a blank region.

At S103, area ratio σ of the photographic subject region in the first image is calculated. At S104, it is determined whether the area ratio σ is larger than a threshold ratio σ₀. When the area ratio a is less than or equal to the threshold ratio σ₀, the fingertip position specification process is ended because no photographic subject is expected to exist within the photographing range of the camera 12b.

At S105, a second image “B” is created by displacing the first image a predetermined distance in a finger extension direction, which is a direction in which a finger is extended (e.g., Y direction). The second image is, for example, one illustrated in FIG. 6. The predetermined distance is, for example, 20% to 80% length of a middle finger end portion between the end of the middle finger and the first joint of the middle finger, and may be in a range between 5 mm and 20 mm in actual length. At S106, a tip region “ta” (also called a fingertip region “ta”) is specified. As shown in FIG. 6, a difference image “C” between the first image “A” and the second image “B” is created. The tip region “ta” appears in a part of a non-overlapping region of the difference image “C”, the part being close to a finger end in the finger extension direction when the photographing subject is a hand. By superimposing the image displaced in the finger extension direction on the original image, it is possible to easily specify the fingertip region as a non-overlapping region. Even if some fingers are closed and are in close contact with each other, it is possible to reliably separate and specify multiple fingertip regions, because each fingertip region is rounded.

The difference image “C” illustrated in FIG. 6 is created using the second image “B”, which is created by displacing the first image “A” in the finger extension direction (Y direction) toward the wrist. The tip region (the finger tip region) is specified as a finger end part of the non-overlapping region of the difference image “C”. Thus, it is possible to specify the fingertip region on the first image “A”, which has the coordinate relationship to the photographing range of the camera 12b and the display screen of the monitor 15. It is possible to easily perform a specific process on the fingertip point (fingertip position) and a corresponding coordinate on the display screen.

Since the first image “A” and the second image “B” are binarized, the non-overlapping region can be specified by calculating image difference between the first image “A” and the second image “B”. Thus, a process of specifying the pixels representative of the non-overlapping region can be a logical operation between pixels of the first image “A” and corresponding pixels of the second image “B”. More specifically, the pixels of the non-overlapping region can be specified as the pixels where the exclusive-or operation between the first and second images “A” and “B” results in “0”. In some cases, the non-overlapping region between the first image “A” and the second image “B” areas in a side part of the finger. Such a side part can be easily removed in the following way for instance. When the number of consecutive “1” pixels in the X direction” is smaller than a predetermined number, the consecutive “1” pixels are inverted into “0”.

As S107 in FIG. 11A, a contraction process is performed on the fingertip region extracted in the above-described way. More specifically, a contraction process is performed on all of “1” pixels, such that a target pixel with the value of “1” is inverted into “0” when the pixels having a predetermined adjacency relationship to the target pixel includes at least one pixel with the value of “0”. The pixels having the predetermined adjacency relationship to the target pixel are, for example, four pixels that are adjacent to the target pixel on the left, the right, the upper and the lower, or eight pixels that are adjacent to the target pixel on the left, the right, the upper, and the lower, the upper left, the lower left, the upper right and the lower right. The contraction process may be performed multiple times in accordance with needs.

After the contraction process is performed, a process of separating tip regions is performed on image data. For example, as shown in FIG. 32, the image is scanned in a predetermined direction (e.g., X direction), and it is determined whether the number of consecutive “0” pixels between “1” pixels is greater than or equal to a predetermined threshed (e.g., three pixels). Thereby, it is determined whether pixels belong to the same tip region or different tip regions while a labeling code is being assigned to each pixel. In the present embodiment, the labeling code for distinguishing different tip regions is, for example, “1”, “2”, “3”, and so on. After scanning the first row, each when the detected pixel state is changed from “0” pixel to “1” pixel in the scanning, the labels of eight pixels surrounding the “1” pixel are determined. When the eight pixels contain a pixel to which the labeling code has already assigned, the same label code is assigned. When the eight pixels do not contain a pixel to which the labeling code has already assigned, a new labeling code is assigned. Groups of pixels assigned to different labeling code are recognized as different tip regions.

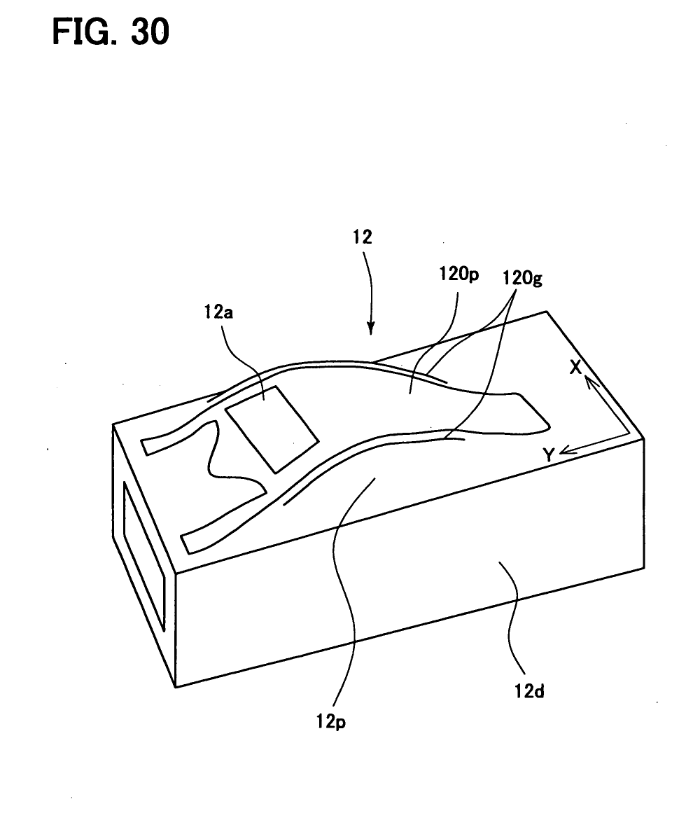

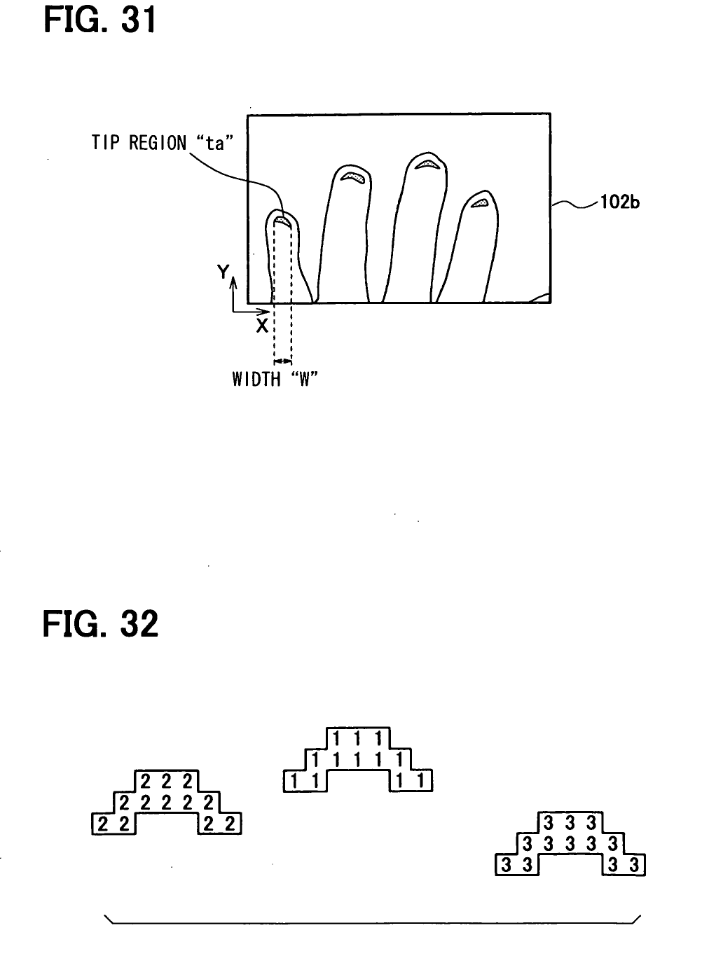

At S108 in FIG. 11A, a fingertip determination process is performed to determine whether each of the separated and specified tip regions is a true fingertip region. As shown in FIG. 31, a necessary condition to determine that a tip region “ta” is a true fingertip region is, for example, that width W of the tip region “ta” in a finger width direction is within a predetermined range between an upper limit Wₜₕ₁ and a lower limit Wₜₕ₂. The predetermined range may be preliminarily set based on finger width of ordinary adult persons. As shown in FIG. 1, when the user sitting the seat uses the control device 1, the hand of the user is typically inserted in the photographing range 102b of the camera 12b in an insertion direction from a back side to a front side of the photographing range. The insertion direction is substantially the same of a heading direction of the vehicle, since the touch panel 12a minted to the center console C and the camera 12b captures an image of the hand from below the input manipulation surface 102a of the touch panel 12a. Thus, the insertion direction of the hand is expected to the Y direction, which is perpendicular to a longitudinal direction of the photographing range 102b having a rectangular shape with a longer side in the longitudinal direction. A finger width direction is expected to the X direction, which is perpendicular to the hand insertion direction on the input manipulation surface 102a, and which matches the longitudinal direction of the photographing range 102b. The width W of the tip region is fixedly measured in the X direction, which is parallel to the longitudinal direction of the photographing range 102b.

FIG. 11B is a flowchart illustrating the fingertip determination process. At S1001, the width “W” of each separated and specified tip region “ta” is specified. More specifically, the width “W” of each tip region “ta” can be calculated as W=Xₘₐₓ−Xₘᵢₙ where Xₘₐₓ is the maximum X coordinate of the pixel in the tip region and Xₘᵢₙ is the minimum X coordinate of the pixel in the tip region. At S1002, it is determined whether the width W specified in S1001 is in the predetermined range. Although the touch panel 12a is mounted to the center console C, a driver or a passenger sitting next to the center console C frequently puts things to the center console C. In such a case, when things other than the hand are put to the input manipulation surface 102a of the touch panel 12a or are put inside the photographing range 102b, the camera 12b captures an image of things in place of an image of a hand.

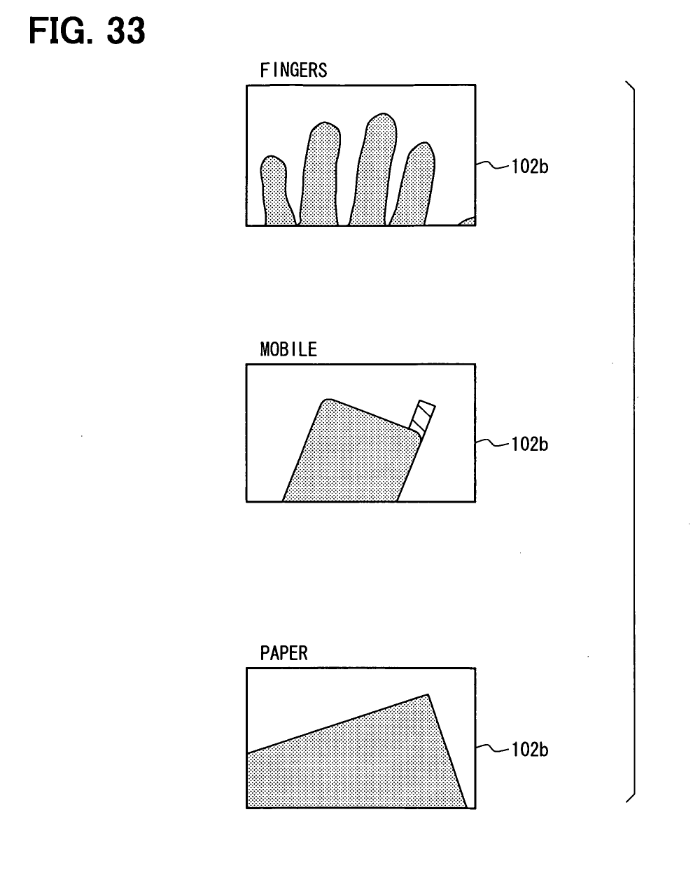

In FIG. 33, a binarized image of hand is illustrated at an upper part, a binarized image of mobile phone is illustrated at a middle part, and a binarized image of paper is illustrated at a lower part. An outline of the mobile phone or paper in the image is much simpler than that of the hand and is clearly different in shape from that of the hand. If an approximation using an ellipse that circumscribes the outline is performed, a complicated outline of the hand is changed into a simpler ellipsoidal form, and thus, it becomes difficult to distinguish the hand from the originally-simple-shaped things such as mobile phone, paper and the like. If an outline of a finger pulp is approximated using an high-dimension function, it is difficult to uniquely determine whether coefficients of the high-dimension obtained in the approximation or the like provides a true finger outline. Further, the following method brings the following difficulty. A circumscribing polygon in the captured image is divided into multiple sub-polygons, and it is determined from area ratios of the sub-polygons whether a thing in the image has a shape that does not require calculation of a coordinate of the fingertip. In this method, however, if area ratio of the thing other than hand in the captured image accidentally matches typical area ratio of the hand, it becomes impossible to distinguish between the thing and the hand.

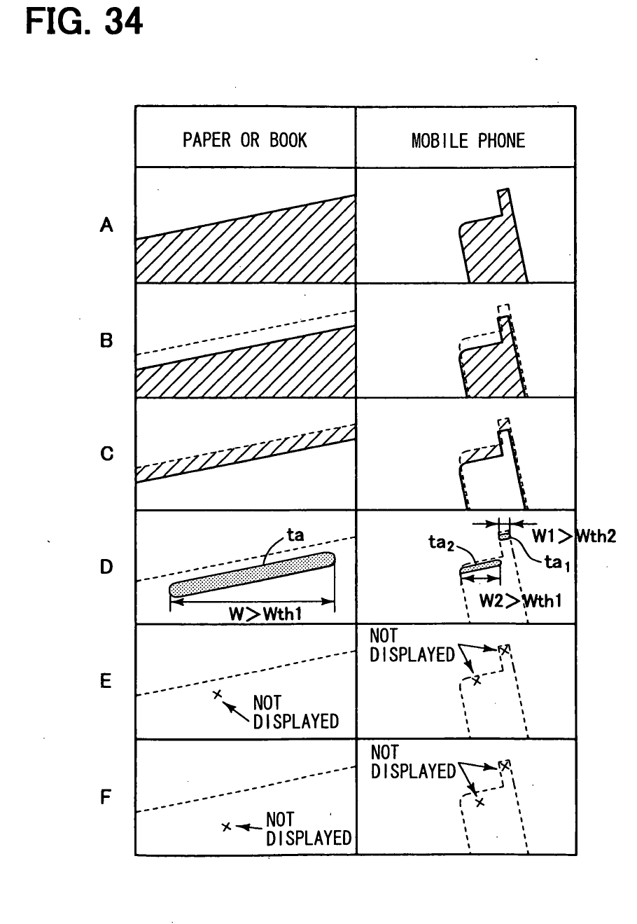

However, the present embodiment can reliably distinguish the hand from things other than the hand, because the present embodiment employs the identification method using the width “W' of the tip region “ta”, which is extracted from the different image “C” between the first image “A” and the second image “B”, wherein the first image is a captured image and the second image is one made by parallel-displacing the first image in the Y direction. Thus, as shown in the left side o FIG. 34, when a paper or a book is put, the width “W” of the extracted and identified tip region “ta” clearly exceeds the upper limit “Wₜₕ₁” of the predetermined range, which is determined based on finger width of ordinary adult persons. The width “W” of the extracted and identified tip region “ta” can be reliably determined as a non-fingertip region. When a mobile phone is put, width “W₁” of a first tip region “ta₁” originating from an antenna is clearly thinner than finger width, and the width “W₁” becomes smaller than the lower limit “Wₜₕ₂” of the predetermined range, as shown in the right side of FIG. 34. Further, width “W₂” of a second tip region “ta₂” originating from a body of the mobile phone exceeds the upper limit “Wₜₕ₁” of the predetermined range. Thus, both of the first and second tip regions “ta₁” and “ta₂” can be determined as non-fingertip regions.

When the hand is imaged, there may be arises the following case: one or two fingers are extended (e.g., only the forefinger is extending or the forefinger and the middle finger are extending); and the rest of fingers are closed (e.g., the rest of finger are clenched into a fist). In such a case, width of a tip region of the closed finger may exceed the upper limit W_th1″ of the predetermined range and width of the extended finger is in the predetermined range. In view of the above, when multiple tip regions are extractable from a thing, if at least one of the multiple tip regions is in the predetermined range, the tip region in the predetermined range may be determined as a true fingertip region.

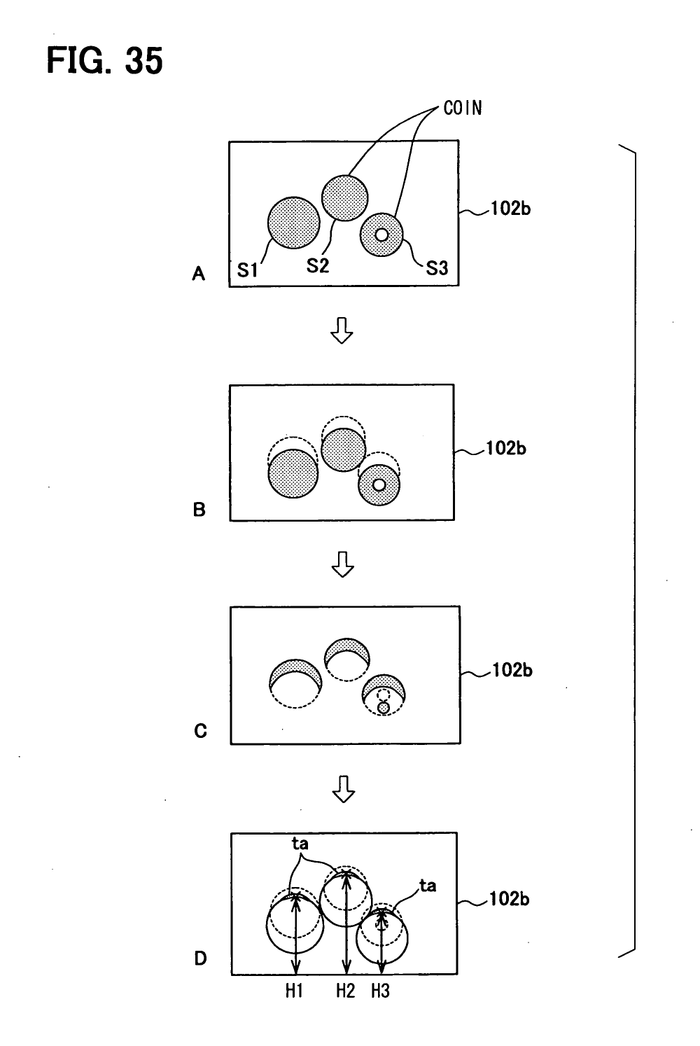

In some cases, there may be a possibility that a user puts to the input manipulation surface 102a of the touch panel 12a a thing whose tip region is not actually a non-fingertip region but the tip region can be wrongly detected as a true finger tip region because width of the tip region is in the predetermined range. FIG. 35 illustrates a binarized image “A” of a coin putted to the input manipulation surface 102a. The binarized image “B” is created by displacing the binarized image “A” in the Y direction. The binarized image “C” is a difference image between the binarized images “A” and “B”. The binarized image “D” is created by performing the contraction process on the binarized image “C”. Since width of the coin is similar to that of a finger, width of the tip region “ta” in the binarized image “D” can be in the predetermined range. Thus, the tip region can be wrongly identified as a fingertip region in this state.

A difference between a finger and a coin on an image includes the followings. In a case of finger, a finger base reaches a back end of the photographing range 102b (the back end is an end in the insertion direction of the hand and may be located closest to the rear of the vehicle among the ends of the photographing range 102b). In a case of coin, on the other hand, the coin forms a circular region that is isolated in the photographing range 102b, and forms the background region (a region with “0” pixel value) between the back end of the circular region and the back end of the photographing range 102b. Taking into account the difference, it is possible to avoid the above described wrong identification in the following way. Total area “S” of a photographing subject is calculated. In the case illustrated in FIG. 35, the total area “S” is S=S1+S2+S3. The sum of distances H1, H2, H3 from the non-overlapping regions “ta” to the back end of the photographing range 102b are calculated as d=H1, H2, H3, as shown in FIG. 35. Then, an estimation finger width is calculated as S/d to avoid the above-described wrong identification. For example, in a coin case, since the background region exists between the coin and the back end of the photographing range, the total area “S” decreases. Thus, when the estimation finger width S/d is smaller than the lower limit W_th1 of the predetermined range, the tip region is determined as a non-tip region. It should be noted that, for each tip region, the estimation finger width S1/H1, S2/H2, S3/H3 may be calculated and compared to the lower limit W_th1 of the predetermined range. S1005 and S1006 in FIG. 11B are performed based on the above described principle.

At S1007 in FIG. 11B, a representation point is determined in the tip region “ta” that is determined at S1001 and S1006 as the fingertip region. In the present embodiment, a geometrical center G of the fingertip region is used as the representation point. It is, possible to use a known calculation method to obtain the geometrical center G. For example, the sum of X coordinates of pixels forming the tip region and the sum of Y coordinates of pixels forming the tip region are calculated. The sum is divided by the number of pixel forming the tip region to obtain the geometrical center G. Alternatively, the representation point may be other than the geometrical center and may be a pixel that has the maximum Y coordinate in the tip region.

A region of a finger that actually contacts the touch panel 12a may be a region around finger pulp that is away from the finger end in the Y direction. In an image “F” related to FIG. 6 or FIG. 35, the center Gin an image “E” is offset a predetermined distance in the Y direction, and the offset point is set as a fingertip point G. Alternatively, the center G in the image E may be used as the fingertip point G without the offset. In such a case, a process related to the image “F” is unnecessary.

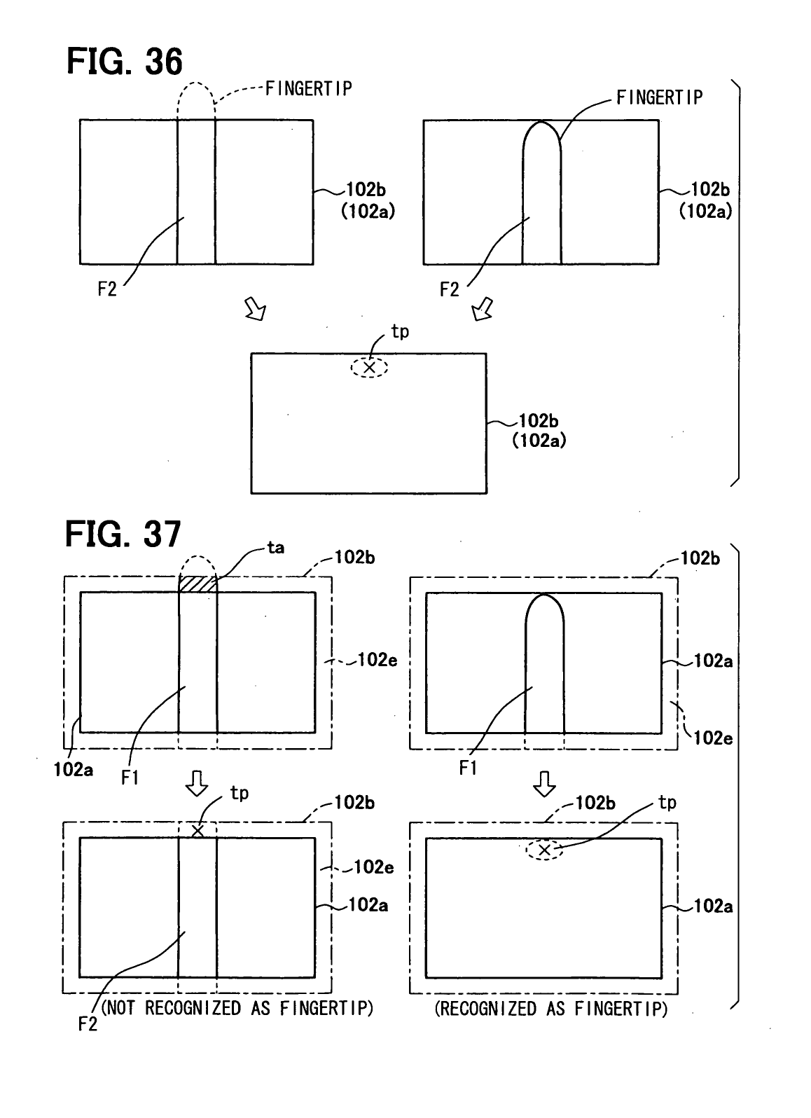

There may arise a case where the representation point determined by the above-described algorithm using the difference image does not correspond to a true fingertip point, depending on a positional relationship between the hand and the photographing range. More specifically, there may arise a case where a fingertip region is stick out from the photographing range, as shown in an upper left case in FIG. 36. When ranges of the coordinate systems of the photographing range 102b, the input manipulation surface 102a of the touch panel 12a and the display screen of the monitor 15 are coincident with each other, there may arise the following situation. In an upper right case in FIG. 36, an actual fingertip position is contained in an outer boundary region of the photographing range 102b (consequently contained in the input manipulation surface 102a and the display screen of the monitor 15). In the upper left case in FIG. 36, an actual fingertip position is out of the photographing range 102b. In both of the upper right case and the upper left case, a tip region identified from a difference image is contained in the outer boundary region. Even when the fingertip region is stick out as shown in the upper left case in FIG. 36, the finger image F2 is still an image of the finger and the width is possibly in the predetermined range. Thus, there may arise a difficulty that the tip region appearing in the outer boundary region is wrongly detected as a true fingertip region.

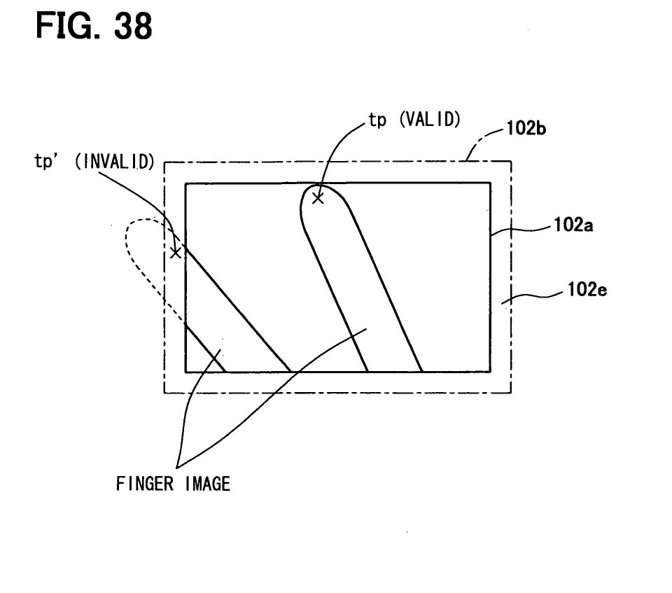

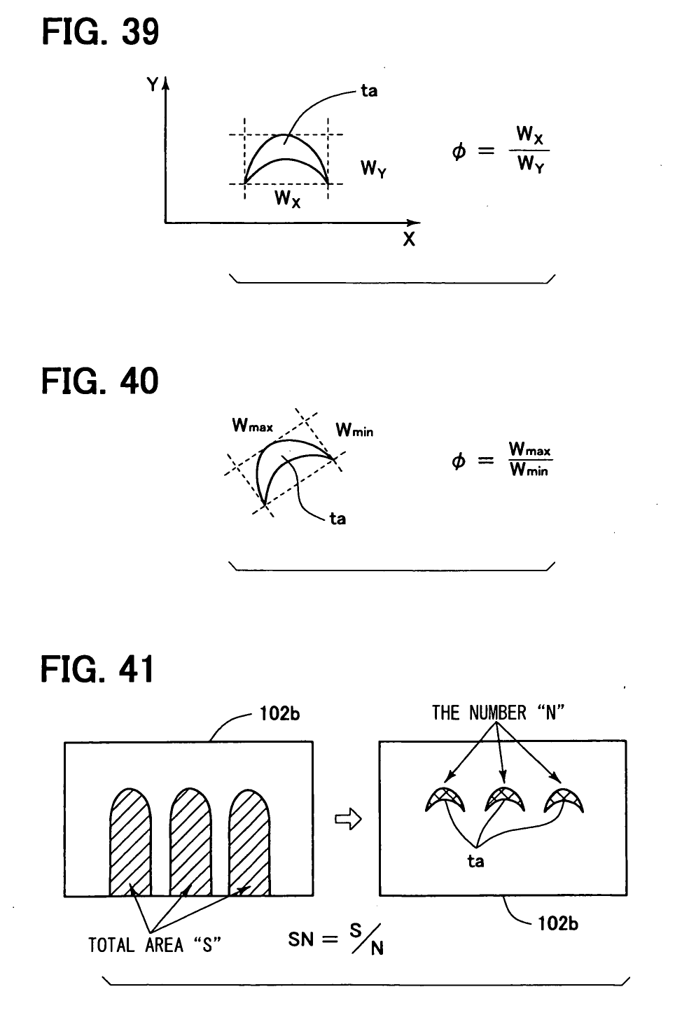

The present embodiment addresses the above difficulty in the following ways. A non-display imaging region is set to the outer boundary region of the photographing range 102b, as shown in FIG. 38. The non-display imaging region 102e is outside of a valid range of the coordinate system. Note that the coordinate system is defined in the valid range. The input manipulation surface 102a and the display screen correspond to each other in range of the coordinate systems.

In one case, as shown in the left of FIG. 3, because a part of the finger sticking out from the display screen forms a photographing subject region in the non-display imaging region 102e, a tip region “ta” identified based on a difference image and a fingertip position specified as a representation point is located in the non-display imaging region 102e. In another case, as shown in the right of FIG. 3, when an actual finger end does not enter in the non-display imaging region 102e and is displayed on an outer boundary part of the display window, the tip region “ta” and the fingertip position “tp” appears inside the display window. Thus, it is possible to perform such a process of unrecognizing the tip region “ta” in the non-display imaging region 102e as a true finger end (invalid), and recognizing the tip region “ta” outside the non-display imaging region 102e as a true finger end (valid). For example, as shown in FIG. 38, even if multiple fingertip positions are specified, it is possible to determine whether each tip region is valid or invalid based on whether the each tip region is in the non-display imaging region 102e. Processes S1008 to S1010 in the flowchart of FIG. 11B are performed based on the above-described principles. In the above, the back end of the display screen, through which the hand is inserted in the Y direction, may match the back end of the photographing range, so that the non-display imaging region 102e is not provided at the back end.

It should be noted that it is possible to use a variety of algorithms different from the above-described algorithm as an algorithm for determining whether a tip region “ta” is a true fingertip region. For example, the displacement distance, by which the first image is displaced in Y direction to obtain the second image, may be set smaller than a common adult finger width. In such a case, a tip region appearing in the difference image between the first and second image tends to have such dimensions that the dimension W_{X} in the X direction is larger than the dimension W_{Y} in the Y direction, and the tip region has the longer dimension in the X direction. Thus, it is possible to determine whether the tip region “ta” is a true fingertip region based on whether an aspect ratio φ (=W_{X}/W_{Y}) of the tip region “ta” is in a predetermined range. For example, the aspect ratio φ of a paper or document illustrated in the left of FIG. 34 becomes extremely large, and the aspect ratio φ of a mobile phone illustrated in the right of FIG. 34 becomes small because of a small dimension “W_{X}” in the X direction. Thus, the tip regions of the paper, the document, the mobile phone and the like can be excluded and detected as non-fingertip regions.

Taking into consideration a case where an inserted finger is inclined with respect to the Y direction, the aspect ratio φ may be calculated in the following manner. As shown in FIG. 40, various pairs of parallel lines circumscribing the tip region “ta” are generated so that angles of the parallel lines are different between different pairs. Among the various pairs, the maximum distance between the parallel lines is retrieved as “Wₘₐₓ” and the minimum distance between the parallel lines is retrieved as “Wₘᵢₙ”. Then, the aspect ratio φ is calculated as Wₘₐₓ/Wₘᵢₙ.

Alternatively, as shown in FIG. 41, it is also possible to determine whether a tip region “ta” is a true fingertip region based on the following way. Total area S of a photographing subject (i.e., “0” pixels region) in the captured image is calculated and the number N of tip regions “ta” (i.e., non-overlapping regions) is specified. An average finger area is estimated as S/N. Then, it is determined whether the tip region “ta” is a true fingertip region based on whether S/N is in a predetermined range. This determination way is especially effective when the dimension of the photographing range in the Y direction is set so that the photographing range receives only a finger end part of the hand, and so that the photographing subject in the image of a hand becomes only fingers.

Explanation is retuned to FIG. 11A. When the fingertip determination process at S108 is finished, the process proceeds to S109. At S109, it is investigated which one or ones of the specified tip regions has been determined to be a true fingertip region. At S110, only for the true fingertip region, the coordinate of the representation point (e.g., the center coordinate G) is stored as the fingertip position. Further, the coordinate of a not true fingertip region is removed or invalidated. After S110, the fingertip position specification process is ended.

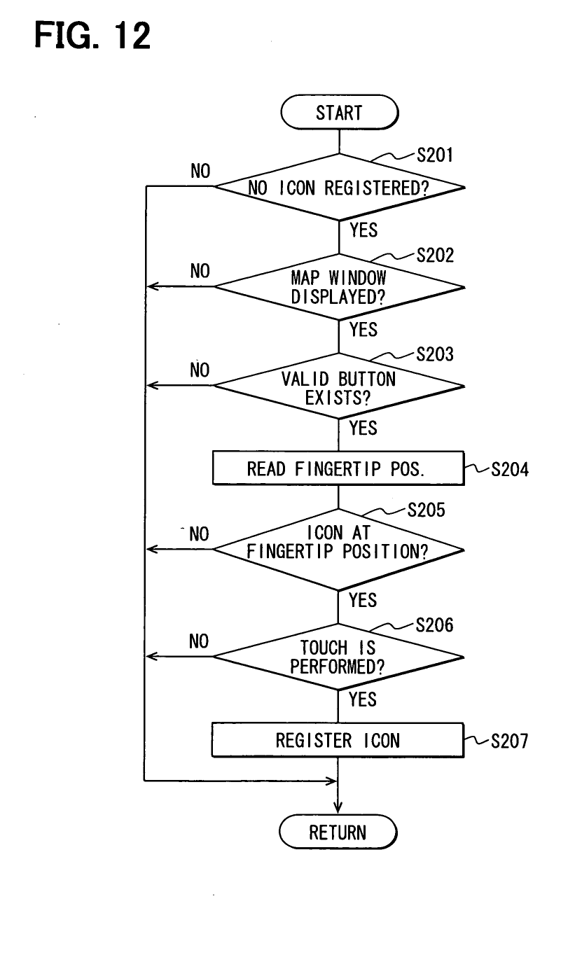

FIG. 12 is a flowchart illustrating details of the icon registration process. At S201, it is determined whether no registration icon exists. When it is determined that no registration icon exists, the process proceeds to S202. At S202, it is determined whether the map display region 150′ illustrated in FIG. 16 is displayed on the display screen. At S203, it is determined whether the operation button image 161 to 165 having the icon exists in the display screen. The operation button image 161 to 165 having the icon is also referred to hereinafter as an icon-attached-button. At S204, the present position of the fingertip is obtained from the fingertip position memory 1102a′ (see FIG. 7). At S205, it is determined whether the position of the fingertip is at the icon. At S206, it is determined whether a touch manipulation (first touch manipulation) is performed at the position of the fingertip. At S207, it is determined that the touch manipulation selects the corresponding icon (marking image), and the icon is stored in the icon registration memory 1102c as being related to the position of the fingertip. When the determination results in “NO” at any one of S201, S202, S203, S205 and S206, the icon registration is not performed. The icon registered in the icon registration memory 1102c is displayed together with the finger image FI (pointer image) so that the icon and the finger image FI are move together in the coupling movement mode in response to the updating of the position of the registered fingertip in the below-described registration management process. When the icon registration is canceled in the registration management process, the coupling movement mode is turned off.

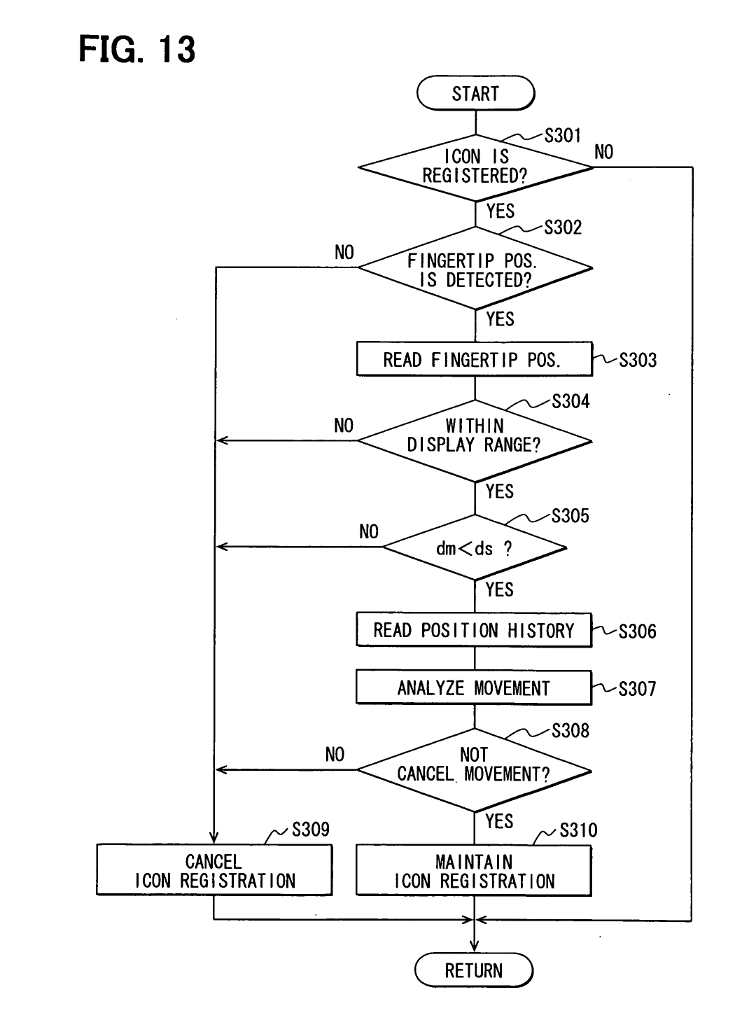

FIG. 13 is a flowchart illustrating details of the icon registration management process. At S301, it is determined whether the registered icon exists. At S302, it is determined whether the position of the fingertip is being detected. At S303, the position of the fingertip registered in the icon registration memory 1102c is read. For simplicity, the position of the fingertip registered in the icon registration memory 1102c is also referred to herein as a registered fingertip position. At S304, of the latest positions of the currently-detected fingertips, one fingertip that is closest to the registered fingertip position is specified. Further, it is determined whether at least one currently-detected fingertip has the position in the display range. In other words, it is determined that whether at least one currently-detected fingertip is located in the non-display imaging region 102e. When any one of the latest positions of the currently-detected fingertips is not inside the display range, corresponding to “NO” at S308, the process proceeds to S309 where the icon registration is canceled. At S305, a distance “dm” between the latest position of the currently-detected fingertip and the position of the registered fingertip is calculated. Further, it is determined whether the distance “dm” is in a prescribed range. When the distance “dm” is not in the prescribed range, corresponding to “NO” at S305, the process proceeds to S309 to cancel the icon registration.

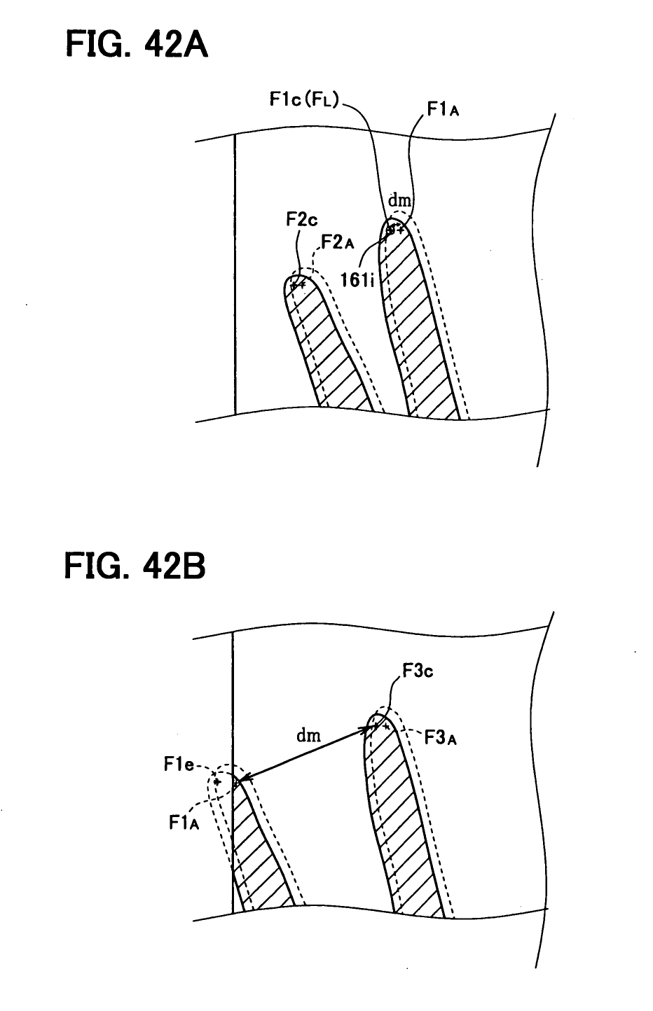

More specifically, in a manner shown in FIG. 42A for instance, it is determined whether the distance “dm” is in the prescribed range, by taking into account cycle time of the main procedure. When time of one cycle is in a range between 10 ms and 100 ms for instance, displacement of finger for operating an icon is not so large and is in range between 5 mm and 15 mm, which corresponds to a threshold “ds”. Thus, as shown in FIG. 42A, when the distance dm is smaller than the threshold “ds”, it is determined that the icon registration should be maintained. In FIG. 42B, of the latest positions of the fingertips F1e and F3c, the fingertip F1e is out of the display range. Thus, the fingertip F1e is determined as a non-fingertip region at the process S1008 and S1009 in FIG. 11B. The position of the fingertip F1e is invalided and removed from the fingertip position memory 1102a′. When the fingertip position F1_{A} corresponding to the fingertip F1e is stored in the icon registration memory 1102c as a registered fingertip position (which is a target for coupling movement with an icon), a corresponding latest fingertip position F3_{C} is invalid, and thus, the fingertip position closest to the corresponding latest fingertip position F3_{C} becomes the fingertip position F3_{C} of another finger. However, because the registered fingertip position F1_{A} is a fingertip position of a different finger, the distance “dm” exceeds a threshold distance “ds”. In this case, the icon registration is canceled.

At S307, a history of the fingertip position is read from the icon registration memory 1102c, and a movement indicated by the history is analyzed. At S308, it is determined whether the analyzed movement corresponds to the cancellation movement. When the analyzed movement is determined to correspond to the cancellation movement, the process proceeds to S308 where the icon registration is cancelled. When the left-right finger wave movement is set as the cancellation movement as shown in FIG. 20, a variation in value of the Y-coordinate is not so large but value of the X-coordinate is largely varied and is oscillated inside a constant range. Thus, as shown in FIG. 9, it can be easily determined whether the finger wave movement is made, by checking whether the value of the X coordinate is periodically is varied inside the constant range.

When all of the determinations at S302, S304 and S308 results in “YES”, the process proceeds to S310 where the icon registration is maintained. It should be noted that the registered fingertip position is updated as the latest position of the currently-detected fingertip.

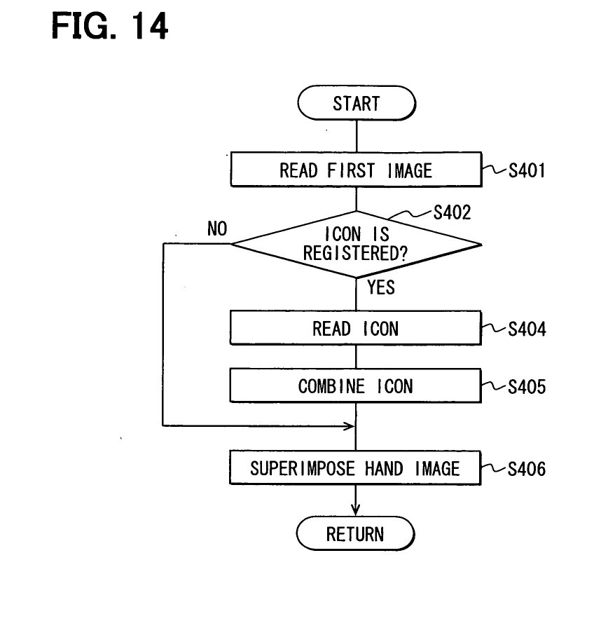

FIG. 14 is a flowchart illustrating details of the icon synthesis display process. At S401, image data of the hand image including a pointer image, in other words, data of the first image illustrated in FIG. 6A is read. At S402, it is determined whether there exists the registered icon. When it is determined that the registered icon exists, corresponding to “YES” at S402, the process proceeds to S404. At S404, a registered icon image and the registered fingertip position are read from the icon registration memory 1102c. At S405, the registered icon image is combined with the first image. At S406, the synthesized image is displayed on the, display screen, in other words, the hand image is superimposed on the display screen. As long as the registered icon image is unchanged, the icon and the hand image are displayed together so as to move together because the registered fingertip position is updates at S301 every time the main procedure is performed one cycle. When it is determined that no registered icon exists, corresponding to “NO” at S402, the process proceeds to S406 whiling skipping S404 and S405. In such a case, the hand image is displayed without the icon.

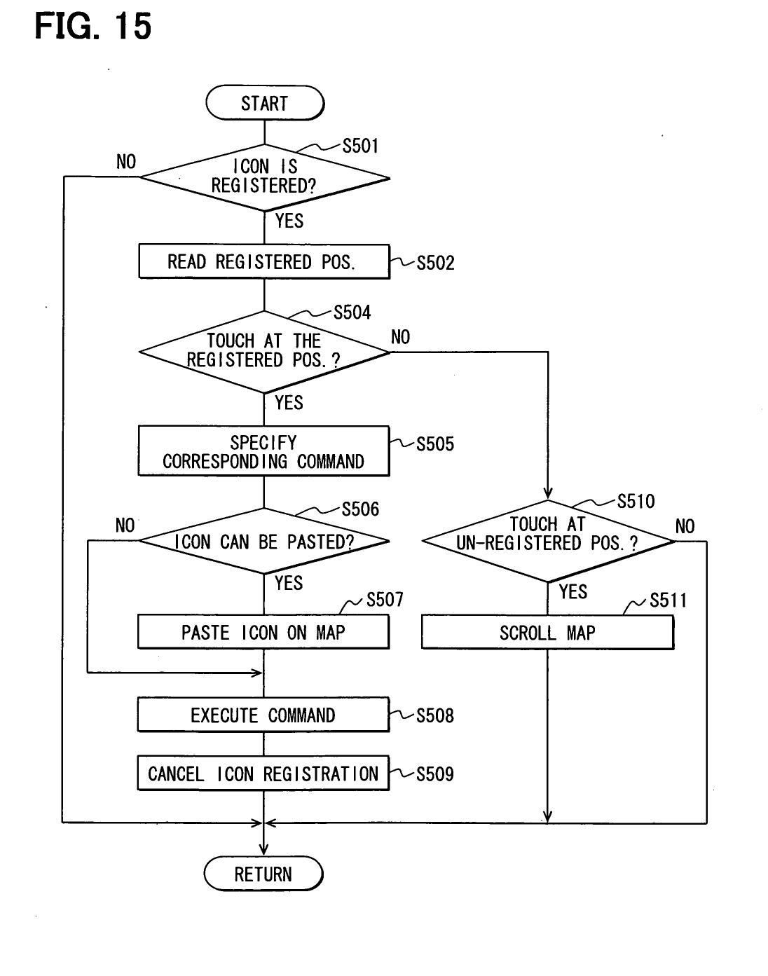

FIG. 15 is a flowchart illustrating details of the command execution process. At S501, it is determined whether the registered icon exists. When it is determined that the registered icon exists, the process proceeds to S502 where the registered fingertip position is read. At S504, it is determined whether a touch manipulation on the touch panel is performed at an input location corresponding to the registered fingertip position. In other words, it is determined at S504 whether the second touch manipulation is performed. When it is determined that the second touch manipulation is performed, the process proceeds to S505 where a control command associated with the registered icon is specified. Note that the control command may have the following properties. The destination setting command associated with the button 161 (see FIG. 16), the stopover point setting command associated with the button 162 and the peripheral facilities search command associated with the button 163 are in a type of icon pasting command, which causes a corresponding icon (i.e., the marking image) to be pasted at a place that is set by the second touch manipulation. The map enlarge display command associated with the button 164 and the eraser tool associated with the button 165 are in a type of icon delete command, which does not cause a corresponding icon (i.e., the marking image) to be pasted but causes the icon to be deleted after the map enlarge display command or the eraser tool is executed.

At S506, the type of the specified control command is clarified. When the specified control command is in the type of icon pasting command, the process proceeds to S507 where the icon is pasted at a place corresponding to the second touch manipulation. When the specified control command is the type of icon delete command, the process proceeds to S508 while skipping S507. At S508, the corresponding control command is executed. At S509, the icon registration is canceled.

When it is determined at S504 that a touch manipulation on the touch panel is not performed at an input location corresponding to the registered fingertip position, the process proceeds to S510. At S510, it is determined whether a touch manipulation is performed at a place that is inside the map display region 150′ and is different from the registered fingertip position. The detection of the touch manipulation at S510 indicates that the touch manipulation is made by a finger different from the finger whose fingertip position is registered. Thus, when the determination at S510 results in “YES”, the process proceeds to S511 where the map scroll process illustrated in FIG. 23 is performed.

### Modifications of First Embodiment

The first embodiment can be modified in various ways, examples of which are described below.

In the first embodiment, when a finger is escaped to an outside of the display range (corresponding to the pointer displayable region) in the coupling movement mode, the coupling movement mode is turned off. Even if the same finger is then returned to the display range, the coupling movement mode is maintained at an off state. Alternatively, the coupling movement mode may be maintained at an on state when the finger is escaped to the outside of the display range (corresponding to the pointer displayable region). Further, when the finger is returned to the display range, the icon may be displayed so as to be attached to the finger. The above alternative is illustrated in FIG. 43. A margin region having a predetermined width ξ is set in the photographing range so that the margin region is located adjacent to and inward of the non-display imaging region and the margin region extends along a perimeter of the display range of the monitor 15. When the registered fingertip position F1_{A} (target fingertip position) in the margin region is moved into the non-display imaging region (see F1_{C} in FIG. 43), the registered fingertip position F1_{A} in the margin region is stored as a reserved fingertip position F_{R} for a predetermined period. In such a case, the icon registration is maintained. Then, when the fingertip position is detected again in the margin region, the detected fingertip position is set to the registered fingertip position F1_{C}. Further, the icon is pasted at the registered fingertip position F1_{C} and the coupling movement mode comebacks. If multiple fingertip positions are detected in the margin region, the fingertip position closest to the reserved fingertip position F_{R} is selected as the registered fingertip position F1_{C}.

In the first embodiment, the move target image is the marking image acting as an icon. Alternatively, the move target image may be an icon 701 representative of a folder or a file. In the alternative, the first touch manipulation switches the icon 701 in the selected state. When the finger is then spaced apart from the touch panel 12a and is moved, the icon 701 is moved together with the pointer image until the second touch manipulation is performed. It is thereby possible to perform so called a drag operation on a file or a fold.

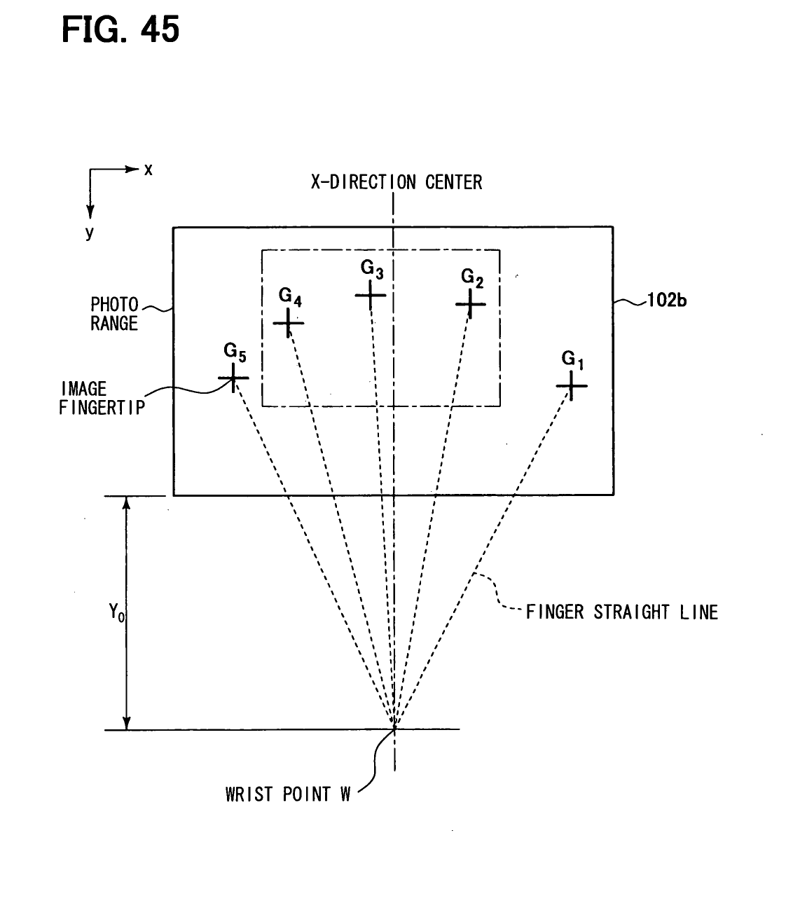

In the first embodiment, an actual finger image is used as a pointer image. Alternatively, an image irrelevant in data to the actual finger image may be used as a pointer image. FIG. 45 illustrates coordinates of fingertip positions (G₁ to G₅) on the input manipulation surface 102a or on the image frame. The pointer image frame is created by pasting pointer images at the fingertip points G₁ to G₅ on the image frame. The finger image is made so as to be narrower than the actual finger image FI in width. A finger image narrower than the actual finger image FI in width may be also referred to as a simulated finger image. For example, based on the distribution in finger width of Japanese people older than 18 years old, the width of the finger image may be set to a value of 50% to 80% of the lower limit of a predetermined range of the distribution, where the predetermined range contains 90% of all people in the distribution and the center of the range is an average value of all people. By using this width, the pointer image becomes narrower in width than the actual finger image for almost all of users except kids. In a case of forefinger, the width of the finger image at the first joint may be set to a value between 7 mm and 14 mm.

The tip region that is determined as a non-true fingertip region is not stored as the fingertip position, and as a result, a pointer image is not pasted on the non-true fingertip region. Thus, the following difficulty does not arise fundamentally. A pointer image is pasted at a point that is associated with photographing subject other than a finger but wrongly-detected as a fingertip position. In such a case, although a user is clearly figuring out that the hand is not put in the photographing range 102b, a finger image is displayed on the display screen. The control device 1 can minimize the user feeling that something is wrong.

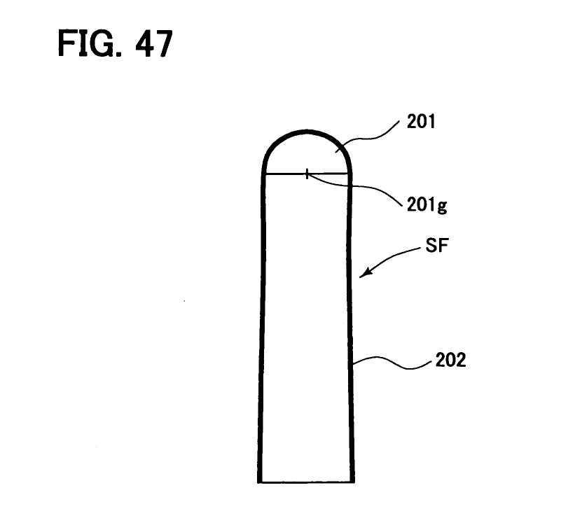

A simulated finger image imitating an outline shape of a finger may be used as a pointer image. A simulated finger image according to a simple example may be a combination of a circular arc FIG. 201 representing an outline of a fingertip of a finger and a rectangular FIG. 202 representing an outline of the rest of the finger, as shown in FIG. 47. When the circular ark FIG. 201 is used for the fingertip, the center of the circular ark can be advantageously used as the fingertip position to which the fingertip point is positioned. Alternatively, a pointer figure simpler than the simulated finger image may be used as a pointer image. For example, an arrow-shaped figure may be used.

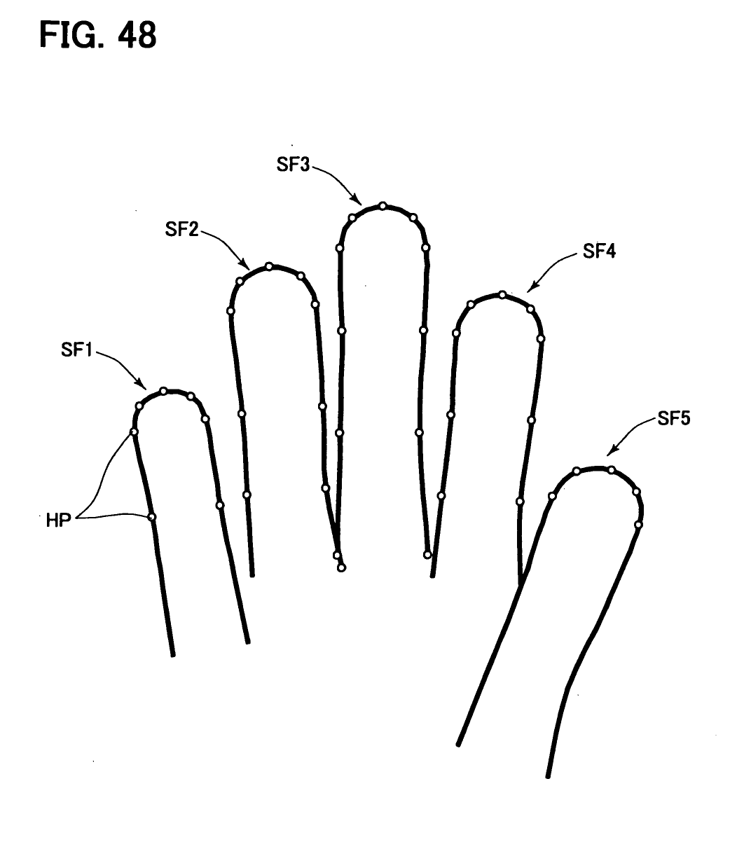

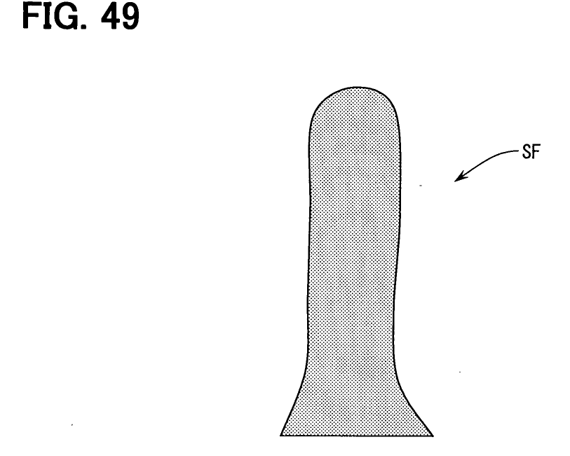

Alternatively, as shown in FIG. 48, a finger outline image data SF1 to SF5 may be used. The finger outline image data SF1 to SF5 represents an actual finger by using a polygonal line or a curve (e.g., B-spline, Bezier Curve) to more precisely imitate the actual finger. The finger outline image data SF1 to SF5 can be configured as vector outline data given by a series of handling points HP arranged to correspond to the finger outline.

Alternatively, an image of an actual finger, which has been preliminarily imaged for each finger, may be used as a pointer image. For example, the image of an actual finger may be an image of a finger of a user, or an image of a finger of a model, which may be preliminarily obtained from a hand-professional part model. In such a case, an outline may be extracted from the image of the finger by using a known edge detection process, and vector outline data approximating the outline is created. Thereby, finger outline image data SF1 to SF5 similar to that shown in FIG. 48 can obtained. Alternatively, as shown in FIG. 49, bitmap figure data obtained by binarizing the finger image may be used as a pointer image SF. In this case, a process of extracting a finger outline is unnecessary.

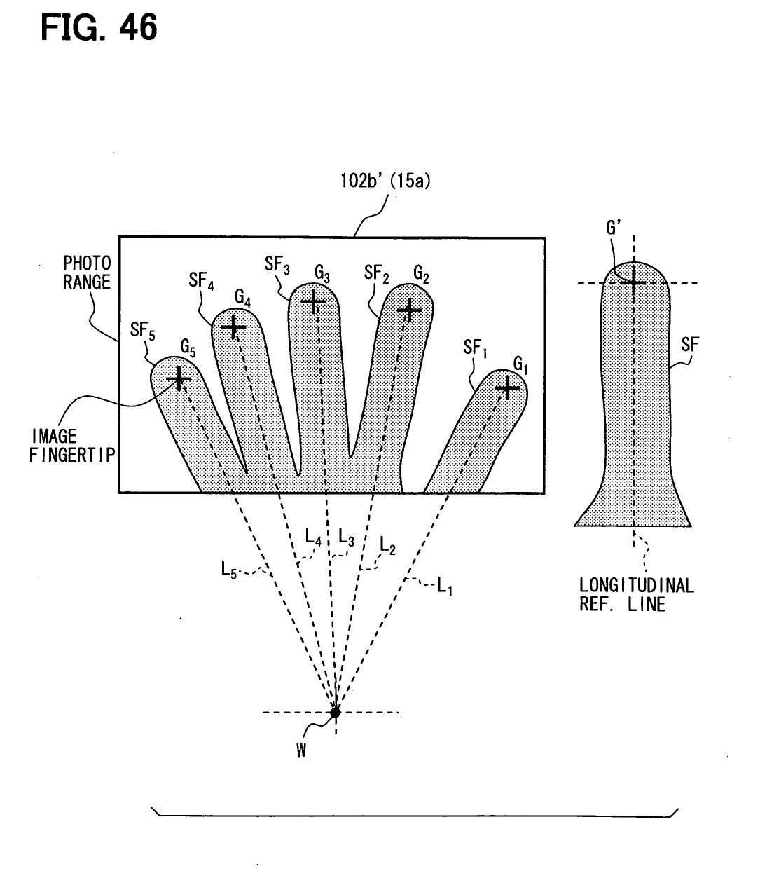

As shown in the right of FIG. 46, a pointer fingertip point G′ is set to a predetermined point in a tip portion of the pointer image SF. By making the pointer fingertip point G′ correspond to each fingertip point G₁ to G₅, the pointer image SF is pasted on the image frame. However, in order to perform the above pasting, it may be necessary to specify a direction of the finger in addition to the fingertip position G′. In view of the above necessity, as shown in FIG. 45, a finger direction regulation point W is set on the image frame (display coordinate plane) separately from the fingertip point G₁ to G₅. Lines interconnecting between the finger direction regulation point W and the fingertip points G₁ to G₅ are determined as finger lines L₁ to L₅ by calculation. As shown in FIG. 46, each pointer image SF₁ to SF₅ is pasted such that the fingertip position G′ matches the fingertip point G₁ to G₅ and the finger line L₁ to L₅ matches a longitudinal direction reference line of the pointer image SF (preliminarily determined for every pointer image SF₁ to SF₅). Thereby, the pointer image frame is created.

Because bones of fingers are arranged so as to approximately focus at a joint of a wrist, the finger direction regulation point W in FIG. 45 can be described as a wrist point W corresponding to the wrist. As described above, the dimensions of the input manipulation surface 102a (photographing range) is set so as to receive only a part of a hand (e.g., fingers), and the user manipulates the control device 1 by extending his or her hand from the back side of the photographing range. Thus, the wrist point W is located away from the display region in a lower direction in FIG. 45. In FIG. 45, the wrist point W is set at a position spaced a predetermined length Y₀ apart in the Y direction from a lower edge of the display region. Since the position of the wrist point W in the Y direction is fixedly set with reference to the lower edge of the display region regardless of Y coordinates of the finger points G₁ to G₅ on the window, it is possible to simplify an algorithm for determining the wrist point W. The X coordinate of the wrist point W may be set to the X direction center of the photographing range (the input manipulation surface 102a and the display screen of the monitor). When the display region has a dimension L in the Y direction, a value Y₀+L/2 may be adjusted to between 100 mm and 200 mm.

The pointer image frame in FIG. 46 made in the above described way is transferred to the graphic controller 110 and is combined with the input window image frame data acquired separately, and is displayed on the monitor 15. Depending on data forms of the pointer image SF, various methods for combining the input window image frame data and the pointer image frame data can be used. Examples of the method are as follows.

(1) When the pointer image data is described as bitmap data from the beginning, the pointer image with transparency is superimposed on the input window by performing an alpha blending process between corresponding pixels.

(2) When the pointer image data is described as vector outline data, an outline of the pointer image is generated on the pointer image frame data by using the vector outline data, and further, a region inside the outline is converted in bitmap by rasterizing, and then, an alpha blending process is performed in a way similar to that in (1).

(3) An outline is drawn on the input window image frame data by using the vector outline data forming the pointer image data, the pixels located inside the outline on the input window image are extracted, and values of the extracted pixels are uniformly shifted.

According to any one of the methods (1) to (3), regarding the pixels forming the outline of the pointer image data, it is possible to superimpose the pointer image whose outline is highlighted by increasing in blend ratio of the pointer image data. Alternatively, the pointing image data may be image data representing only the outline in the form of bitmap data or victor outline data, and only the outline may be superimposed.

As shown in FIG. 1, the display screen of the monitor 15 is placed out of sight of the user who is sifting in the driver seat 2D or the passenger seat 2P and who is looking straight at the finger on the touch panel 12a. Thus, the user cannot look straight at both of the hand and the monitor 15 at the same time. The pointer image on the display screen becomes only available source of information for the user to perceive his or her hand position in manipulation. Since it is possible to display the pointer image SF representative of each finger such that the pointer image is narrower in width than the actual finger image regardless of how the actual finger image is on the captured image, it is possible to effectively minimize a difficulty that the captured image of an actual finger with a large width is displayed and influences operability.

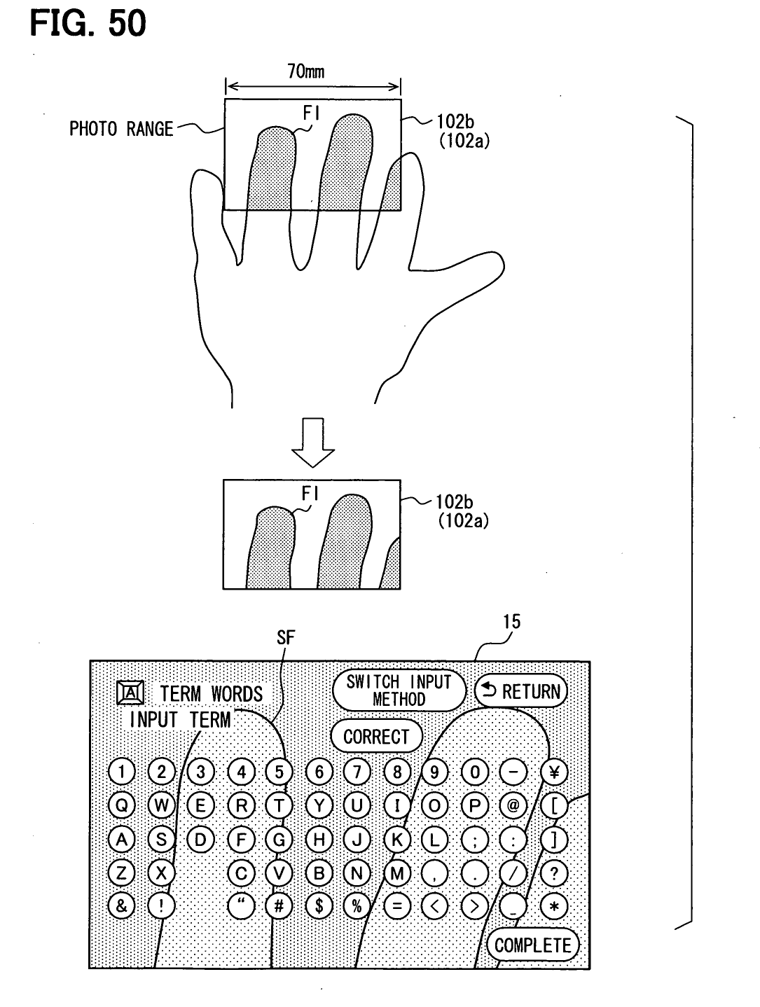

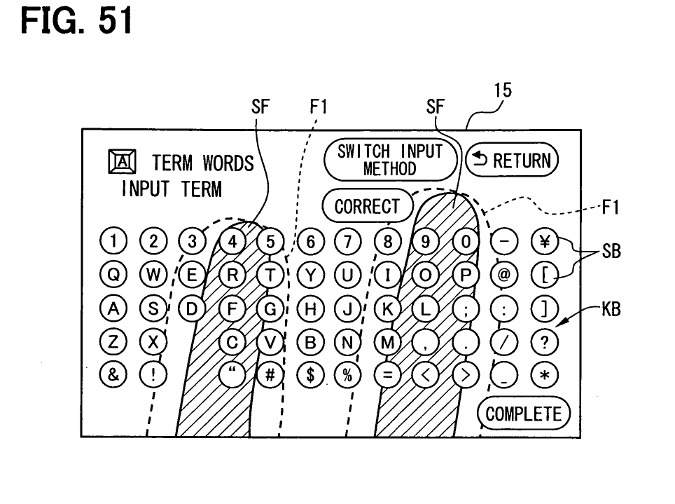

The above described merit becomes more notable when the photographing range 102b and the input manipulation surface 102a of the touch panel is downsized, as shown by the dashed-dotted line in FIG. 45. The above downsizing results in such size that at least two whole fingers of the fore finger, the middle finger and the ring finger can be imaged. In other words, as shown in FIG. 50, all of the fore finger, the middle finger, the ring finger and the little finger are not received in the photographing range but three fingers (e.g., the fore finger, the middle finger and the ring finger) or two fingers (e.g., the fore finger and the middle finger, or, the middle finger and the ring finger) are received in the photographing range.

An X direction dimension of the photographing range 102b (the input manipulation surface 102a) in the above case may be in a range between 60 mm and 80 mm and may be 70 mm in an illustrative case, and a Y direction dimension may be in a range between 30 mm and 55 mm and may be 43 mm in an illustrative case.

When the number of fingers received in the photographing range is two, and when the actual finger image FI being only binarized is displayed on the display screen of the monitor 15, the two actual fingers image FI is displayed in a relatively larger size because of the downsizing of the photographing range, as shown in FIG. 51 by using the dashed line. For example, as shown in FIG. 51, when a soft alphabet keyboard KB having more than fifty soft buttons SB is displayed on the monitor 15 by window switching, the actual finger image FI having the large width can contain three or more soft buttons. SB in the width direction of the actual finger image FI. In other words, the soft buttons SB on the soft alphabet keyboard KB have such sizes and arrangement that, when the actual finger image FI of the captured image is virtually projected at a corresponding position on the display screen while the size of the actual finger image FI on the coordinate system is being kept, the virtual projected area of the actual finger image FI contains multiple soft buttons SB, e.g., two or more soft buttons SB, in the width direction of the finger. In the above-described situation, it is quite difficult to see whether a desired soft button is correctly pointed, and a user may select a soft button next to the desired soft button.

However, as shown in FIG. 51 by using the sold line, the pointer image SF narrower in width than the actual finger image FI is displayed, the number of soft buttons SB overlapped by the pointer image SF in the width direction is reduced to one or two. It is possible to decrease the population of soft buttons around the pointer image SF. A user can easily see the soft button he or she is operating. As a result, it is possible to minimize a difficulty that a soft button next to the desired soft button is wrongly selected, and it is possible to dramatically improve operability.

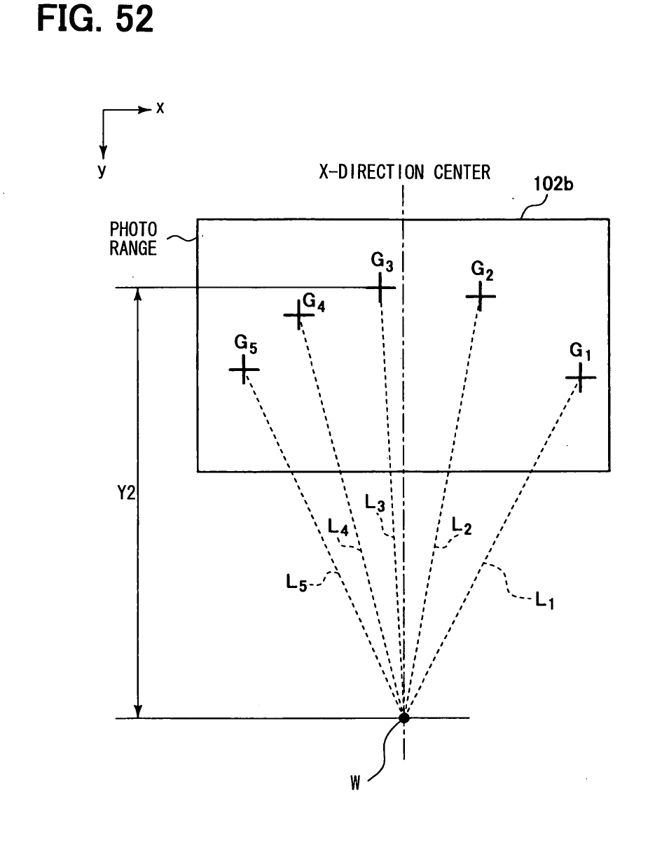

When the input location largely varies in the Y direction, it may be necessary to take into account a change in wrist position in Y direction. In such a case, as shown in FIG. 52, the wrist point W is set so as to have a predetermined positional relationship to a specified fingertip point G on the display coordinate plane, in order to improve reality in arrangement direction of the pointer image SF. For example, the wrist point W is set to a place that is spaced a predetermined distance Y₂ apart downward from the finger point G in the Y direction. The predetermined distance Y₂ may be between 100 mm and 200 mm.

In the followings, explanation is given on a situation where a user sitting in the driver seat 2D or the passenger seat 2P manipulates the manipulation part 12 arranged as shown in FIG. 1. When the user sitting in the seat moves the hand in the Y direction over the manipulation part 12, a lower arm typically moves backward and frontward while a shoulder joint and an elbow joint are moving. As a result, the movement of the hand to be imaged on the input manipulation surface 102a is approximately parallel to the Y direction. In such a case, a direction and an angle of the finger for input may not be changed largely. However, when the user moves the hand in the X direction, the rotation movement of the wrist may become a main movement. In this case, the movement of the hand to be imaged on the input manipulation surface 102a may become rotation around an axis, the axis being located around the center of the palm. As a result, a direction and an angle of the finger for input may be changed in accordance with rotation angle of the hand.

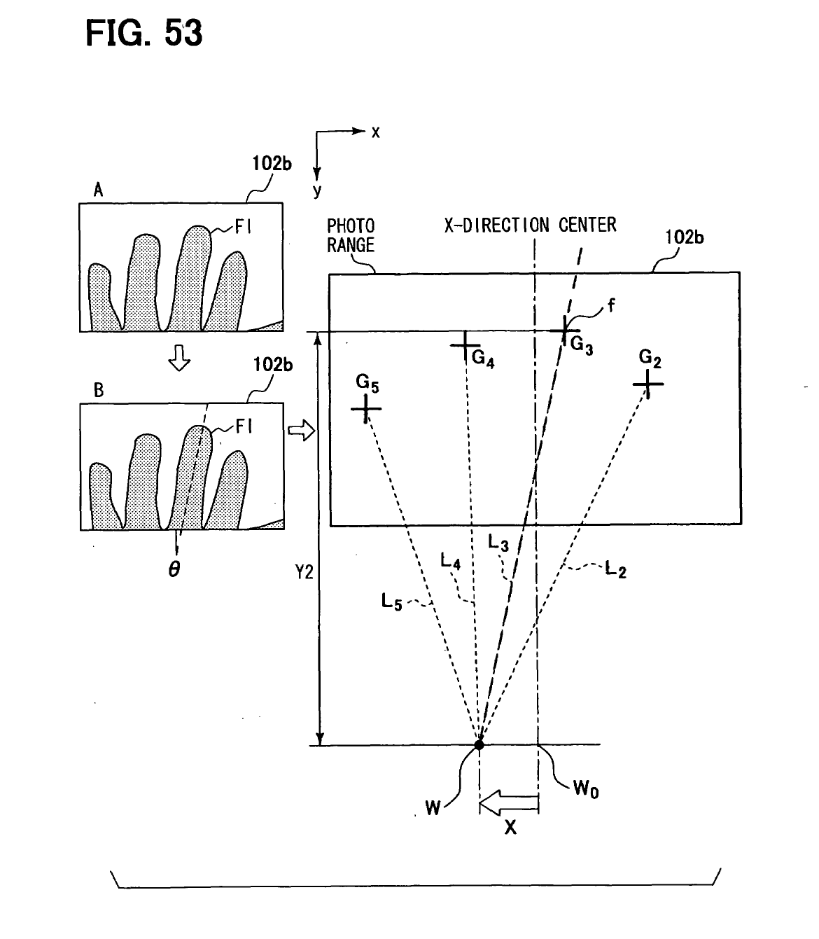

In order to reflect the above movement of the hand, as shown in FIG. 53, the wrist point W may be changed depending on the X coordinate of the finger point G. Note that the wrist point W determines the finger direction. In FIG. 53, a reference wrist point W₀ indicative of a reference wrist position is fixedly set below the display region (photographing range). The X coordinate of the wrist point W is set such that, as an angle of the actual finger image FI with respect to the Y direction becomes larger, an X direction displacement of the wrist point W from the reference wrist point W₀ becomes larger.

In FIG. 53, the X coordinate of the reference wrist point W₀ is set to the X direction center of the photographing range (input manipulation surface 102a and the display screen of the monitor 15). Further, the Y coordinate of the reference wrist point W₀ is set to a place that is spaced a predetermined stance Y₂ apart downward from the fingertip point that has the uppermost fingertip position (see the fingertip point G₃ of the middle finger in FIG. 53) among the multiple specified fingertip points.

On an assumption that the rotation axis is located inside the palm, the position of the fingertip and the position of the wrist are moved in opposite directions due to the rotation movement. Thus, for the actual finger image FI inclined upper rightward with respect to the Y direction, the X coordinate of the wrist point W is set so as to displace leftward in the X direction from the reference wrist point W₀. For the actual finger image FI inclined upper leftward with respect to the Y direction, the X coordinate of the wrist point W is set so as to displace rightward in the X direction from the reference wrist point W₀. More specifically, the actual finger image FI (corresponding to the fingertip point G₃ in FIG. 53) having the uppermost fingertip position is used as a representation finger image. An inclination angle θ of the representation finger image with respect to the Y direction is obtained where measurements in the clockwise direction are positive inclination angles. The inclination angle θ can be calculated, for example, from a slope of a line that is obtained by application of the least-square method to the pixels forming the actual finger image FI. Values of the X direction displacement of the wrist point W from the reference wrist point W₀ or the X coordinate of the wrist point W for the corresponding values of the inclination angle θ may be preliminarily determined and stored in ROM 103. In this configuration, it is possible to easily determine a value of the X direction displacement of the wrist point W corresponding to a calculated value of the inclination angle θ. In FIG. 53, the Y coordinate of the wrist point W is set so as to be always equal to the Y coordinate of the reference wrist point W₀. In other words, the wrist point W is set in accordance with the inclination angle θ so as to move on a straight line that is parallel to the X axis and passes through the reference wrist point W₀. Alternatively, the wrist point W is set so as to move on a circular arc path.

Alternatively, the representation actual finger image employed may be the actual finger image whose X coordinate or Y coordinate of the fingertip point is closest to the X direction center or the Y direction center of the photographing range among the multiple actual finger images.

Alternatively, the wrist point W may be set by using a representation fingertip point, which is obtained by averaging X coordinates and Y coordinates of multiple fingertip points G₁ to G₅.

Alternatively, when the number of fingertip positions is odd, the representation fingertip point may be set to the fingertip point of the actual finger image located at the center. When the number of fingertip positions is even, the representation fingertip point may be set to a point obtained by averaging X coordinates and Y coordinates of two actual finger images located close to the center.

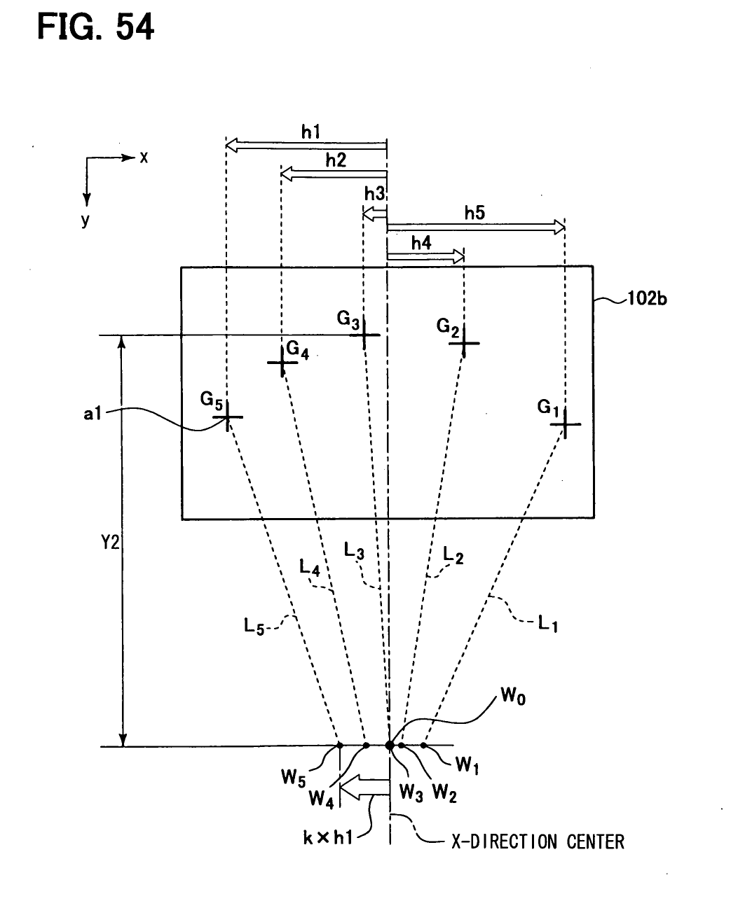

In the actual hand, finger bones have respective widths at the wrist, and are connected with difference points of the wrist joint at in the X direction. In view of the above, as shown in FIG. 54, independent wrist points W₁ to W₅ may be set to respectively correspond to multiple fingertip points G₁ to G₅, and arrangement directions of the pointer images may be determined by using the wrist points W₁ to W₅. More specifically, the wrist points W₁ and W₂, which correspond to the fingertip points G₁ and G₂ located rightward of the reference wrist points W₀, may be set such that the X coordinates of the wrist points W₁ and W₂ are located rightward of the reference wrist points W₀. The wrist points W₃, W₄ and W₅, which correspond to the fingertip points G₃, G₄ and G₅ located leftward of the reference wrist points W₀, may be set such that the X coordinates of the wrist points W₃, W₄ and W₅ are located leftward of the reference wrist points W₀. In the above, as the fingertip point has the larger X direction displacement (h1 to h5) from the reference wrist point W₀, the X coordinate of the corresponding wrist point has a larger X direction displacement from the reference wrist point W₀. More specifically, the X direction displacement of the wrist point W from the reference wrist point W₀ is calculated as a predetermined factor (e.g., between 0.1 and 0.3) times the X direction displacement of the fingertip point from the reference wrist point W₀.

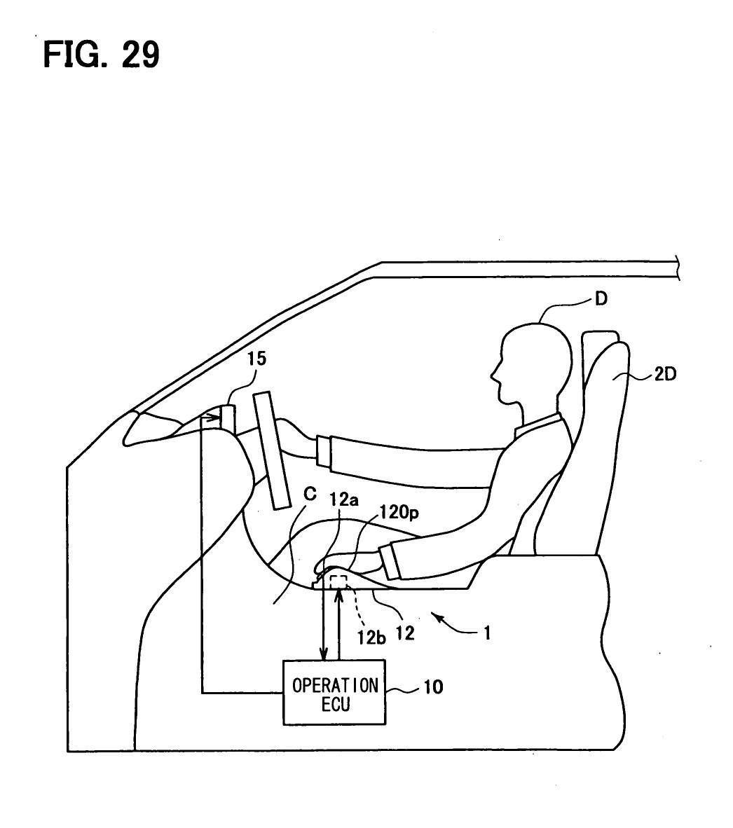

FIG. 29 illustrates a control device 1 that includes a hand guide part for regulating the insertion direction in which the hand is inserted in the photographing range 102b of the camera 12b. The insertion direction is also referred to as a guide direction. The width of the tip region (non-overlapping region) is defined as the width in a direction perpendicular to the guide direction. FIG. 30 is an enlarged view of the input part 12 of the control device that includes the hand guide part. A palm rest part 12p for supporting a palm of the user is formed on an upper surface of the case 12d. An upper surface of the palm rest part 12p has a guide surface 120p, which includes a convex surface whose central part in a front-rear vehicle direction (corresponding to the Y direction) swells out in the upper direction. The upper surface of the palm rest part 12p functions to regulate the hand so that the longitudinal direction of hand matches the Y direction. As shown in FIG. 29, the touch panel 12a is placed adjacent to an end of the guide surface 120p so that, when a user puts his or her hand to the guide surface 120p, end portions of fingers can cover the touch panel 12a or can be imaged. Guide ribs 120q extending in the Y direction are formed at two edges of the guide surface 120p, the two edges being spaced apart from each other in the X direction. Because of the guide ribs 120q, the fingers of the hand on the guide surface 120p is inserted toward the touch panel 12a or the photographing range in a direction restricted to the Y direction. The guide surface 120p and the guide ribs 120q constitute the hand guide part. It should be noted in the above that the dimensions of the photographing range can be similar to those shown in FIG. 50.

In the above examples, the control device is applied to an in-vehicle electronic apparatus. However, the control device is applicable to another apparatus. For example, the control device may be applied to a GUI input device for a PC.

### Aspects of First Embodiment

The first embodiment and modification have the following aspects.

According to an aspect, there is provided a control device including: a touch input device that has a manipulation surface adapted to receive a touch manipulation made by a finger of a user, and detects and outputs an input location of the touch manipulation; an imaging device that has a photographing range having one-to-one coordinate relationship to the manipulation surface, and captures an image of a hand of the user getting access to the manipulation surface; a fingertip specifying section (or means) that specifies a fingertip of the hand based on data of the image of the hand; a display device that includes a display screen having one-to-one coordinate relationship to the photographing range and the manipulation surface; a pointer image display control section (or means) that causes the display device to display a pointer image on the display screen, the pointer image pointing to a place corresponding to the fingertip; a selection reception region setting section (or means) that sets a selection reception region on the display screen so that the selection reception region is located at a predetermined place on the display screen; a move target image selection section (or means) that switches a move target image prepared on the selection reception region into a selected state when the touch input device detects that the touch manipulation is performed at the input location corresponds to the move target image item; and an image movement display section (or means) that (i) detects a target fingertip, which is the fingertip that makes the touch manipulation at the input location corresponding to the move target image item, (ii) causes the display device to display the move target image in the selected state and the pointer image at a place corresponding to position of the target fingertip, and (iii) causes the move target image in the selected state and the pointer image to move together on the display screen in response to movement of the target fingertip in the photographing range, in such manner that a trajectory of movement of the selected move target image and the pointer image corresponds to a trajectory of the movement of the target fingertip.

The imaging device of the control device captures the image representative of a hand of a user getting access to the touch input device, as conventional operating devices disclosed in Patent Documents 1 to 3 do. The conventional operating device utilizes the captured image of the hand as only a hand line image that is superimposed on the display screen to indicate manipulation position, and thus, the conventional operating device cannot effectively utilize the information on the captured image of the hand as input information. The control device of the present disclosure can utilize information on position of the fingertip of the user based on the image of the hand. The control device can detect the position of the fingertip and the input location of the touch manipulation independently from each other.

More specifically, the control device can recognize, as the target fingertip, one of the specified fingertips that is associated with the touch manipulation. The control device displays the move target image being in the selected state and the pointer image at a place on the display screen, the place corresponding to the position of the target fingertip. The control device moves the move target image in the selected state and the pointer image in response to the movement of the target fingertip in the photographing range, in such manner that the trajectory of the movement of the move target image and the pointer image corresponds to the trajectory of the movement of the fingertip. Through the above ways, if the finger is spaced apart from the manipulation surface after the touch manipulation for switching the move target item into the selected state is performed, it is possible to track the position of the fingertip based on the captured image of the hand, and it is possible to display the move target image and the pointer image indicating the present position of the fingertip so that the move target image and the pointer image are movable together. The control device therefore enables input operation such as drag operation on an image item in an intuitive manner.

The above control device may be configured such that the pointer image display control section uses an actual finger image as the pointer image, the actual finger image being extracted from the image of the hand. According to this configuration, a user can perform input operation using the touch input device while seeing the actual finger image superimposed on the display screen. The actual finger image may be an image of the finger of the user. The control device therefore enables input operation in a more intuitive manner.

The above control device may be configured such that the pointer image display control section uses a pre-prepared image item as the pointer image, the pre-prepared image item being different form an actual finger image extracted from the image of the hand. The pre-prepared image item may be, for example, a commonly-used pointer image having an arrow shape, or alternatively, a preliminarily-captured image of a hand or a finger of a user or another person.

When the actual finger image extracted from the captured image is used as the pointer image, and when size of the manipulation surface is relatively smaller than that of the display screen, size of the displayed image of the finger is enlarged on the display screen. Thus, it may become difficult for a user to understand the position of the fingertip precisely, because the finger displayed may be excessively wide in width. In such a case, the actual finger image that is extracted from the captured image of the hand in real time may be used to specify the position of the fingertip only, and the pre-prepared image item may be pasted and displayed on the display screen. Thereby, regardless of how the actual finger image extracted from the image of the hand is, it becomes possible to reliably display the pointer images corresponding to respective fingers such that the displayed pointer images are thinner than the actual finger image representative of fingers, and as a result, it is possible to prevent a user from having odd feeling caused by the display of the excessively wide finger image.

The pre-prepared image item may be a simulated finger image whose width is smaller than that of the actual finger image extracted from the hand image. The simulated finger image may represent an outline of the finger. The use of such a simulated finger image enables a user to catch the present manipulation location in a more intuitive manner.

The control device may be configured such that: the touch manipulation includes a first touch manipulation, which is the touch manipulation that is performed by the target fingertip at the input location corresponding to the selection reception region; the first touch manipulation switches the move target image into the selected state; when the target fingertip is spaced apart form the manipulation surface and is moved after the first touch manipulation is performed, the image movement display section switches display mode into a coupling movement mode, in which the move target image in the selected state and the pointer image are moved together in response to the movement of the target fingertip; the touch manipulation further includes a second touch manipulation, which is the touch manipulation that is performed at the input location corresponding to the target fingertip after the target fingertip is moved in the coupling movement mode; and the image movement display section switches off the coupling movement mode when the touch input device detects that the second touch manipulation is performed. According to the above configuration, the above control device can switches the move target image into the selected state in response to the first touch manipulation performed at the selection reception region. Then, the control device can display and move the move target image and the pointer image to a desired location (e.g., display of a drag operation) in the coupling movement mode while not receiving a touch. Then, when the control device detects that the second touch manipulation is performed, the control device switches off the coupling movement mode. In the above, the first and second touch manipulations have therebetween a period where no touch is made on the manipulation surface. The first and second touch manipulations can respectively indicate a start time and an end time of the coupling movement mode (e.g., display of a drag operation) in a simple and clear manner.

The control device of the present disclosure may be applied to a data-processing device including computer hardware as a main component, the data-processing device being configured to perform a data-processing operation by using input information based on execution of a predetermined program. The target fingertip specified from the Captured image is always associated with a touch manipulation performed at a corresponding position, and the touch manipulation can be used for activating a data-processing operation of the data-processing device. When the touch input device is manipulated by the hand, multiple fingers may be specified from the captured image in some cases. In such cases, multiple finger points are set on the display screen, and multiple pointer images corresponding to the multiple finger points may be displayed. In order to realize an intuitive operation in the above case, it may be necessary for the control device to enable a user to clearly distinguish which one of the multiple fingers has performed the touch manipulation that triggers activation of the data-processing operation. In other words, it may be necessary for the control device to enable a user to clearly distinguish which one of the multiple fingertips is the target fingertip.

According to the conventional technique, a trigger signal for activating the data-processing operation is provided when there occurs a touch manipulation directed to a key or a button fixedly displayed on a display screen. Thus, the conventional technique enables a user to catch which finger performs the touch manipulation by reversing color of the key or the button aimed by the touch manipulation or by outputting operation sound. However, the conventional technique cannot essentially track a change in position of the target finger based on input formation provided by touch, in order to track the movement of the target fingertip after the touch manipulation is finished (i.e., after the target fingertip is spaced apart from the touch input device). In view of the above difficulty of the conventional technique, the control device of the present disclosure may be configured such that the move target image is a marking image that highlights the position of the target fingertip. The control device having the above configuration can track the target fingertip by using the captured image and can use the marking image as the move target image accompanying the target fingertip, and thereby enables a user to grasp the movement of the target fingertip even after the touch manipulation is finished (i.e., after the target fingertip is spaced apart from the touch input device).

The above control device may further include an operation button image display control section (or means) that causes the display device to display an operation button image on the selection reception region of the display screen, the operation button image containing the marking image as design display. When the operation button image is displayed on the reception selection region, a user can intuitively select a function corresponding to the operation button image by performing a touch manipulation directed to the operation button image. The making image on the operation button image can act as the move target image and can be pasted at a target fingertip point, so that the marking image is movable in response to the movement of the target fingertip. Thus, a use can constantly and clearly see which operation button image is in the selected state, even when the user is moving the target fingertip.

The above control device may further include a marking image pasting section (or means) that causes the display device to display the marking image on the display screen, such that the marking image is fixedly pasted at a place corresponding to the input location of the second touch manipulation when the coupling movement mode is switched off. The above configuration is particularly effective for apparatus-function-setting that requires the specifying of a point for setting on a window. By using the above control device, a user can easily grasp the present position and the movement trajectory of the fingertip that has operated the operation button image, through the movement of the marking image in the coupling movement mode. Further, a user can easily grasp the point for setting fixed by the second touch manipulation, through the fixedly-pasted place of the marking image. For canceling the point for setting fixed in the above-described operation for instance, the above control device may further include a marking image deletion section (or means) that deletes the marking image, which has been displayed together with the pointier image, from the place corresponding to the input location of the second touch manipulation when the coupling movement mode is switched off.

The above control device may be configured such that the marking image has a one-to-tone correspondence to a predetermined function of an electronic apparatus, which is a control target of the subject control device. The control device may further include a control command activation section (or means) that activates a control command of the predetermined function corresponding to the marking image when the touch input device detects that the second touch manipulation is performed. According to the above configuration, it becomes possible to specify the point for setting for the predetermined function and activate the predetermined function at the same time. Further, a user can more easily grasp a type of the selected predetermined function and the final point for setting, through the pasted marking image.

The above control device may be configured such that: the selection reception region is multiple selection reception regions; the predetermined function of the electronic apparatus is multiple predetermined functions; the marking image is multiple marking images; and the multiple marking images respectively correspond to the multiple predetermined functions. In such a configuration, the control device may further include: an operation button image display control section (or means) that causes the display device to respectively display a plurality of operation button images on a polarity of selection reception regions, so that the plurality of operation button images respectively contains the plurality of marking images as design display. When the first touch manipulation is performed at the input location corresponding to one operation button images of the operation button images, the image movement display section (i) switches one marking image of the marking images that corresponds to the one operation button image in the selected state, and (ii) switches the display mode into the coupling movement mode. When the touch input device detects that the second touch manipulation is performed, the control command activation section activates the control command of one of the predetermined functions corresponding to the one marking image being in the selected state. By arranging the multiple operation button images on the multiple selection reception regions so that designs of the multiple marking images are different from each other, the control device enables a user to visually and easily grasp a lineup of the multiple predetermined functions. Further, the control device enables a user to distinguish which one of the predetermined factions is being selected, through the design of the marking image in the selected state.

The control device may be configured such that: a part of the manipulation surface is a command activation valid region; a part of the display screen is a window outside part, which corresponds to the command activation enablement part; the operation button image is displayed on the window outside part of the display screen; the control command activation section activates the control command of the predetermined function when the touch input device detects that the second touch manipulation is performed on the command activation enablement part of the manipulation surface; and the control command activation section does not activate the control command of the predetermined function when the touch input device detects that the second touch manipulation is performed outside the command activation enablement part. According to the this configuration, if an error touch manipulation is made at a place corresponding to a region around the operation button image, such error touch manipulation, which is not aimed at activation of the predetermined function, can be an outside of the command activation enablement part. Thus, it is possible to prevent an error operation of the electronic apparatus from occurring.

In particular, when the electronic apparatus is an is an in-vehicle electronic apparatus and the display screen of the display device may be placed so as to be out of sight of the user who is looking straight at the finger on the manipulation surface, the user cannot look straight at both of the display screen and the hand for performing operation at the same time. According to this configuration, since the pointer image and the marking image are movable together on the display screen, a user can intuitively and reliably perform an operation including specification of a point without looking at the hand.

The in-vehicle electronic apparatus may be a car navigation system for instance. In this case, the manipulation surface may be placed next to or obliquely forward of a seat for a user, and the display screen may be placed upper than the manipulation surface so that the display screen may be placed in front of or obliquely forward of the user. The control device may be configured such that a part of the display screen is a map display region for displaying a map for use in the car navigation system; the operation button image is displayed on the selection reception region and is displayed on an outside of the map display region; the control command enables a user to specify a point on the map displayed on the map display region; the control command is assigned to correspond to the operation button image; the control command activation section activates the control command when the touch input device detected that the second touch manipulation is performed inside the map display region; and the control command activation section does not activates the control command when the touch input device detects that the second touch manipulation is performed inside the map display region. In the above, the control command may be associated with specification of a point on the map display region, and may be one of (i) a destination setting command to set a destination on the map display region, (ii) a stopover point setting command to set a stopover point on the map display region, (iii) a peripheral facilities search command, and (iv) a map enlargement command.

The above control device may be configured such that: the display screen has a pointer displayable part, in which the pointer image is displayable; and the image movement display section switches off the coupling movement mode and switches the marking image in an unselected state when the target fingertip escapes from the pointer displayable part in the coupling movement mode. According to this configuration, after the marking image is switched into the selected state, a user can easily switch the marking from the selected state into the un-selected state by moving the finger to an outside of the pointer displayable part.

Alternatively, the above control device may be configured such that, when the target fingertip escapes from the pointer displayable part in the coupling movement mode, the image movement display section maintains the selected state of the marking image. Further, the above control device may be configured such that, when the escaped target fingertip or a substitution fingertip, which is a substation of the escaped target fingertip, is detected in the pointer displayable part after the target fingertip has escaped from the pointer displayable part, the image move display section keeps the coupling movement mode by newly setting the target fingertip to the escaped target fingertip or the substitution fingertip and by using the marking image being in the selected state. According to this configuration, even when the finger moves to an outside of the pointer displayable part, it is possible to keep the selected state of the making image and it becomes unnecessary to select the marking image again.

The above control device may further include a target fingertip movement detection section (or means) that detects the movement of the target fingertip in the coupling movement mode. Further, the control device may be configured such that when the detected movement of the target fingertip in the coupling movement mode corresponds to a predetermined mode switch off movement, the image movement display section switches off the coupling movement mode and switches the marking image in an unselected state. When a certain movement of the target fingertip is preliminarily determined as the predetermined mode switch off movement, a user can switch the marking image into the unselected state by performing the predetermined mode switch off movement after the marking image is switched into the selected state.

The control device may be configured such that the hand of the user is inserted into the photographing range in a predetermined insertion direction. Further, the control device may further include: a tip extraction section (or means) that extract a tip region of the hand on the captured image in the predetermined insertion direction; a tip position specification section (or means) that specifies position of the tip region in the photographing range as a image tip position; a fingertip determination section (or means) that determines whether the image tip position indicates a true fingertip point, based on size or area of the tip region; and a fingertip point coordinate output section (or means) that outputs a coordinate of the image tip position as a coordinate of a true fingertip point when it is determined that the image tip position indicates the true fingertip point.

According to the above configuration, the hand of the user is inserted into the photographing range of the imaging device in the predetermined insertion direction, and the fingertip is located at a tip of the hand in the predetermined insertion direction. Thus, by extracting the tip region of the hand of the captured image in the predetermined insertion direction, and by determining whether the size or the area of the tip region has appropriate values, it is possible to accurately determine whether the tip region indicates a true fingertip.

The control device may be configured such that: the tip extraction section acquires the captured image as a first image; the tip extraction section acquires a second image by parallel-displacing the first image in the predetermined insertion direction, and extracts, as the tip region (fingertip region), a non-overlapping region of the hand between the first image and the second image. According to this configuration, it is possible to easily specify the non-overlapping region between the first and second images as the fingertip region, by parallel-displacing the captured image in the predetermined insertion direction (i.e., a longitudinal direction of a palm of the hand) and by overlapping the parallel-displaced image on the captured image.

The above control device may be configured such that: the imaging device images the hand inserted into the photographing range by utilizing light reflected from a volar aspect of the palm. When the control device extracts and specifies the fingertip region based on difference between the first and second images in the above described way, the control device may be configured such that: the imaging device is located lower than the hand; and the imaging device images the hand that is inserted into the photographing range in a horizontal direction while the volar aspect of the palm being directed in a lower direction. It should be noted that, in Patent Document 2, a camera is mounted to a ceiling of a vehicle body and located so as to be obliquely upper than the hand. Thus, unlike Patent Document 2, the control device of the present disclosure is not influenced by ambient light or foreign substances between the hand and the camera mounted to the ceiling. The above control device may further include an illumination section (or means) that illuminates the photographing range with illumination light. Further, the imaging device of the control device may capture the image of the hand based on the illumination light reflected from the hand. According to this configuration, it becomes possible to easily separate a background region and a hand region from each other on the captured image.

The tip position specification section can specify the position of the tip region as the position of the tip of the hand on the image. In the above, the tip region is specified as the non-overlapping region, and the tip of the hand on the image can be a coordinate of the fingertip point. The position of the non-overlapping region can be specified from a representation position, which satisfies a predetermined geometrical relationship to the non-overlapping region. For example, a geometrical center of the non-overlapping region can be employed as the representation position. It should be noted that the representation position is not limited to the geometrical center.

When the non-overlapping region is a true fingertip region, the size and the area of the non-overlapping region should be in a predetermined range corresponding to fingers of human beings. Thus, when the size or the area of the non-overlapping region is without the predetermined range, it is possible to determine that the non-overlapping region is not the true fingertip region associated with the fingertip of the user and it is possible to determine that the non-overlapping region is associated with a photographing subject other than the fingertip of the user or associated with a part of the hand other than the fingertip. Thus, the control device can be configured such that the fingertip determination section determines whether the non-overlapping region is the true fingertip region based on determining whether the size or area of the non-overlapping region corresponding to the extracted tip region is in the predetermined range.

In connection with the imaging device, the control device may further include a hand guide part that provides a guile direction and regulates the predetermined insertion direction to the guide direction, so that the hand is inserted into the photographing range in the guide direction. According to this configuration, the predetermined insertion direction, in which, the hand of the user is inserted into the photographing range, can be substantially fixed. As a result, a longitudinal direction of the finger of the hand to be image can be substantially parallel to the guide direction, and the size of the non-overlapping region in a direction perpendicular to the guide direction substantially can match or corresponds to a width of the finger. Thus, the control device can be configured such that the fingertip determination section determines whether the tip region is the true fingertip region based on determining whether a width of the non-overlapping region in the direction perpendicular to the guide direction is in a predetermined range. According to this configuration, a measurement direction of the size of the non-overlapping region can be fixed. For example, the measurement direction can be fixed to the direction perpendicular to the guide direction, or a direction in a range between about +45 degrees and −45 degrees from the direction perpendicular to the guide direction. It is possible to remarkably simplify a measurement algorithm for determining whether the tip region is the true tip region.

As described above, the fingertip region can be extracted from the non-overlapping region between the first image, which is the captured image, and the second image, which is obtained by parallel-displacing the first image. When multiple fingers are inserted into the photographing range, multiple non-overlapping regions between the first and second images can be separated into multiple pieces. In such a case, the tip extraction section can extracts the multiple non-overlapping regions as candidates of the fingertip regions. As a result, it becomes possible to utilize the multiple fingertip regions for location inputs at the same time, and thus, it is possible to increase degree of freedom of input in the control device. Further, if some of fingers are closed and in contact with each other, it is possible to reliably separate and specify the fingertip region rounded.

The fingertip determination section may be configured to estimate a value of S/d as a finger width from the multiple non-overlapping regions, where the S is total area of a photographing subject on the captured image and “d” is the sum of distances from the non-overlapping regions to a back end of the photographing range. The back end is an end of the photographing subject in the predetermined insertion direction, so that the hand is inserted into the photographing range through the back end earlier than another end opposite to the back end. Thus, the fingertip determination section can determine whether the non-overlapping region is the true fingertip region based on determining whether S/d is in a predetermined range. According to this configuration, the fingertip determination section can also estimate a value of S/D as the finger width, not only specify the width of the non-overlapping region. Thereby, it is possible to determine whether the captured image includes, as a finger image, a photographing subject that continuously extends from the tip region to an end of the captured image corresponding to the back end of the photographing range. Thus, a photographing subject other than a finger (e.g., a small foreign object such as a coin and the like) is effectively prevented from wrongly being identified as a finger. In the above, a region of the small foreign object around a tip of the photographing subject may be detected. The fingertip determination section may estimate the value of S/N as an average finger area and may be configured to determine whether the non-overlapping region is the true fingertip region based on determining whether S/N is in a predetermined range, where S is total area of the photographing subject and N is the number of non-overlapping regions.

The above control device may be configured such that: the pointer image is displayed at the fingertip point indicated by the fingertip region only when it is determined that the tip region on the captured image is the true fingertip region; and the pointer image is not displayed when it is determined that the tip region on the captured image is not the true fingertip region. According to this configuration, there does not fundamentally arise the following difficulty for example. The pointer image is pasted at a point that is associated with photographing subject other than a finger but wrongly-detected as a fingertip position. In such a case, although a user is clearly figuring out that the hand is not put in the photographing range 102b, a finger image is displayed on the display screen. The control device thus can minimize the user feeling that something is wrong.

There may arise a difficulty that, when a part of the finger of the user moves to an outside of the photographing range, an end of another part of the finger in the photographing range is wrongly identified as the true fingertip region. To address the above difficulty, the control device may be configured such that: the photographing range includes a window corresponding region and a window periphery region; the window corresponding region corresponds to a window on the display screen; the window periphery region is located outside of the window corresponding region, extends along an outer periphery of the window corresponding region, and has predetermined width; the fingertip point coordinate output section is configured to output the coordinate of the tip position when the tip position coordinate specification section determines that the coordinate of the tip position on the captured image is within the window corresponding region. According to this configuration, when the hand of the user protruding into the window periphery region is imaged, it is possible to determine that an actual fingertip is located outside of the window corresponding region, which is a target of display. In such a case, a tip of the hand extracted from the image is not recognized as the fingertip point, and thereby, it is possible to prevent the above difficulty from occurring.

### Second Embodiment

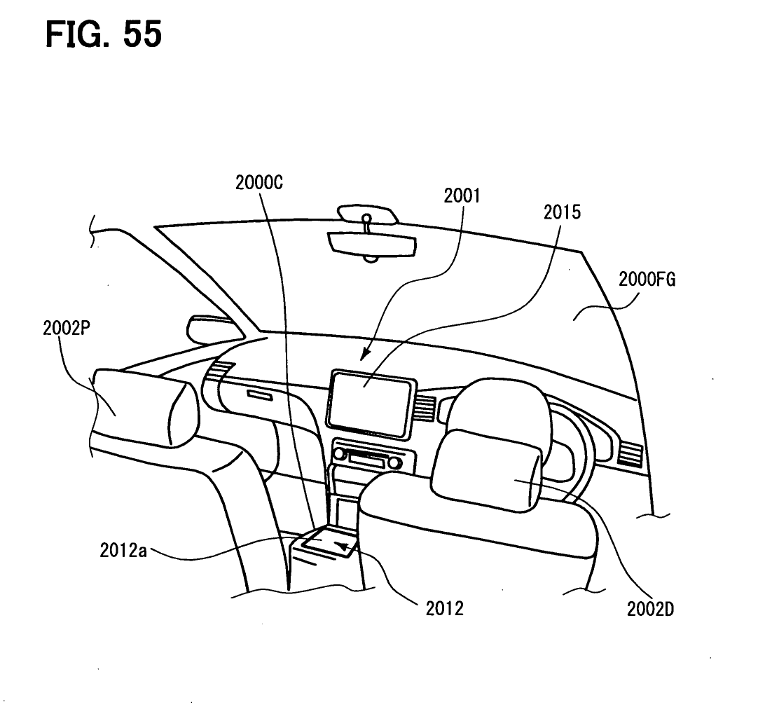

FIG. 55 illustrates an in-vehicle electronic apparatus control device 2001 according to the second embodiment. For simplicity, the in-vehicle electronic apparatus control device 2001 is also referred to as a control device 2001. The control device 2001 is placed in a vehicle compartment, and includes a monitor 2015 and a manipulation part 2012 (also referred as input part 2012). The monitor 2015 can function as a display device and is located at a center part of an instrument pane. The manipulation part 2012 is located on a center console, and is within reach from both of a driver seat 2002D and a passenger seat 2002P, so that a user sitting in the driver seat or the passenger seat can manipulate the manipulation part 2012. Although an intended use of the control device 2001 is not limited, the control device 2001 can enable, for example, a user to operate an in-vehicle electronic apparatus such as a car navigation apparatus, a car audio apparatus and the like while the user is taking look at a display screen of a monitor 2015. It should be noted that the monitor 2015 may be a component of the in-vehicle electronic apparatus.

The manipulation part 2012 has a manipulation input surface 2102a acting as a manipulation input region. The manipulation part 2012 is positioned so that the manipulation input surface 2102a faces in the upper direction. A touch panel 2012a provides the manipulation input surface. The touch panel 2012a may be a resistive type panel, a surface acoustic wave (SAW) type panel, a capacitive type panel or the like. The touch panel 2012a includes a transparent resin plate acting as a base, or a glass plate acting as a transparent input support plate. An upper surface of the touch panel 2012a receives and supports a touch manipulation performed by a user using a finger. The control device 2001 sets an input coordinate system on the manipulation input surface. The input coordinate system has one-to-one coordinate relationship to the display screen of the monitor 2015. The touch panel 2012a can act as a manipulation input element or a location input device. The transparent resin plate can act as a transparent input reception plate.

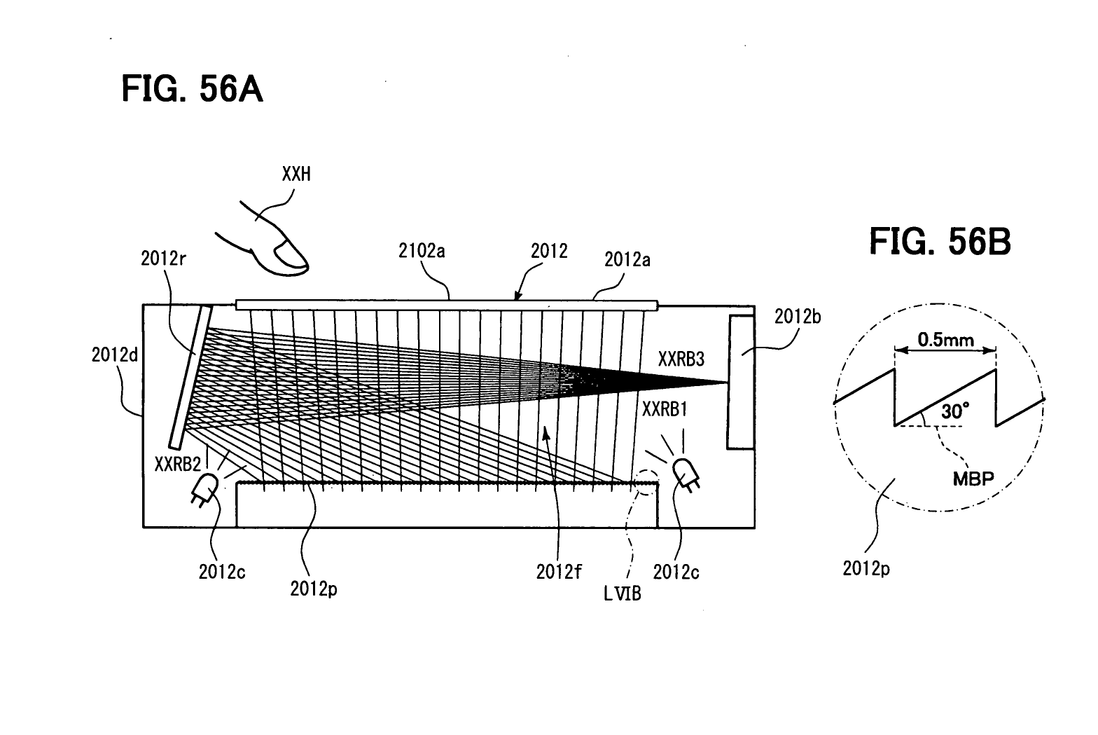

FIG. 56A is a cross sectional diagram illustrating an internal configuration of the input part 2012. The input part 2012 includes a case 2012d. The touch panel 2012a is mounted to an upper surface of the case 2012d so that the manipulation input surface 2102a faces away from the case 2012d. The input part 2012 further includes an illumination light source 2012c, an imaging optical system, and a hand imaging camera 2012b, which are received in the case 2012d and can function as a image date acquisition means or section. The hand imaging camera 2012b can act as an imaging device and is also referred to as a camera 2012b for simplicity. The illumination light source 2012c includes multiple light-emitting diodes (LEDs), which may be a monochromatic light source. Each LED has a mold having a convex surface, and has a high brightness and a high directivity in an upper direction of the LED. The multiple LEDs are located in the case 2012d so as to surround a lower surface of the touch panel 2012a. Each LED is inclined so as to point a tip of the mold at an inner part of the lower surface of the touch panel 2012a. When a user puts a front of the hand H over the manipulation input surface 2102a for instance, a first imaging reflected light RB1 generates and transmits through the touch panel and travels in a lower direction.

The imaging optical system includes a first reflecting portion 2012p and a second reflecting portion 2012r. As shown in FIG. 56B, the first reflecting portion 2012p is, for example, a prism plate 2012p, on a surface of which multiple tiny triangular prisms are arranged in parallel rows. The prism plate 2012p is transparent and located just below the touch panel 2012a. The prism plate 2012p and the touch panel 2012a are located on opposite sides of the case 2012d so as to define therebetween a space 2012f. The first reflecting portion 2012p reflects the first reflected light XXRB1 in an upper oblique direction, and thereby outputs a second reflected light XXRB2 toward a laterally outward side of the space 2012f. The second reflecting portion 2012r is, for example, a flat mirror 2012r located on the laterally outward side of the space 2012f. The second reflecting portion 2012r reflects the second reflected light XXRB2 in a lateral direction, and thereby outputs a third reflected light XXRB3 toward the camera 2012b, which is located on an opposite side of the space 2012f from the second reflecting portion 2012r. The camera 2012b is located at a focal point of the third reflected light XXRB3. The camera 2012b captures and acquires an image of the hand XXH with the finger of the user.

As shown in FIG. 56B, the multiple tiny prisms of the prism plate 2012p have a rib-like shape and have respectively reflecting surfaces that are inclined at the substantially same angle with respect to a mirror base plane MBP of the prism plate 2012p. The multiple tiny prisms are closely spaced and parallel to each other on the mirror base plane MBP. The prism plate 2012p can reflect the normal incident light in an oblique direction or the lateral direction. Due to the above structure, it becomes possible to place the first reflecting portion 2012p below the touch panel 2012a so that the first reflecting portion 2012p and the touch panel 2012a are parallel and opposed to each other. Thus, it is possible to remarkably reduce a size of the space 2012f in a height direction.

Since the second reflecting portion 2012r and the camera 2012b are located on laterally opposite sides of the space 2012f, the third reflecting light XXRB3 can be directly introduced into the camera 2012b by traveling across the space 2012f. Thus, the second reflecting portion 2012r and the camera 2012b can be placed close to lateral edges of the touch panel 2012a, and, a path of the light from the hand)0(H to the camera 2012b can be, so as to speak, folded in three in the space 2012f. The imaging optical system can therefore be reparably compact as a whole, and the case 2012d can be thin. In particular, since the reducing of size of the touch panel 2012a or the reducing of area of the manipulation input surface 2102a enables the input part 2012 to be remarkably downsized or thinned as a whole, it becomes possible to mount the input part 2012 to vehicles whose center console XXC has a small width or vehicles whose have a small attachment space in front of a gear shift lever. The input part 2012 can detect a hand as a hand image region when the hand is relatively close to the touch panel 2012a, because a large amount of the reflected light can reach the camera 2012b. However, as the hand is spaced apart from the touch panel 2012a, the amount of the reflected light decreases. Thus, the input part 2012 does not recognize a hand spaced a predetermined distance apart from the touch panel 2012a in the image of the hand. For example, when a user moves a hand across above the touch panel 2012a to operate a different control device (e.g., a gear shift lever) located close to the input part 2012, if the hand is sufficiently spaced apart from the touch panel 2012a, the hand image region with a valid area ratio is not detected, and thus, errors hardly occur in the below-described information input process using hand image recognition.

The manipulation input surface 2102a of the touch panel 2012a corresponds to a photographing range of the camera 2012b. As shown in FIG. 59, on an assumption that the hand has an average size of adult hand, the manipulation input surface 2102a has a dimension in an upper-lower direction corresponding to a Y direction, such that only a part of the hand in a longitudinal direction of the hand is within the manipulation input surface 2102a, the part including a middle finger tip. For example, the dimension of the manipulation input surface 2102a in the Y direction may be in a range between 60 mm and 90 mm, and may be 75 mm in an illustrative case. Because of the above size, the monitor 2015 can display only a part of the hand between bases of fingers and ends of fingers on the display screen, and the palm of the hand (another part of the hand except the fingers) may not be involved in display, and thus, it is possible to remarkably simplify the below-described display procedure using an pointer image. A dimension of the manipulation input surface 2102a in a right-left direction corresponding to an X direction is in a range between 110 mm and 130 mm. Thus, when the fingers of the hand are opened far apart from each other on the manipulation input surface 2102a, the forefinger, the middle finger and the ring finger are within the photographing range, and the thumb is outside the photographing. It should be noted that, when fingers appropriately get close to each other, all of the fingers can be within the photographing range. Further, when a palm of the hand XXH covers the manipulation input surface 2102a, the hand covers between 60% and 100% (e.g., 80%) of the total area of the manipulation input surface 2102a and makes a hand cover state, as shown in the top of FIG. 59.

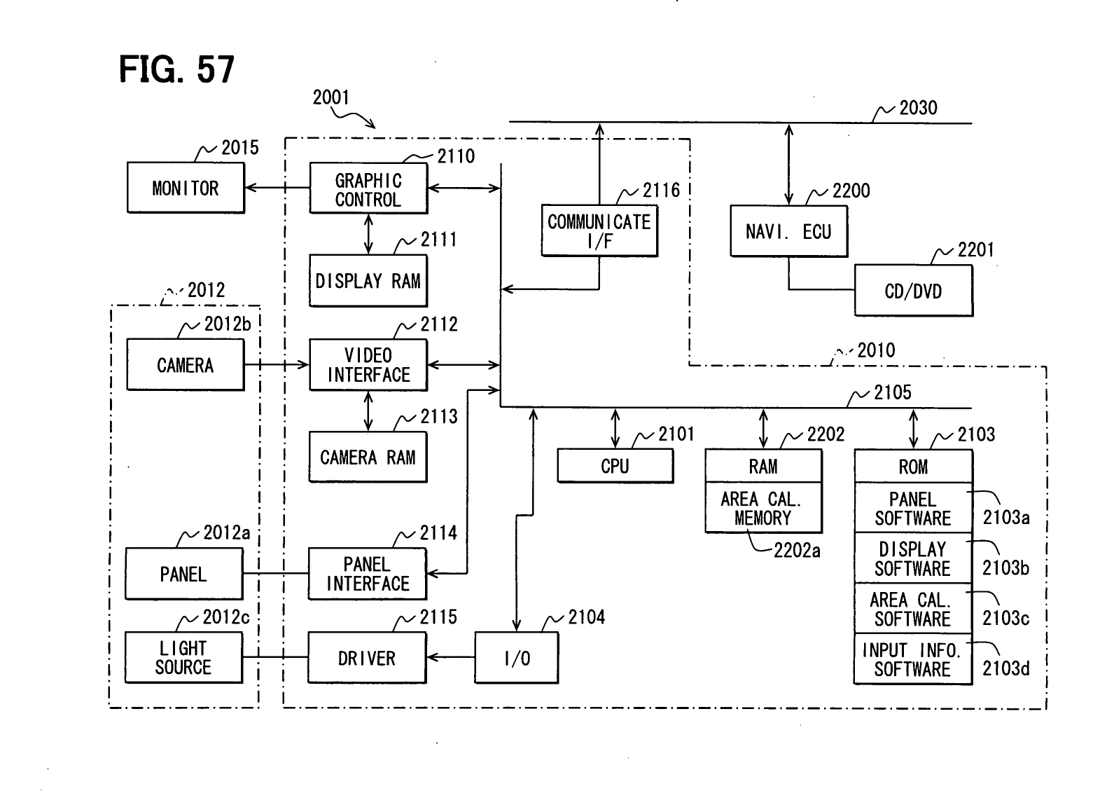

FIG. 57 is a block diagram illustrating an electrical configuration of the control device 2001. The control device 2001 includes an operation ECU (electronic control unit) 2010 acting as a main controller. The operation ECU 2010 may be provided as a computer hardware board. The operation ECU 2010 includes a CPU 2101, a RAM 2102, a ROM 2103, a graphic controller 2110, a video interface 2112, and a touch panel interface 2114, a general-purpose I/O 2104, a serial communication interface 2116 and an internal bus connecting the foregoing components with each other. The graphic controller 2110 is connected with the monitor 2015 and a display video RAM 2111. The video interface 2112 is connected with the camera 2012b and a imaging video RAM 2113. The touch panel interface 2114 is connected with the touch panel 2012a. The general-purpose I/O 2104 is connected with the illumination light source 2012c via a driver (drive circuit) 2115. The serial communication interface 2116 is connected with an in-vehicle serial communication bus 2030 such as a CAN communication bus and the like, so that the control device 2001 is mutually communicatable with another ECU network-connected with the in-vehicle serial communication bus 2030. Another ECU is, for example, a navigation ECU 2200 for controlling the car navigation apparatus.

An image signal, which is a digital signal or an analog signal representing an image captured by the camera 2012b, is continuously inputted to the video interface 2112. The imaging video RAM 2113 stores therein the image signal as image frame data at predetermined time intervals Memory content of the imaging video RAM 2113 is updated on an as-needed basis each time the imaging video RAM 2113 stores new image frame data.

The graphic controller 2110 acquires data of an input window image frame from the navigation ECU 2200 via the serial communication interface 2116 and acquires data of a pointer image frame from the CPU 2101. In the pointer image frame, a pointer image is pasted at a predetermined place. The graphic controller 2110 performs alpha blending or the like to perform frame synthesis on the display video RAM 2111 and outputs to the monitor 2015.

The touch panel interface 2114 includes a drive circuit corresponding to a type of the touch panel 2012a. Based on the input of a signal from the touch panel 2012a, the touch panel interface 2114 detects an input location of a touch manipulation on the touch panel 2012a and outputs a detection result as location input coordinate information.

Coordinate systems having one-to-one correspondence relationship to each other are set on the photographing range of the camera 2012b, the manipulation input surface of the touch panel 2012a and the display screen of the monitor 2015. The photographing range corresponds to an image captured by the camera 2012b. The manipulation input surface acts as a manipulation input region. The display screen corresponds to the input window image frame data and the pointer image frame data, which determine display content on the display screen.

The ROM 2103 stores therein a variety of software to cause the CPU 2101 to function as a hand image region identification means or section, a area ratio calculation means or section, and a operation input information generation means or section. The variety of software includes touch panel control software 2103a, display control software 2103b, hand image area ratio calculation software 2103c and operation input information generation software 2103d.

The touch panel control software 2103a is described below. The CPU 2101 acquires an input location coordinate from the touch panel interface 2114. The CPU 2101 further acquires the input window image frame and determination reference information from the navigation ECU 2200. The determination reference information can be used for determining content of the manipulation input. For example, the determination reference information includes information used for specifying a region for soft button, and information used for specifying content of a control command that is to be outputted in response to a touch manipulation directed to the soft button. The CPU 2101 specifies content of the present manipulation input based on the input location coordinate and the determination reference information, and issues and outputs a command to cause the navigation ECU 2200 to perform an operation corresponding to the manipulation input.

The display control software 2103b is described below. The CPU 2101 instructs the graphic controller 2110 to read the input window image frame data. Further, the CPU 2101 generates the pointer image frame data in the below described way, and transmits the pointer image frame data to the graphic controller 2110.

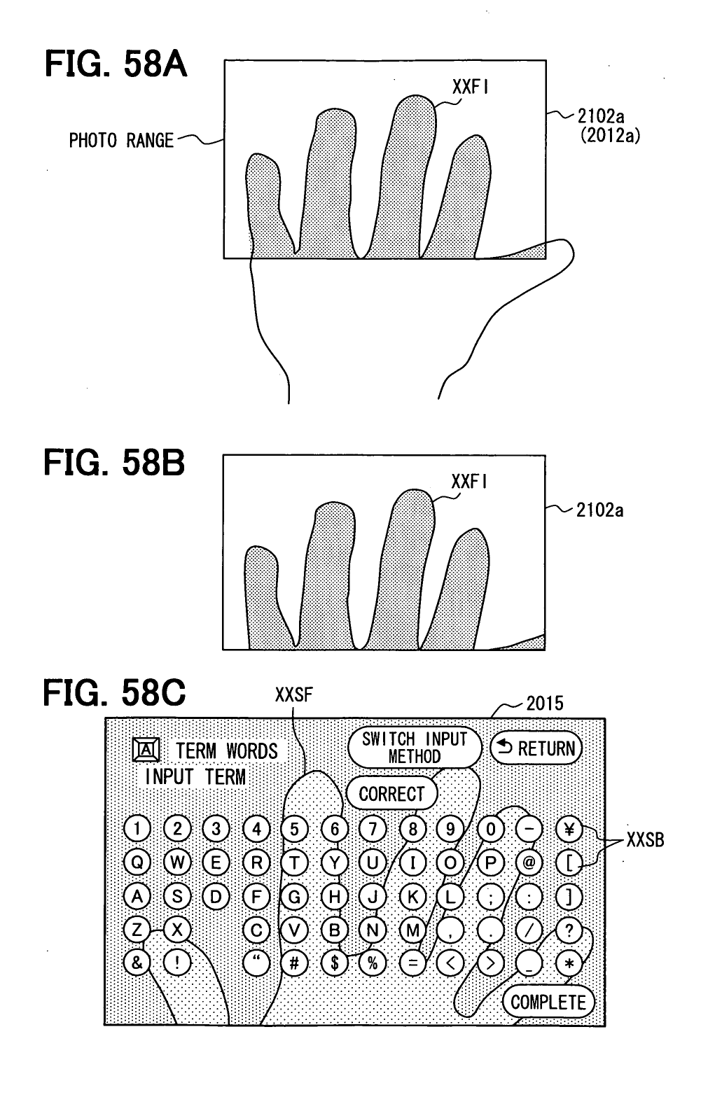

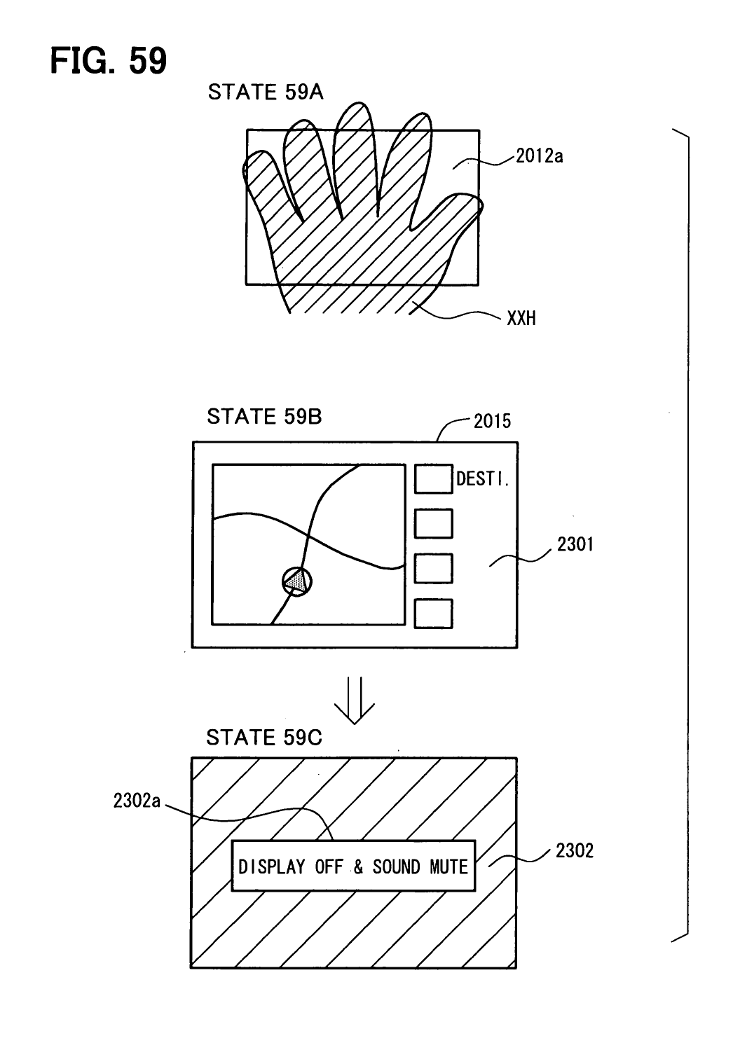

The hand image area ratio calculation software 2103c is described below. The CPU 2101 identifies a hand region XXFI in the captured image as shown in FIG. 58B, and calculates a hand image area ratio of the identified hand region XXFI to the manipulation input region of the touch panel 2012a. The hand image area ratio can be calculated as S/S0 where S0 is the total area of the manipulation input region or the total number of pixels of the display screen, and S is the area of the hand region XXFI or the number of pixels inside the hand region XXFI. Alternatively, when the number of pixels of the display screen for displaying the hand region XXFI is constant, because the area of the hand region XXFI or the number of pixels inside the hand region FI has a value reflecting the hand image area ratio, the value may be used as the hand image area ratio.

The operation input information generation software 2103d is described below. The CPU 2101 generates operation input information directed to the in-vehicle electronic apparatus based on manipulation state on the touch panel and the hand image area ratio.

For example, the followings can be illustrated as the operation input information.

(1) A one-to-one relationship between value of the hand image area ratio and content of the operation input information is predetermined. The CPU 2101 determines the content of the operation input information that corresponds to the calculated value of the hand image area ratio, based on the one-to-one relationship. More specifically, when the calculated value of the hand image area ratio exceeds a predetermined area ratio threshold (in particular, when the hand cover state in which the hand image area ratio exceeds 80% is detected), the CPU 2101 outputs predetermined-function activation request information as the operation input information. The predetermined-function activation request information is for requesting activation of a predetermined function of the in-vehicle electronic apparatus. The predetermined function of the in-vehicle electronic apparatus is, for example, to switch display from a first window 2301, which is illustrated in FIG. 59 as the state 59B, into a second window 2302, which is illustrated in FIG. 59 as the state 59C, when the hand image area ratio exceeds the predetermined area ratio threshold. In other words, when the hand image area ratio is changed from a value less than the predetermined area ratio threshold into another value greater than the predetermined area ratio threshold, window switch command information is outputted as window content change command information to switch the display from the first window into the second window.

(2) When a predetermined manipulation input is provided on the touch panel 2012a after the predetermined function is activated in the in-vehicle electronic apparatus, the CPU 2101 outputs operation change request information for changing operation state of the predetermined function. For example, the operation change request information is operation recover request information that request deactivation of the predetermined function in the in-vehicle electronic apparatus and recovers the in-vehicle electronic apparatus into a pre-activation stage of the predetermined function. For example, when the touch manipulation on the touch panel 2012a is made after the display is switched into the second window 2302 on the display screen of the monitor 2015, the CPU 2101 outputs, as the operation input information, the window recovery request information to switch the display on the monitor into the first window 2301.

In the followings, operation of the control device 2001 is explained.

It is here assumed that, due to an previous input of a command based on a touch manipulation made in another window for example, an input window illustrated in FIG. 58C is displayed on the display screen and a ponder image is not displayed at the present stage. It should be noted that, although the input window shown in FIG. 58C is a keyboard input window, the input window may be another input window such as a map window illustrated as the state 59B in FIG. 59 and the like. When, as shown in FIG. 56A, the hand approaches the manipulation input surface 2102a of the touch panel 2012a in the above assumed state, the camera 2012b captures an image of a hand based on the light that is outputted from the illumination light source 2012c and reflected from the hand, as shown in FIG. 58A. In the image of the hand, the pixels corresponding to the hand is brighter than those corresponding to a background region. Thus, as shown in FIG. 58B, by binarizing the brightness of the pixels using an appropriate threshold, it is possible to separate the image of the hand into two regions; one is a hand image region XXFI (shown as a dotted region in FIG. 58B) where pixel brightness is large and becomes “1” after the binarizing; and the other is a background region (shown as a blank region in FIG. 58B) where pixel brightness is small and becomes “0” after the binarizing.

An outline of the hand image region is extracted. A pixel value for a region inside the outline and that for another region outside the outline are set to different values so that it is possible to visually distinguish between the region' outside the outline and the region inside the outline. The CPU 2101 generates the pointer image frame, in which a pointer image XXSF corresponding to a shape of the finger image region is pasted at a place corresponding to the hand image region. The pointer image frame is transferred to the graphic controller 2110 and is combined with the input window image frame, and is displayed on the display screen of the monitor 2015. A way of combining the input window image frame and the pointer image frame may depend on data format of the pointer image XXSF, and may be the following ways.

(1) When bitmap data is used for the pointer image, an alpha blending process is performed on the corresponding pixels, so that the pointer image with partial transparency can be superimposed on the input window.

(2) Data of the outline of the pointer image is converted into vector outline data. Thereby, it is possible to use the pointer image frame in which its handling points are mapped on frame. In this case, the graphic controller 2110 generates the outline of the pointer image by using the data on the frame, and performs a raster writhing process to generate bit-maps in an inside of the outline, and then performs the alpha blending similar to that used in (1).

(3) In a way similar to the above-described (2), the outline is drawn on the input window image frame by using the vector outline data corresponding to the pointing image data, and the pixels inside the outline in the input window image are extracted, and setting values of the extracted pixels are shifted uniformly.

According to any one of the methods (1) to (3), regarding the pixels forming the outline of the pointer image data, it is possible to superimpose the pointing image whose outline is high lightened due to an increase in blend ratio of the pointer image data. Alternatively, the pointer image may be an image of only the outline in the form of bitmap data or victor outline data, and only the outline may be superimposed.

As shown in FIG. 55, while watching an input window (referred to also as a window 2015) on the monitor 2015 illustrated in FIG. 58C or 59, a user sitting in a seat may perform a virtual figure operation input on the touch panel 2012a to operate a soft button XXSB displayed on the window 2015. As shown in FIG. 56A, when the hand XXH of the user gets access to the touch panel 2012a, the camera 2012b captures an image of the hand XXH, and the monitor 2015 superimposes the pointer image (corresponding to the hand image region) on the window 2015 based on the above-described image processing so that a location of the pointer image corresponds to a location of the hand XXH. Accordingly, by watching a positional relationship between the soft button XXSB and the pointer image XXSF on the window 2015, the user can recognize an actual positional relationship between a soft button region (which is set on the touch panel 2012a) and the hand XXH on the touch panel 2012a. Thereby, it becomes possible to assist an input operation directed to the soft button XXSB.

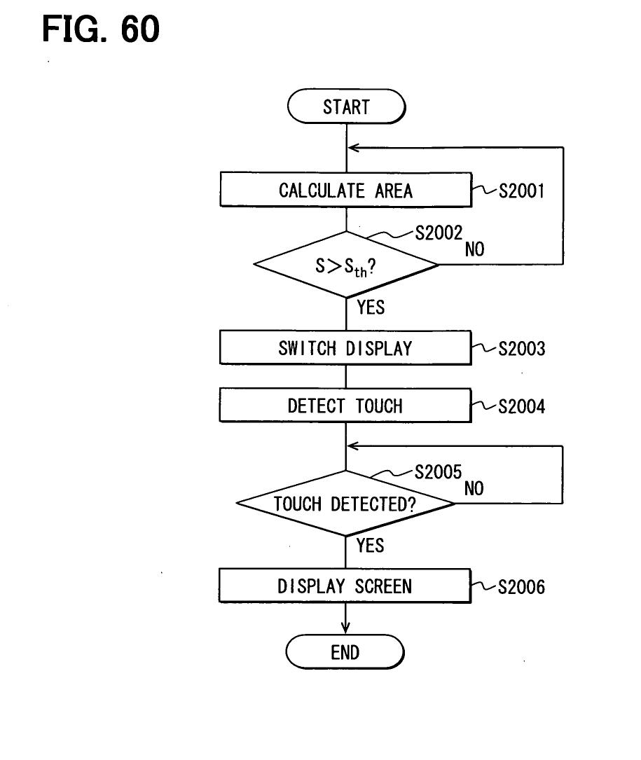

In the above-described described process, the touch panel 2012a independently generates the user operation input information, which does not involve information on an image captured by the camera 2012b. In the present embodiment, an input information generation procedure for generating input information involved in the information on an image captured by the camera 2012b is performed in parallel by the hand image area ratio calculation software 2103c and the operation input information generation software 2103d in accordance with a flowchart illustrated in FIG. 60.

The input information generation procedure is described below with reference to FIG. 60. At S2001, area ratio of the hand image region XXFI to the manipulation input surface 2102a of the touch panel 2012a is calculated as hand image area ratio. Alternatively, an absolute value of area of the hand image region XXFI or the number of pixels of the hand image region XXFI may be calculated as the hand image area ratio. At S2002, it is determined whether the hand image area ratio S is grater than a threshold Sₜₕ, which is for example 0.8. When the hand image area ratio S is measured by the absolute value of area of the hand image region XXFI or the number of pixels of the hand image region XXFI, the threshold Sₜₕ, may be an absolute value threshold or the threshold number of pixels. When it is determined that the hand image area ratio is less than or equal to the threshold, the process returns to S1 to monitor the hand image area ratio. In a case illustrated in FIG. 58B for example, the hand image area ratio is less than 0.4, and a normal touch input procedure may be performed with reference to the input window, as shown in FIG. 58C.

As shown by the state 59A in FIG. 59, a state where the hand image area ratio is greater than 0.8 is recognized as the hand cover state. If the hand cover state occurs when the first window 2301 is displayed as the input window shown by the state 59B in FIG. 59, the window content change request, information or the predetermined-function activation information is transferred to the display control software 2103b to switch the display into the second window 2302 as shown by the state 59C in FIG. 59. The display control software 2103b receives the window content change request information or the predetermined-function activation information, and performs a display switching process to switch the display at S2003.

When the display is switched into the second window 2302, an accompanying function may be activated as a different predetermined function of the in-vehicle electronic apparatus. Examples of such accompanying function are the followings: (1) to mute, to turn down the volume, to pause on an audio apparatus and the like; (2) to change an amount of airflow on a vehicle air conditioner such as a temporal increase in amount of air flow and the like. In the above cases, the switching of the display into the second window 2302 is used as visual notification information indicative of the activation of the predetermined function. The second window 2302 may be a simple blackout screen, in which the display is OFF. Alternatively, for convenience, an information item showing content of the accompanying function may be displayed.

Explanation returns to FIG. 60. When the hand area ratio becomes less than the threshold area ratio from the hand cover state, the second window 2302 continues to be displayed and the accompanying function continues to be activated. At S2004 and S2005, when the touch panel 2012a receives a predetermined manipulation input (e.g., a touch manipulation), window recovery request information is outputted as the operation input information to recover the display of the monitor 2015 into the first window 2301. When the display control software 2103b receives the display recovery request information, the display control software 2103b performs at S6 a display switching process to switch the display. Further, the accompanying function is deactivated and is returned to a pre-activation stage. For example, the mute, the turn down of the value, or the stop of a function of the audio apparatus is canceled. The change in amount of airflow of the car air conditioner is canceled.

### Modifications of Second Embodiment

The second embodiment can be modified in various ways, examples of which are described below.

The operation input information generation software 2103d may be configured to detect a time variation in value of the hand image area ratio. When the detected time variation matches a predetermined time variation, the manipulation input information generation software 2103d may generate and output the operation input information having the content corresponding to the predetermined time variation. According to the above configuration, it is possible to relate a more notable input hand movement to the operation input information. It is therefore possible to realize more intuitive input operation.

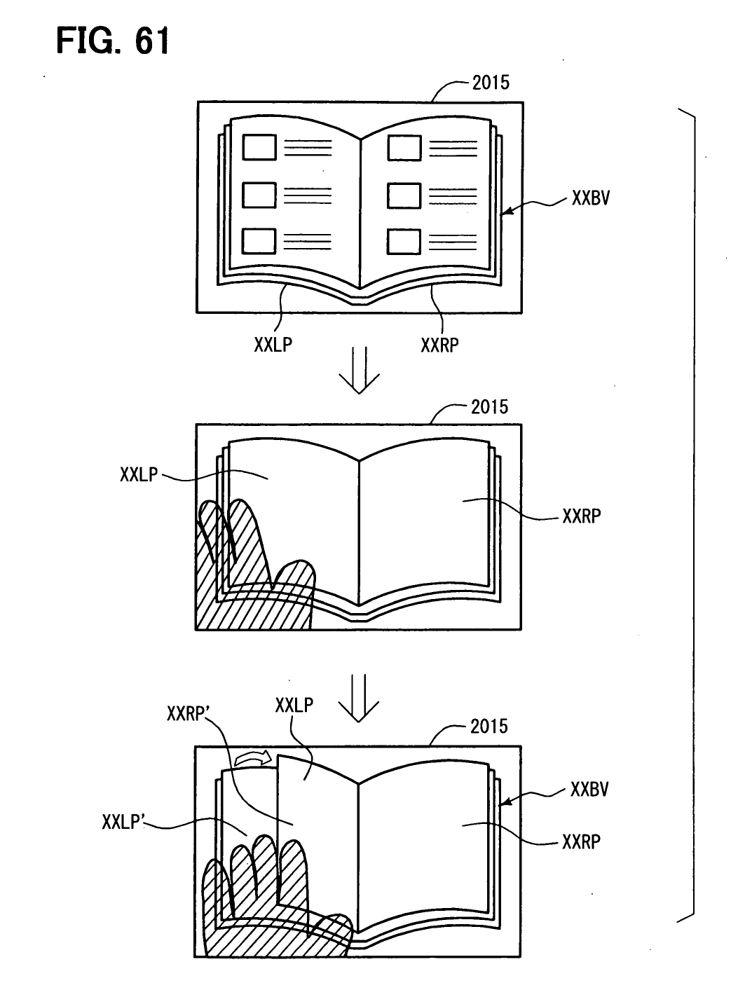

FIG. 61 illustrates a book viewer XXBV displayed by the monitor 2015. The book viewer XXBV has a left page XXLP and a right page XXRP as information display regions. When a command to turn a page is issued, a moving image is displayed to show that a leaf is flipped from left to right (see the bottom of FIG. 61) or from right to left, and the display is switched into a new spread that displays a page XXRP′ located on an opposite side of the turned leaf from the page XXRP and a page XXLP′ that is a page next to the page XXRP′.

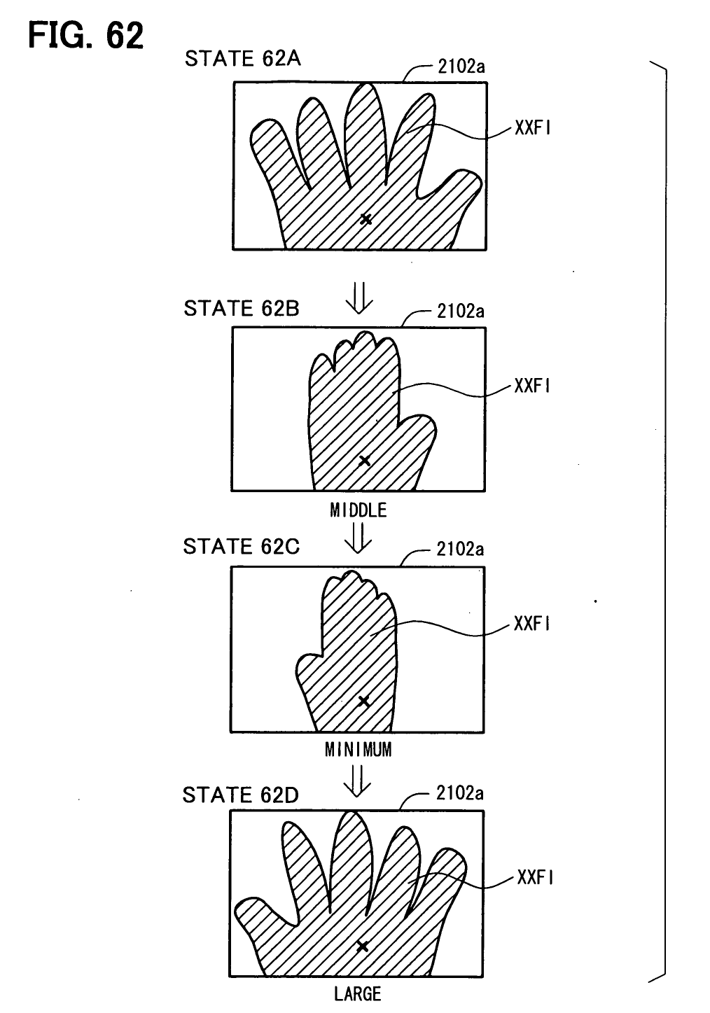

The control device 2001 can operate the above-described book view BV in the following way. The camera 2012b captures a moving image of a user input movement that is imitative of the flipping of a page. Based on the moving image, a time variation in shape of the hand image region is detected as a time variation of the hand image area ratio. When the time variation of the hand image area ratio matches a predetermined time variation, a command to flip a page is issued as the operation input information. Using the above way, a user can virtually and realistically flip a page on the book viewer displayed on the display screen, by performing the input hand movement that is imitative of the flipping of a page above the touch panel 2012a. As shown in FIG. 62, the input hand movement that is imitative of the flipping of a page may be the following sequence of actions. The state 62A in FIG. 62 illustrates the first action (act I) where a user puts the palm FI to the manipulation input surface 2102a so that a region corresponding to a leaf to be flipped is covered by the palm FI. The states 62B and 62C in FIG. 62 respectively illustrate the second and third actions (act II and act III) where the palm FI is turned up above the manipulation input surface 2102a. The state 62D in FIG. 62 illustrates the fourth action (act IV) where the palm FI is reversed.

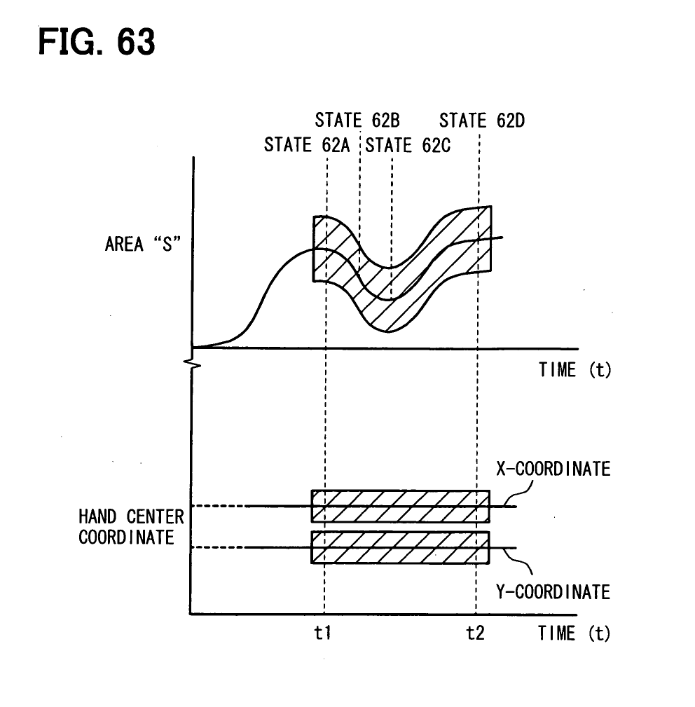

A graph illustrated in the upper of FIG. 63 shows a change in area of the hand image region in the input hand movement that is imitative of the flipping of a page. As shown in FIG. 63 the area of the hand image region is reduced in the series actions of ACT. I, ACT. II and ACT III, and is then increased around ACT. IV. The time variation of the hand image area or that of the hand image area ratio has minimum and is a convex downward shape. On a time-area plane, a determination area (window) having a shape corresponding to the above convex downward shape and having a predetermined allowable width is set. When the time variation of the hand image area obtained from actual measurement is within the determination area, the command to flip a page is issued.

In the above, a time variation in position of the center of the hand image region FI may be further determined. When both of the time variation of the hand image area ratio and the time variation in position of the center respectively match predetermined time variations, the command to flip a page may be issued. In this configuration, it is possible to identify the input hand movement that is imitative of the flipping of a page with higher accuracy. Since the manipulation input surface 2102a is relatively small, the palm is reversed while position of the wrist in the X direction is being kept, and thus, the position of the center of the palm is not changed so much. Thus, regarding each of coordinate values of X, Y axes, a determination area (window) having a predetermined allowance width in the coordinate axis is set on a time-coordinate plane, as shown in the bottom of FIG. 63. When the time variation in coordinate of the center is within in the determination area, the command to flip a page is issued.

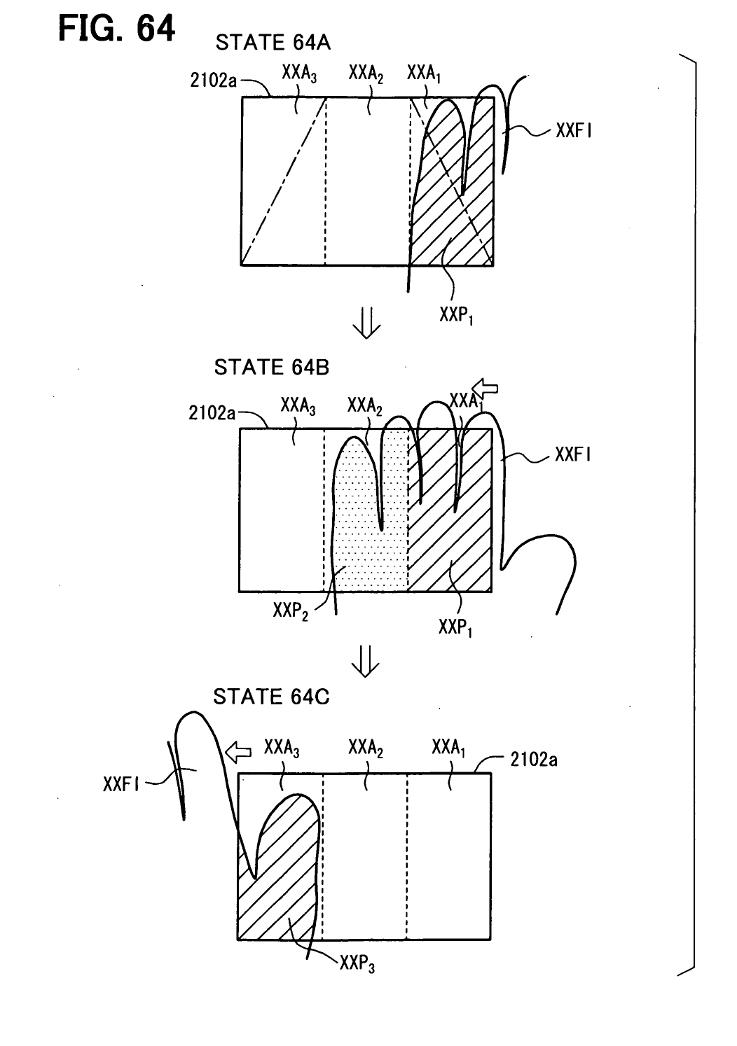

As another method, as shown in FIG. 64 the manipulation input region 2102a may be divided into multiple sub-regions “XXA₁”, “XXA₂”, “XXA₃”. The area ratio of the hand image region in each of the sub-regions “XXA₁”, “XXA₂” “XXA₃” may be calculated. In the above configuration, the time variation of the hand area ratio in each of the sub-regions “XXA₁”, “XXA₂” “XXA₃” can be detected. The time variation of the number or location of sub-regions whose value of the hand image area ratio of the hand imaged region XXFI exceeds the threshold can be detected. Thereby, a predetermined input hand movement can be identified. For example, the sub-region in which the hand image area ratio of the hand image region is greater than or equal to a threshold of, for example, 0.8 is recognized as a first state sub-region. The sub-region in which the hand image area ratio of the hand image region is less than the threshold is recognized as a second state sub-region. A change in distribution of the first state sub-regions and the second state sub-regions on the manipulation input region 2102a over time is detected as a state distribution change. When the detected state distribution change matches a predetermined state distribution, the operation input information corresponding to the detected state distribution change is generated and outputted.

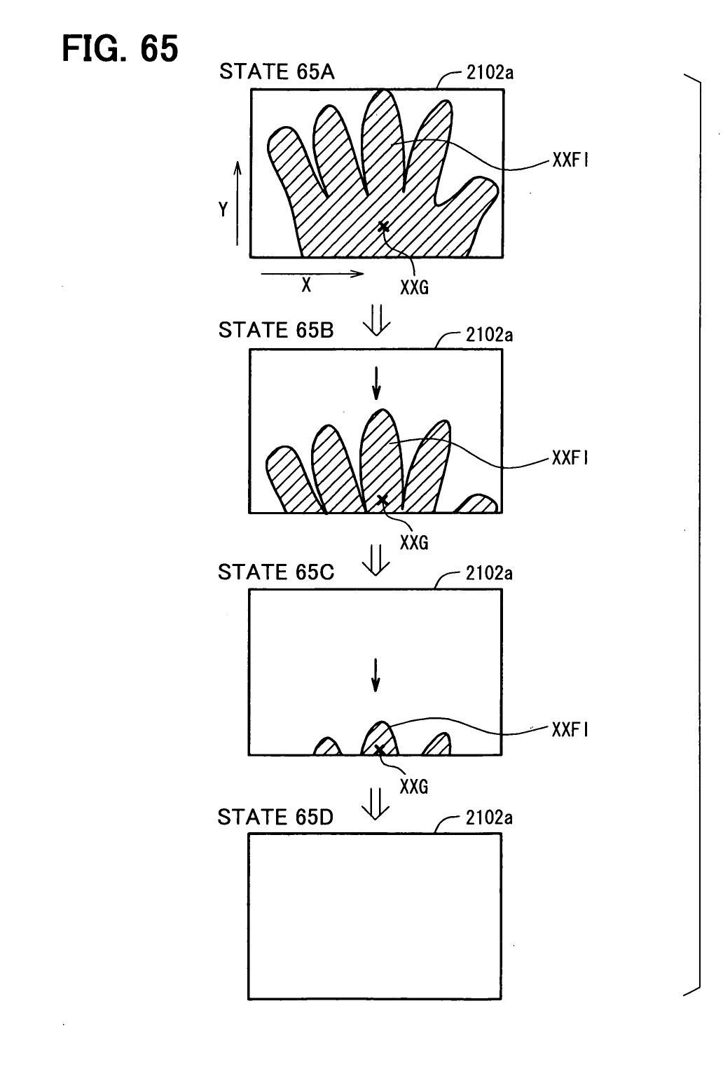

More specifically, as the predetermined input hand movement, it is possible to use a hand movement including a series of actions respectively illustrated in FIG. 65 as the states 65A to 65D. The hand movement is such that the hand approaches the touch panel 2012a from a right side of the touch panel 2012a, and moves leftward while being spaced apart from the touch panel 2012a. The hand movement may be used to, but not limited to, to issue a command to invoke a function of selecting a next album or starting play of the next album when the control device 2001 is in an audio apparatus operation mode or displays the input window. More specifically, a change in appearance location distribution of the first state sub-region and the second sub-region is detected as the state distribution change. Further a change of ff the number of first state sub-regions and second state sub-regions appearing on the manipulation input region 2102a is detected as the state distribution change. In the above, the first state sub-region may be encoded as 1, and the second state sub-region may be encoded as 0. In the case of the flipping of a page, as shown in FIG. 64, the input hand operation performed by a user may be such that the hand moves across the manipulation input region 2102a in a left-right direction (i.e., X direction) from a first end (which is a right end in FIG. 64) to a second end (which is a left end in FIG. 64) of the manipulation input region 2102a. To detect the above input hand operation, the manipulation input region 2102a is divided in the sub-regions “XXA₁”, “XXA₂” “XXA₃”, each of which has a rectangular shape, and which are aligned in the X direction. A movement of appearance location of the first state sub-regions and a variation of the number of first state sub-regions are determined.

When the hand is not close to the touch panel 2012a, all of the sub-regions “XXA₁”, “XXA₂”, “XXA₃” becomes the second state-sub regions. When the hand approaches the touch panel 2012a from the right side of the touch panel 2012a, the hand image area ratio in the sub-region “XXA₁” increases, and then, the sub-region “XXA₁” becomes the first state sub-region while the sub-regions “XXA₂” and “XXA₃” are the second state sub-regions. The state distribution in the above case can be expressed as {XXA₁, XXA₂, XXA₃}={1, 0, 0} according to the above-described definition in the encoding. When the hand is further moved from right to left as shown by the states 64B and 64C in FIG. 64, the state distribution becomes {XXA₁, XXA₂, XXA₃}={0, 1, 1}, and then changes from {1, 1, 1} to {1, 1, 0}, and becomes {XXA₁, XXA₂, XXA₃}={1, 0, 0} at the moment shown by the state 64C in FIG. 64. Then, finally, the state distribution becomes {1, 0, 0}. By measuring a change in state distribution {XXA₁, XXA₂, XXA₃} in the above-described way, it is possible to detect movement of the hand from right to left.

It is possible to detect the movement of the hand from left to right by detecting the state distribution {XXA₁, XXA₂, XXA₃} whose change is opposite to that show in the movement of the hand from right to left. Using the above-described ways, it is possible to distinguishingly detect different manipulations; one is to move a hand from right to left or from left to right while the hand is being spaced apart from the touch panel 2012a; and another is to move a finger or a hand while the finger or the hand is contacting or pressing down the touch panel 2012a. For example, when the control device 2001 is in an audio apparatus operation mode or displays the input window, a command to select a next track or a previous track corresponds to a manipulation of moving the finger between left and right with the finger making touch. A command to select a next album or a previous album corresponds to a manipulation of moving finger between left and right without the finger making touch. Accordingly, it is possible to provide a user with intuitive and natural operation manners.

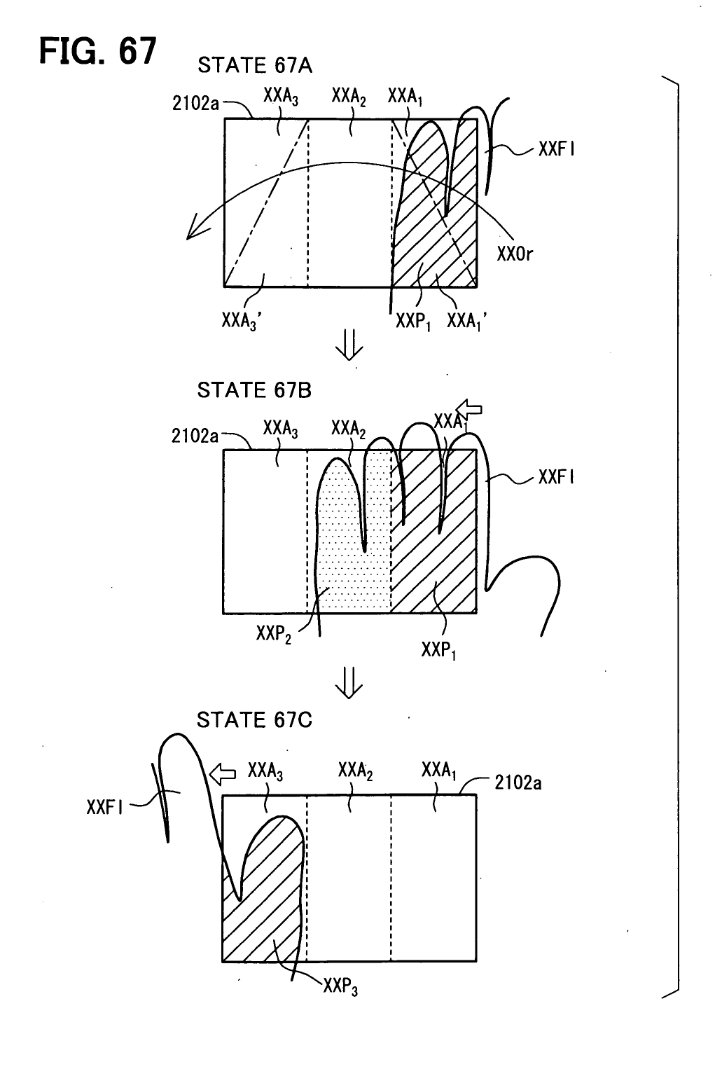

A shape of the sub-region is not limited to rectangular or square. Alternatively, the sub-region may have other shapes. For example, the sub-region may have any polygonal shape including rectangular, triangular, and the like. As an example, triangular sub-regions are illustrated in FIG. 67 by using the dashed-dotted lines. In FIG. 67, the triangular sub-regions A₁′, A₃′ are set to correspond to the utmost right and utmost left sub-regions A₁, A₃ illustrated in the state 64A in FIG. 64. Although the utmost right and utmost left sub-regions A₁, A₃ in the state 64A in FIG. 64 are rectangular, each of the utmost right and utmost left sub-regions A₁, A₃ is divided into two triangles in a case of the state 67A of FIG. 67 by a diagonal line that interconnects between an upper vertex adjacent to the central sub-region A₂ and a lower vertex opposite to the central sub-region A₂. Out of the two triangles, only one triangle adjacent to the central sub-region A₂ is used as the sub-region A₁′, A₃′. The other of the two triangles does not contribute to the calculation of the hand image area ratio. When the hand is moved between the right and the left while being spaced apart from the touch panel 2012a, the hand may move on an arc trajectory Or, as shown on the upper of FIG. 67. In such a case, the sub-regions A₁′, A₃′ correspond to regions that are to be swept in the hand movement. Thus, when the triangular sub-regions A₁′, A₃′ are set in the above described manner, the other of the two triangles can be excluded from calculation of the hand image area ratio. As a result, even in the hand movement along the trajectory Or, it becomes possible to easily detect fingers approaching from a lower side, because each sub-region A₁′, A₃′ has a wider area at a lower portion.

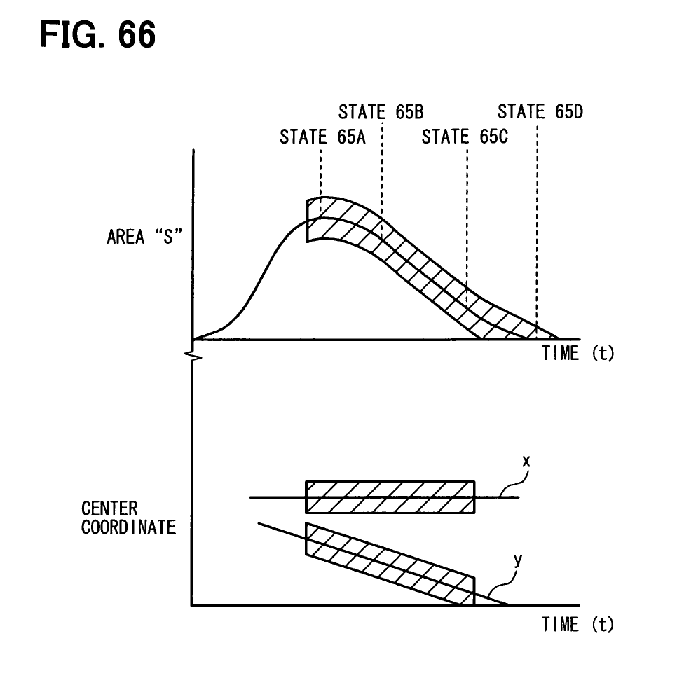

FIG. 65 illustrates an input hand movement according to another modification. The input hand movement in FIG. 65 can be used for inputting a disk ejection command to a CD/DVD drive 2201 (see FIG. 57) connected with the navigation ECU 2200. The disk ejection command is one example of the operation input information. The hand image region is changed in the order of the states 65A to 65D shown in FIG. 65. The hand image XXFI moves down from the center of the display toward a lower side in the Y direction. Thus, the time variation of the hand image area ratio monotonically decreases in the movement shown as a sequence of the states 65A to 65D. On a time-area plane, a determination area (window) having a shape corresponding to the above time variation and having a predetermined allowable width is set, as shown in the upper part of FIG. 66. When the time variation of the hand image area obtained from actual measurement is within the determination area, the disk ejection command is issued.

In the above case, the center XXG of the hand image region FI does not changes largely in the X direction but changes remarkably in the Y direction. Thus, when a time variation in coordinate of the center XXG is within a determination area (window) illustrated in the lower part of FIG. 66, the disk ejection command is issued.

### Aspects of Second Embodiment

The second embodiment and it modifications have the following aspects.

According to an aspect, there is provided a control device for a user to operate an in-vehicle electronic apparatus in a vehicle by manipulating the control device. The control device includes: a manipulation input element that is located so as to be within reach of the user who is sitting in a seat of the vehicle, and that has a manipulation input region having a predetermined area; an imaging device that has a photographing range covering the manipulation input region, and that captures an image including a hand image region representative of the hand of the user getting access to the manipulation input element; a hand image region identification section that identifies the hand image region in the image; an area ratio calculation section that calculates a value of hand image area ratio, which is area ratio of the hand image region to the manipulation input region; and an operation input information generation section that generates and outputs operation input information based on the calculated value of the hand image area ratio and a manipulation state of the manipulation input region, the operation input information being directed to the in-vehicle electronic apparatus.

According to the above aspect, as input information, it is possible to efficiently use information on the image captured by the imaging device in addition to the input information provided from the manipulation input element. Therefore, it is possible to largely extend input forms in utilizing the control device.

The above control device may be configured such that: the operation input information generation section determines content of the operation input information, based on a predetermined correspondence relationship between the content of the operation input information and the value of the hand image area ratio; and the operation input information section generates and outputs the operation input information having the content that corresponds to the calculated value of the hand image area ratio. According to this configuration, by preliminarily determining the content of the operation input information in accordance with the value of the hand image area ration, It is possible to easily determine the content of the operation input information to be outputted.

The above control device may be configured such that, when the calculated value of the hand image area ratio exceeds a predetermined threshold, the operation input information generation section outputs predetermined-function activation request information as the operation input information to request a predetermined-function of the in-vehicle electronic apparatus to be activated. According to this configuration, it is possible to determine a distinctive input manipulation as an operation for calling the predetermined function of the in-vehicle electronic apparatus, and thus, it is possible to activate the predetermined function in an intuitive manner by using a simple manipulation. For example, the predetermined threshold of the hand image area ratio may be set to a large value to the extent that an input manipulation causing the hand image area ratio large than the predetermined threshold is distinguishable from a normal input manipulation such as a mere touch manipulation made by a finger and the like. In such setting, it is possible to minimize an occurrence of error operation of activating the predetermined function in un-desirable timing. For example, the above control device may be configured such that: the predetermined threshold is larger than 0.6 or 0.7 and may be set to 0.7 for instance; the value of the hand image area ratio larger the predetermined threshold corresponds to an occurrence of a hand cover state in the manipulation input region; and the operation input information generation section outputs the predetermined function activation request information when the hand cover state is detected.

The above control device may be configured such that, when the manipulation input element receives a predetermined manipulation input after the predetermined-function of the in-vehicle electronic apparatus is activated, the operation input information generation section outputs operation change request information to request a change in operation state of the predetermined-function of the in-vehicle apparatus. According to this configuration, since it is possible to change the operation state of the predetermined-function based on an input via the manipulation input element, it is possible to increase a variation of control related to operation of the predetermined function.

For example, the operation change request information may be operation recover request information that requests deactivation of the predetermined-function of the in-vehicle electronic apparatus to recover the in-vehicle electronic apparatus into a pre-activation stage of the predetermined-function. In this configuration, it is possible to easily and smoothly suspend the operation of the predetermined function in response to the predetermined input manipulation on the manipulation input element.

The above control device may further include an area ratio variation detection section that detects a time variation in value of the hand image area ratio, the time variation being caused by a predetermined input hand movement in the manipulation input region. Further, when the detected time variation matches a predetermined time variation, the operation input information generation section may generate and output the operation input information having the content that corresponds to the predetermined time variation. In this configuration, it is possible to relate a more distinctive manipulation input to the operation input information, and the control device enables a more intuitive input operation. The above control device may be configured such that: a time variation in location of the center of the hand image region may be further detected in addition to the time variation in value of the hand image area ratio; and the operation input information generation section may generate and output the operation input information having the corresponding content when both of the above time variations respectively matches predetermined time variations. In this configuration, it is possible to more precisely detect and specify hand movement that is defined as a specific input manipulation. Further, it is possible to more reliably to distinguish the specific input manipulation from the normal input manipulation. In such setting, it is possible to further minimize an occurrence of error operation of activating the predetermined function in un-desirable timing.

The above control device may be configured such that: the manipulation input region is divided into multiple sub-regions; the hand image area ratio calculation section calculates the hand image area ratio in each of the multiple sub-regions; the hand image area ratio variation detection section detects and specifies the time variation in value of the hand image area ratio in each of the multiple sub-regions. According to this configuration, it is possible to detect and specify the input hand movement in more details.

The above control device may be configured such that: the hand image area ratio variation detection section detects a first state sub-region, which is the sub-region whose value of the hand image area ratio is grater than or equal to the predetermined threshold; the hand image area ratio variation detection section detects (i) a number of first state sub-regions and (ii) a change in appearance location of, the first sub-region in the multiple sub-regions over time as a transition behavior; and the operation input information generation section generates and outputs the operation input information when the detected transition behavior matches a predetermined transition behavior. According to this configuration, by (i) the number of first state sub-regions and (ii) the change in appearance location of the first sub-region over time, it is possible detect and specify the hand moving above the manipulation input region without detecting the location of the center of the hand image region. It is possible to easily detect movement of hand related to the manipulation input in a more detailed manner.

For example, the above control device may be configured such that: the multiple sub-regions are arranged adjacent to each other in a row extending in a predetermined direction; the hand image area ratio variation detection section detects a second state sub-region, which is the sub-region whose value of the hand image area ratio is less than the predetermined threshold; the hand image area ratio variation detection section detects a state distribution change, which includes a change in distribution of the first state sub-region and the second state sub-region on the manipulation input region over time; and the operation input information generation section generates and outputs the operation input information when the detected state distribution change matches a predetermined state distribution change. According to this configuration, it is possible to perform coding of states of the sub-regions based on whether the hand image area ratio of each sub-region exceeds the predetermined threshold, and thereby, it is possible to more simply describe the states of the sub-regions by using macroscopic bitmap information in the unit of the sub-region.

The above control device may be configured such that: the state distribution change further includes a change in appearance location distribution of the first state sub-region and the second state sub-region on the manipulation input region over time. According to this configuration, it is possible to easily detect the input hand movement of the user by detecting the change in appearance location distribution of the first state sub-region and the second state sub-region over time. Further, the above control device may be configured such that: the hand image area ratio variation detection section determines the state distribution change by detecting one of: a change of the number of first state sub-regions over time; and a change of the number of second state sub-regions over time. In this configuration, it is possible to easily detect the input hand movement of the user in a more detailed manner. For example, the above control device may be configured such that: the manipulation input region has a first end and a second end opposite to each other in the predetermined direction; the multiple sub-region are aligned in the predetermined direction so as to be arranged between the first end and the end; the predetermined input hand movement is movement of the hand across the multiple sub-regions in the predetermined direction; and the hand image area ratio variation detection section determine the state distribution change caused by the predetermined input hand movement, by detecting movement behavior of appearance location of the first state sub-region. According to this configuration, it is possible to more easily detect the hand moving across the manipulation input region in the predetermined direction, based on the movement behavior of the appearance location of the first state sub-region.

The above control device may be configured such that: the manipulation input element is a location input device; the location input device includes a transparent input reception plate; one surface of the transparent input reception plate is included in the manipulation input region and is adapted to receive a touch manipulation made by a finger of the user; the location input device sets an input coordinate system on the manipulation input region; the location input device detects a location of the touch manipulation on the input coordinate system and outputs coordinate information on the location of the touch manipulation on the input coordinate system; and the imaging device is located on an opposite side of the transparent input reception plate from the manipulation input region, so that the imaging device captures, through the transparent input reception plate, the image of the hand. Further, the above control device may further include: a display device that displays an input window, which provides a reference for the user to perform an input operation on the location input device; and a pointer image display section that superimposes a pointer image, which is generated based on image information on the hand image region, on the input window. On the input window, the pointer image is located at a place corresponding to place of the hand image region in the captured image.

According to the above configuration, the user can perceive position of a finger of the user on the manipulation input surface by watching the pointer image on the input window. In particular, when a display screen of the display device is placed so be out of “a line of sight” of the user who is looking straight at the finger on the input manipulation surface, the pointer image on the input widow can be an only information source that the user can use to perceive operation position of the hand because the user can not look straight at both of the input manipulation surface and the display screen. For example, when the control device is used to operate the in-vehicle electronic apparatus such as a car navigation apparatus and the like, the manipulation input surface is placed next to (or obliquely forward of) a vehicle seat for the user to sit down, and the display screen of the display device is placed above the manipulation input surface so that the display screen is located in front of or obliquely in front of the user sitting in the seat.

The above control device may further include an illumination light source that is located on the opposite side of the transparent input reception light from the manipulation input region. The illumination source irradiates the manipulation input region with illumination light. The imaging device captures the image including the hand image region, based on the illumination light reflected from the hand. Based on the hand image ratio of the hand image region to the manipulation input region, the control device uses the information on the image captured by imaging device as the input information. Because of the illumination source, when the hand is relatively close to the transparent input reception plate, the reflected light reaching the imaging device is increased. However, the hand spaced a predetermined distance or more apart from the transparent input reception plate cannot be recognized as the hand image region. Thus, when the hand moves across over the transparent input reception plate to manipulate a different control device (e.g., a gear shift lever) proximal to the subject control device, the hand is not recognized as the hand image region having a valid hand image area ratio and does not cause an error input when a distance between the hand and the transparent input reception plate is sufficiently large.

The above control device may be configured such that: each of the display device and the display control section is a component of the in-vehicle electronic apparatus (e.g., a car navigation system); the operation input information generation section outputs window content change command information as the operation input information to the display control section, based on the calculated value of the hand image area ratio; and the display control section causes the display device to change content of the input window when the display control section receives the window content change command information. According to this configuration, it is possible to control a change in content of the input window based on the hand image area ratio, which is calculated from the captured image, and it is possible to considerably increase freedom of control forms for the change in content of the input window.

For example, the above control device may be configured such that, when the hand image area ratio increases from a value lower than the predetermined threshold to a value larger than the predetermined threshold, the operation input information generation section outputs window switch command information as the outputs window content change command information to request the display device to switch the input window from (i) a first widow that is presently displayed into (ii) a second window different from the first window. According to this configuration, it is possible to perform an operation of switching the window into a certain window by using a characteristic manipulation form based on the hand image area ratio. An intuitive and easy-to-follow window switching operation becomes possible. An operation of switching the behavior of another cooperating electronic apparatus (e.g., an audio apparatus, an air conditioner and the like) is also possible. Further, such a characteristic manipulation form is highly distinguishable from the normal input manipulation such as a mere touch manipulation and the like. It is possible to minimize an occurrence of an error such as the switching of the window or the activation of the predetermined function at an undesirable timing. The above control device may be configured such that, when the location input device receives a predetermined touch manipulation after the input window is switched into the second input window, the operation input information generation section outputs window recovery request information to request the display device to recover the input window into the first window.

While the invention has been described above with reference to various embodiments thereof, it is to be understood that the invention is not limited to the above described embodiments and constructions. The invention is intended to cover various modifications and equivalent arrangements. In addition, while the various combinations and configurations described above are contemplated as embodying the invention, other combinations and configurations, including more, less or only a single element, are also contemplated as being within the scope of embodiments.

Further, each or any combination of processes, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

What is claimed is:

1. A control device comprising:
a touch input device that has a manipulation surface adapted to receive a touch manipulation made by a finger of a user, and detects and outputs an input location of the touch manipulation;
an imaging device that has a photographing range having one-to-one coordinate relationship to the manipulation surface, and captures an image of a hand of the user getting access to the manipulation surface;
a fingertip specifying section that specifies a fingertip of the hand based on data of the image of the hand;
a display device that includes a display screen having one-to-one coordinate relationship to the photographing range and the manipulation surface;
a pointer image display control section that causes the display device to display a pointer image on the display screen, the pointer image pointing to a place corresponding to the fingertip;
a selection reception region setting section that sets a selection reception region on the display screen so that the selection reception region is located at a predetermined place on the display screen;
a move target image selection section that switches a move target image prepared on the selection reception region into a selected state when the touch input device detects that the touch manipulation is performed at the input location corresponds to the move target image item; and
an image movement display section that
(i) detects a target fingertip, which is the fingertip that makes the touch manipulation at the input location corresponding to the move target image item,
(ii) causes the display device to display the move target image in the selected state and the pointer image at a place corresponding to position of the target fingertip, and
(iii) causes the move target image in the selected state and the pointer image to move together on the display screen in response to movement of the target fingertip in the photographing range, in such manner that a trajectory of movement of the selected move target image and the pointer image corresponds to a trajectory of the movement of the target fingertip.

2. The control device according to claim 1, wherein:
the pointer image display control section uses a actual finger image as the pointer image, the actual finger image being extracted from the image of the hand.

3. The control device according to claim 1, wherein:
the pointer image display control section uses a pre-prepared image item as the pointer image, the pre-prepared image item being different form a actual finger image extracted from the image of the hand.

4. The control device according to claim 3, wherein:
the pre-prepared image item is a simulated finger image; and
the simulated finger image is smaller in width than the actual finger image.

5. The control device according to claim 1, wherein:
the touch manipulation includes a first touch manipulation, which is the touch manipulation that is performed by the target fingertip at the input location corresponding to the selection reception region;
the first touch manipulation switches the move target image into the selected state;
when the target fingertip is spaced apart form the manipulation surface and is moved after the first touch manipulation is performed, the image movement display section switches display mode into a coupling movement mode, in which the move target image in the selected state and the pointer image are moved together in response to the movement of the target fingertip;
the touch manipulation further includes a second touch manipulation, which is the touch manipulation that is performed, after the target fingertip is moved in the coupling movement mode, at the input location corresponding to the position of the target fingertip; and
the image movement display section switches off the coupling movement mode when the touch input device detects that the second touch manipulation is performed.

6. The control device according to claim 5, wherein:
the move target image is a marking image that highlights position of the target fingertip.

7. The control device according to claim 6, further comprising:
an operation button image display control section that causes the display device to display an operation button image on the selection reception region of the display screen, the operation button image containing the marking image as design display.

8. The control device according to claim 6, further comprising:
a marking image pasting section that causes the display device to display the marking image on the display screen, such that the marking image is fixedly pasted at a place corresponding to the input location of the second touch manipulation when the coupling movement mode is switched off.

9. The control device according to claim 6, further comprising:
a marking image deletion section that deletes the marking image, which has been displayed together with the pointier image, from the place corresponding to the input location of the second touch manipulation when the coupling movement mode is switched off.

10. The control device according to claim 7, wherein:
the marking image has a one-to-tone correspondence to a predetermined function of an electronic apparatus, which is a control target of the subject control device,
the control device further comprising:
a control command activation section that activates a control command of the predetermined function corresponding to the marking image when the touch input device detects that the second touch manipulation is performed.

11. The control device according to claim 10, wherein:
the selection reception region is a plurality of selection reception regions;
the predetermined function of the electronic apparatus is a plurality of predetermined functions;
the marking image is a plurality of marking images; and
the plurality of marking images respectively corresponds to the plurality of predetermined functions of the electronic apparatus;
the control device further comprising:
an operation button image display control section that causes the display device to respectively display a plurality of operation button images on the polarity of selection reception regions, so that the plurality of operation button images respectively contains the plurality of marking images as design display,
wherein:
when the first touch manipulation is performed at the input location corresponding to one operation button images of the operation button images, the image movement display section (i) switches one marking image of the marking images that corresponds to the one operation button image in the selected state, and (ii) switches the display mode into the coupling movement mode; and
when the touch input device detects that the second touch manipulation is performed, the control command activation section activates the control command of one of the predetermined functions corresponding to the one marking image being in the selected state.

12. The control device according to claim 10, wherein:
a part of the manipulation surface is a command activation valid region;
a part of the display screen is a window outside part, which corresponds to the command activation enablement part;
the operation button image is displayed on the window outside part of the display screen;
the control command activation section activates the control command of the predetermined function when the touch input device detects that the second touch manipulation is performed on the command activation enablement part of the manipulation surface; and
the control command activation section does not activate the control command of the predetermined function when the touch input device detects that the second touch manipulation is performed outside the command activation enablement part.

13. The control device according to claim 10, wherein:
the electronic apparatus is an in-vehicle electronic apparatus; and
the touch input device and the display device are arranged in a vehicle compartment such that the display screen of the display device is out of a filed of sight of the user who is sitting in a seat in the vehicle compartment and who is looking straight at the manipulation surface of the touch input device.

14. The control device according to claim 10, wherein:
the in-vehicle electronic apparatus is a car navigation system.

15. The control device according to claim 14, wherein:
a part of the display screen is a map display region for displaying a map for use in the car navigation system;
the operation button image is displayed on the selection reception region and is displayed on an outside of the map display region;
the control command enables a user to specify a point on the map displayed on the map display region;
the control command is assigned to correspond to the operation button image;
the control command activation section activates the control command when the touch input device detected that the second touch manipulation is performed inside the map display region; and
the control command activation section does not activates the control command when the touch input device detects that the second touch manipulation is performed inside the map display region.

16. The control device according to claim 15 wherein:
the control command is one of
(i) a destination setting command to set a destination on the map display region,
(ii) a stopover point setting command to set a stopover point on the map display region,
(iii) a peripheral facilities search command, and
(iv) a map enlargement command.

17. The control device according to claim 6, wherein:
the display screen has a pointer displayable part, in which the pointer image is displayable; and
when the target fingertip escapes from the pointer displayable part in the coupling movement mode, the image movement display section switches off the coupling movement mode and switches the marking image in an unselected state.

18. The control device according to claim 6, wherein:
the display screen has a pointer displayable part, in which the pointer image is displayable;
when the target fingertip escapes from the pointer displayable part in the coupling movement mode, the image movement display section maintains the selected state of the marking image; and
when one of the escaped target fingertip and a substitution fingertip, which is a substation fingertip of the escaped target fingertip, is detected in the pointer displayable part after the target fingertip has escaped from the pointer displayable part, the image move display section keeps the coupling movement mode
by newly setting the target fingertip to the one of the escaped target fingertip and the substitution fingertip and
by using the marking image being in the selected state.

19. The control device according to claim 6 further comprising:
a target fingertip movement detection section that detects the movement of the target fingertip in the coupling movement mode,
wherein:
when the detected movement of the target fingertip in the coupling movement mode corresponds to a predetermined mode switch off movement, the image movement display section switches off the coupling movement mode and switches the marking image in an unselected state.

20. A control device for a user to operate an in-vehicle electronic apparatus in a vehicle by manipulating the control device, the control device comprising:
a manipulation input element that is located so as to be within reach of the user who is sitting in a seat of the vehicle, and that has a manipulation input region having a predetermined area;
an imaging device that has a photographing range covering the manipulation input region, and that captures an image including a hand image region representative of the hand of the user getting access to the manipulation input element;
a hand image region identification section that identifies the hand image region in the image;
an area ratio calculation section that calculates a value of hand image area ratio, which is area ratio of the hand image region to the manipulation input region; and
an operation input information generation section that generates and outputs operation input information based on the calculated value of the hand image area ratio and a manipulation state of the manipulation input region, the operation input information being directed to the in-vehicle electronic apparatus.

21. The control device according to claim 20, wherein:
the operation input information generation section determines content of the operation input information, based on a predetermined correspondence relationship between the content of the operation input information and the value of the hand image area ratio; and
the operation input information section generates and outputs the operation input information having the content that corresponds to the calculated value of the hand image area ratio.

22. The control device according to claim 21, wherein:
when the calculated value of the hand image area ratio exceeds a predetermined threshold, the operation input information generation section outputs predetermined-function activation request information as the operation input information to request a predetermined-function of the in-vehicle electronic apparatus to be activated.

23. The control device according to claim 22, wherein:
the predetermined threshold is larger than 0.6; and
the value of the hand image area ratio larger the predetermined threshold corresponds to an occurrence of a hand cover state in the manipulation input region.

24. The control device according to claim 23, wherein:
when the manipulation input element receives a predetermined manipulation input after the predetermined-function of the in-vehicle electronic apparatus is activated, the operation input information generation section outputs operation change request information to request a change in operation state of the predetermined-function of the in-vehicle apparatus.

25. The control device according to claim 24, wherein:
the operation change request information is operation recover request information that requests deactivation of the predetermined-function of the in-vehicle electronic apparatus to recover the in-vehicle electronic apparatus into a pre-activation stage of the predetermined-function.

26. The control device according to claim 20, further comprising:
an area ratio variation detection section that detects a time variation in value of the hand image area ratio, the time variation being caused by a predetermined input hand movement in the manipulation input region,
wherein:
when the detected time variation matches a predetermined time variation, the operation input information generation section generates and outputs the operation input information having the content that corresponds to the predetermined time variation.

27. The control device according to claim 26, wherein:
the manipulation input region is divided into multiple sub-regions;
the hand image area ratio calculation section calculates the hand image area ratio in each of the multiple sub-regions;
the hand image area ratio variation detection section detects the time variation in value of the hand image area ratio in each of the multiple sub-regions.

28. The control device according to claim 27, wherein:
the hand image area ratio variation detection section detects a first state sub-region, which is the sub-region whose value of the hand image area ratio is grater than or equal to the predetermined threshold;
the hand image area ratio variation detection section detects
(i) a number of first state sub-regions and
(ii) a change in appearance location of the first sub-region in the multiple sub-regions over time
as a transition behavior; and
the operation input information generation section generates and outputs the operation input information when the detected transition behavior matches a predetermined transition behavior.

29. The control device according to claim 28, wherein:
the multiple sub-regions are arranged adjacent to each other in a row extending in a predetermined direction;
the hand image area ratio variation detection section detects a second state sub-region, which is the sub-region whose value of the hand image area ratio is less than the predetermined threshold;
the hand image area ratio variation detection section detects a state distribution change, which includes a change in distribution of the first state sub-region and the second state sub-region on the manipulation input region over time; and
the operation input information generation section generates and outputs the operation input information when the detected state distribution change matches a predetermined state distribution change.

30. The control device according to claim 29, wherein:
the state distribution change further includes a change in appearance location distribution of the first state sub-region and the second state sub-region on the manipulation input region over time.

31. The control device according to claim 29, wherein:
the hand image area ratio variation detection section determines the state distribution change by detecting one of: a change of the number of first state sub-regions over time; and a change of the number of second state sub-regions over time.

32. The control device according to claim 31, wherein:
the manipulation input region has a first end and a second end opposite to each other in the predetermined direction;
the multiple sub-region are aligned in the predetermined direction so as to be arranged between the first end and the end;
the predetermined input hand movement is movement of the hand across the multiple sub-regions in the predetermined direction; and
the hand image area ratio variation detection section determine the state distribution change caused by the predetermined input hand movement, by detecting movement behavior of appearance location of the first state sub-region.

33. The control device according to claim 20, wherein:
the manipulation input element is a location input device;
the location input device includes a transparent input reception plate;
one surface of the transparent input reception plate is included in the manipulation input region and is adapted to receive a touch manipulation made by a finger of the user;
the location input device sets an input coordinate system on the manipulation input region;
the location input device detects a location of the touch manipulation on the input coordinate system and outputs coordinate information on the location of the touch manipulation on the input coordinate system; and
the imaging device is located on an opposite side of the transparent input reception plate from the manipulation input region, so that the imaging device captures, through the transparent input reception plate, the image of the hand;
the control device further comprising:
a display device that displays an input window, which provides a reference for the user to perform an input operation on the location input device; and
a pointer image display section that superimposes a pointer image on the input window,
wherein:
the pointer image is based on image information on the hand image region; and
on the input window, the pointer image is located at a place corresponding to place of the hand image region in the captured image.

34. The control device according to claim 33 further comprising:
an illumination light source that is located on the opposite side of the transparent input reception light from the manipulation input region,
wherein:
the illumination source irradiates the manipulation input region with illumination light; and
the imaging device captures the image including the hand image region, based on the illumination light reflected from the hand.

35. The control device according to claim 34, wherein:
each of the display device and the display control section is a component of the in-vehicle electronic apparatus;
the operation input information generation section outputs window content change command information as the operation input information to the display control section, based on the calculated value of the hand image area ratio; and
the display control section causes the display device to change content of the input window when the display control section receives the window content change command information.

36. The control device according to claim 35, wherein:
when the hand image area ratio increases from a value lower than the predetermined threshold to a value larger than the predetermined threshold, the operation input information generation section outputs window switch command information as the outputs window content change command information;
the outputs window content change command information requests the display device to switch the input window
from a first widow that is presently displayed;
into a second window different from the first window.

37. The control device according to claim 36, wherein
when the location input device receives a predetermined touch manipulation after the input window is switched into the second input window, the operation input information generation section outputs window recovery request information; and
the window recovery request information request the display device to recover the input window into the first window.
